(19) United States
(12) Patent Application Publication
(10) Pub. No.: US 2026/0172954 A1
(43) Pub. Date: Jun. 18, 2026

(54) NETWORK NODES, AND METHODS PERFORMED THEREIN FOR UPDATING NETWORK FUNCTIONS IN A WIRELESS COMMUNICATIONS NETWORK

(71) Applicant: Telefonaktiebolaget LM Ericsson (publ), Stockholm (SE)

(72) Inventors: Lasse OLSSON, Träslövsläge (SE); Jian YANG, Montréal (CA); Peng LI, Saint-Laurent (CA); Maud FORSMAN, Hisings Backa (SE); Emiliano MERINO VAZQUEZ, Madrid (ES); Jesús Ángel DE GREGORIO RODRIGUEZ, Boadilla del Monte Madrid (ES)

(73) Assignee: Telefonaktiebolaget LM Ericsson (publ), Stockholm (SE)

(21) Appl. No.: 19/124,305

(22) PCT Filed: Oct. 23, 2023
(86) PCT No.: PCT/EP2023/079472

§ 371 Date: Apr. 25, 2025

Related U.S. Application Data
(60) Provisional application No. 63/419,240, filed on Oct. 25, 2022.

(30) Foreign Application Priority Data
Apr. 7, 2023 (WO) PCT/CN2023/086892

(51) Int. Cl. H04W 48/18

(52) U.S. Cl. CPC H04W 48/18

(57) ABSTRACT

Embodiments herein may relate to, for example, a method performed by a first network node for handling a testing process associated with a third network node in a wireless communications network. The first network node obtains an instance identity of an updated or initiated third network node; and stores one or more identities of one or more UEs to be used during the testing process mapped to the obtained instance identity. Upon detection of a session establishment of a UE, the first network node checks whether an identity of the UE matches the stored one or more identities of the one or more UEs; and, with the proviso that the identity of the UE matches one of the stored one or more identities of the one or more UEs, the first network node initiates a NF discovery towards a second network node using the instance identity mapped to the matched one identity.

### TECHNICAL FIELD

Embodiments herein relate to a first network node, a second network node, a third network node and methods performed therein regarding wireless communication. Furthermore, a computer program product and a computer-readable storage medium are also provided herein. In particular, embodiments herein relate to handling communication, such as handling or enabling testing of an initiated or updated third network node, in a wireless communications network.

### BACKGROUND

In a typical wireless communications network, User Equipments (UE), also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node, e.g., a Wi-Fi access point or a Radio Base Station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS Terrestrial Radio Access Network (UTRAN) is essentially a RAN using Wideband Code Division Multiple Access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g. as in UMTS, several radio network nodes may be connected, e.g., by landlines or microwave, to a controller node, such as a Radio Network Controller (RNC) or a Base Station Controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

FIG. 1 depicts the 5G reference architecture as defined by 3GPP. The Network Functions (NF) shown in FIG. 1 are described below.

The Application Function (AF) or Application Server (AS) interacts with the 3GPP Core Network and allows external parties to use the Exposure Application Programming Interfaces (API) offered by the network operator. The AF provides session related information to other nodes in the 5G core network (5GC).

The Network Exposure Function (NEF) supports different functionalities and NEF supports different Exposure APIs.

Network Repository Function (NRF) works as a registration centre of NF.

The Unified Data Repository (UDR) stores data grouped into distinct collections of subscription-related information: Subscription Data; Policy Data; Structured Data for Exposure; Application Data.

The Session Management Function (SMF) supports different functionalities, e.g. SMF receives Policy and Charging Control (PCC) rules from the Policy Control Function (PCF) and configures the User Plane Function (UPF) accordingly.

The User Plane Function (UPF) supports handling of user plane traffic based on the rules received from the SMF, e.g. packet inspection and different enforcement actions such as Quality of Service (QoS) handling.

The PCF supports a unified policy framework to govern the network behaviour. Specifically, the PCF provides PCC rules to the Policy and Charging Enforcement Function (PCEF), i.e., the SMF/UPF that enforces policy and charging decisions according to provisioned PCC rules.

The Access and Mobility Management Function (AMF) manages UE access, e.g., when a UE is connected through different access networks, and UE mobility aspects.

Charging Function (CHF) manages charging of services and/or functions. The CHF includes: Online Charging Function (OCF) specified in TS 32.296 v17.0.0 providing quota management functionality under Credit-Control terminology; and Charging Data Function (CDF) specified in clause 4.3.1.2 32.240 v 18.0.0, providing Charging Data Records (CDR) generation functionality for charging events.

Network Slice Selection Function (NSSF), not shown, selects the Network Slicing Instance (NSI), determines the allowed Network Slice Selection Assistance Information (NSSAI) and sets the AMF to serve the UE.

An overall SMF selection has been part of the 3GPP specifications from start, ref TS 23.502 v.17.5.0.

The SMF selection function, as described in clause 6.3.2 of TS 23.501 v.17.5.0, is supported by the AMF and is used to allocate an SMF that manages the Protocol Data Unit (PDU) Session.

The SMF selection function described in this clause does not apply to the selection of an SMF for Emergency services. The SMF selection for Emergency services is described in clause 5.16.4.5 of TS 23.501 v.17.5.0.

Two main branches of deployment scenarios to consider:
Non-roaming and roaming with local breakout, see clause 4.3.2.2.3.2 in TS 23.502 v.17.5.0
Home routed roaming, see clause 4.3.2.2.3.3 in TS 23.502 v.17.5.0

In the case of non-roaming and local breakout, there are two operational scenarios dependent on the configuration of AMF and the deployment option of NSSF in the serving Public Land Mobile Network (PLMN).

In the case of home-routed, there are two main options dependent on the operators' choices in terms of involvement of NRF, NSSF and configuration of AMF. The decision of which option to use is part of the roaming agreements.

NOTE: The use of NSI ID and the use of multiple NRFs in the network are optional and depend on the deployment choices of the operator.

Non-roaming and roaming with local breakout.

FIG. 2 shows SMF selection for non-roaming and roaming with local breakout scenarios. This procedure may be skipped altogether if SMF information is available in the AMF by other means, e.g., locally configured; otherwise:
when the serving AMF is aware of the appropriate NRF to be used to select NFs/services within the corresponding NSI based on configuration or based on the Network Slice selection information received during Registration, only steps 3 and 4 in the following procedure are executed as described in FIG. 2:
when the serving AMF is not aware of the appropriate NRF to be used to select NFs/services within the corresponding NSI, all steps in the following procedure are executed as described in FIG. 2.
   1. The AMF invokes the Nnssf_NSSelection_Get service operation from the NSSF in serving PLMN with the Serving (S)-NSSAI of the serving PLMN from the allowed NSSAI requested by the UE, PLMN ID of the Subscription Permanent Identifier (SUPI), Tracking Area Identifier (TAI) of the UE and the indication that the request is within a procedure of PDU Session establishment in either the non-roaming or roaming with local breakout scenario.
   2. The NSSF in serving PLMN selects the NSI, determines and returns the appropriate NRF to be used to select NFs/services within the selected NSI and optionally may return an NSI ID corresponding to the NSI.
   3. AMF queries the appropriate NRF in serving PLMN by issuing the Nnrf_NFDiscovery_Request including at least the S-NSSAI of the serving PLMN for this PDU Session from the allowed NSSAI, PLMN ID of the SUPI, Data Network Name (DNN) and possibly NSI ID if the AMF has stored an NSI ID for the S-NSSAI of the serving PLMN for this PDU Session from the allowed NSSAI.
   NOTE: The list of parameters for SMF selection is defined in clause 6.3.2 of TS 23.501 v.17.5.0. See also clause 5.34.3 of TS 23.501 17.5.0 for I-SMF selection.
   4. The NRF in serving PLMN provides to the AMF, e.g. Fully Qualified Domain Name (FQDN) or IP address, of a set of the discovered SMF instance(s) or Endpoint Address(es) of SMF service instance(s) in Nnrf_NFDiscovery_Request response message and possibly an NSI ID for the selected NSI corresponding to the S-NSSAI for subsequent NRF queries.

The input parameters to the Nnrf_NFDiscovery_Request that are used to determine the correct SMF instance are described in detail in 3GPP TS 29.510 v.17.6.0 (note that it's not a complete list but only parameters that could be or are used for SMF selection in a non-private network without roaming).

TABLE 6.2.3.2.3.1-1
(TS 29.510 v.17.6.0): URI query parameters supported by the GET method on this resource

| Name | Data type | P | Cardinality | Description | Applicability |
|---|---|---|---|---|---|
| target-nf- | NFType | M | 1 | This IE shall contain the NF type of the target NF being | |
| type | | | | discovered. | |
| service- | array(Service | O | 1 . . . N | If included, this IE shall contain an array of service names | |
| names | Name) | | | for which the NRF is queried to provide the list of NF | |
| | | | | profiles. The NRF shall return the NF profiles that have at | |
| | | | | least one NF service matching the NF service names in | |
| | | | | this list. The NF service names returned by the NRF shall | |
| | | | | be an interclause of the NF service names requested and | |
| | | | | the NF service names registered in the NF profile. | |
| | | | | If not included, the NRF shall return all the NF service | |
| | | | | names registered in the NF profile. Contains unique | |
| | | | | items. | |
| target- | array(PlmnId) | C | 1 . . . N | This IE shall be included when NF services in a different | |
| plmn-list | | | | PLMN, or NF services of specific PLMN ID(s) in a same | |
| | | | | PLMN comprising multiple PLMN IDs, need to be | |
| | | | | discovered. When included, this IE shall contain the | |
| | | | | PLMN ID of the target NF. If more than one PLMN ID is | |
| | | | | included, NFs from any PLMN ID present in the list | |
| | | | | matches the query parameter. | |
| | | | | For inter-PLMN service discovery, at most 1 PLMN ID | |
| | | | | shall be included in the list; it shall be included in the | |
| | | | | service discovery from the NF in the source PLMN sent to | |
| | | | | the NRF in the same PLMN, while it may be absent in the | |
| | | | | service discovery request sent from the source NRF to | |
| | | | | the target NRF. In such case, if the NRF receives more | |
| | | | | than 1 PLMN ID, it shall only consider the first element of | |
| | | | | the array, and ignore the rest. | |
| target-nf- | NfInstanceId | O | 0 . . . 1 | Identity of the NF instance being discovered. | |
| instance-id | | | | | |
| target-nf- | Fqdn | O | 0 . . . 1 | FQDN of the target NF instance being discovered. | |
| fqdn | | | | | |
| snssais | array(Snssai) | O | 1 . . . N | If included, this IE shall contain the list of S-NSSAIs that | |
| | | | | are served by the NF (Service) Instances being | |
| | | | | discovered. The NRF shall return those NF profiles/NF | |
| | | | | services of NF (Service) Instances that have at least one | |
| | | | | of the S-NSSAIs in this list. The S-NSSAIs included in the | |
| | | | | NF profiles/NF services of NF (Service) Instances | |
| | | | | returned by the NRF shall be an interclause of the S- | |
| | | | | NSSAIs requested and the S-NSSAIs supported by those | |
| | | | | NF (Service) Instances. (NOTE 10) | |
| | | | | When the NF Profile of the NF Instances being | |
| | | | | discovered has defined the list of supported S-NSSAis in | |
| | | | | the “perPlmnSnssaiList”, the discovered NF Instances | |
| | | | | shall be those having any of the S-NSSAIs included in this | |
| | | | | “snssais” parameter in any of the PLMNs included in the | |
| | | | | “target-plmn-list” attribute, if present; if the “target-plmn- | |
| | | | | list” is not included, the NRF shall assume that the | |
| | | | | discovery request is for any of the PLMNs it supports. | |
| nsi-list | array(string) | O | 1 . . . N | If included, this IE shall contain the list of NSI IDs that are | |
| | | | | served by the services being discovered. | |
| dnn | Dnn | O | 0 . . . 1 | If included, this IE shall contain the DNN for which NF | |
| | | | | services serving that DNN is discovered. DNN may be | |
| | | | | included if the target NF type is e.g. “BSF”, “SMF”, “PCF”, | |
| | | | | “PCSCF” or “UPF”. | |
| | | | | The DNN shall contain the Network Identifier and it may | |
| | | | | additionally contain an Operator Identifier. (NOTE 11). | |
| | | | | If the Snssai(s) are also included, the NF services serving | |
| | | | | the DNN shall be available in the network slice(s) | |
| | | | | identified by the Snssai(s). | |
| tai | Tai | O | 0 . . . 1 | Tracking Area Identity. | |
| pgw-ind | boolean | O | 0 . . . 1 | When present, this IE indicates whether a combined | |
| | | | | SMF/PGW-C or a standalone SMF needs to be | |
| | | | | discovered. | |
| | | | | true: A combined SMF/PGW-C is requested to be | |
| | | | | discovered; | |
| | | | | false: A standalone SMF is requested to be discovered. | |
| | | | | (See NOTE 2) | |
| pgw | Fqdn | O | 0 . . . 1 | If included, this IE shall contain the PGW FQDN which is | |
| | | | | received by the AMF from the MME to find the combined | |
| | | | | SMF/PGW. | |
| preferred- | string | O | 0 . . . 1 | Preferred target NF location (e.g. geographic location, | |
| locality | | | | data center). | |
| | | | | When present, the NRF shall prefer NF profiles with a | |
| | | | | locality attribute that matches the preferred-locality. | |
| | | | | The NRF may return additional NFs in the response not | |
| | | | | matching the preferred target NF location, e.g. if no NF | |
| | | | | profile is found matching the preferred target NF location. | |
| | | | | The NRF should set a lower priority for any additional NFs | |
| | | | | on the response not matching the preferred target NF | |
| | | | | location than those matching the preferred target NF | |
| | | | | location. | |
| | | | | (NOTE 6) | |
| limit | integer | O | 0 . . . 1 | Maximum number of NFProfiles to be returned in the | Query- |
| | | | | response. | Params- |
| | | | | Minimum: 1 | Ext1 |
| target-nf- | NfSetId | O | 0 . . . 1 | When present, this IE shall contain the target NF Set ID | Query- |
| set-id | | | | (as defined in clause 28.12 of 3GPP TS 23.003 [12]) of | Params- |
| | | | | the NF instances being discovered. | Ext2 |
| target-nf- | NfServiceSetId | O | 0 . . . 1 | When present, this IE shall contain the target NF Service | Query- |
| service- | | | | Set ID (as defined in clause 28.13 of | Params- |
| set-id | | | | 3GPP TS 23.003 [12]) of the NF service instances being | Ext2 |
| | | | | discovered. | |
| preferred- | Tai | O | 0 . . . 1 | When present, the NRF shall prefer NF profiles that can | Query- |
| tai | | | | serve the TAI, or the NRF shall return NF profiles not | Params- |
| | | | | matching the TAI if no NF profile is found matching the | Ext2 |
| | | | | TAI. | |
| | | | | (NOTE 5) | |
| preferred- | array(NfInstanceId) | O | 1 . . . N | When present, this IE shall contain a list of preferred | Query- |
| nf- | | | | candidate NF instance IDs. (NOTE 8) | Params- |
| instances | | | | | Ext2 |
| serving- | array(string) | O | 1 . . . N | If present, this attribute shall contain the list of areas that | Query- |
| scope | | | | can be served by the NF instances to be discovered. The | Params- |
| | | | | NRF shall return NF profiles of NFs which can serve all | Ext2 |
| | | | | the areas requested in this query parameter. | |

(NOTE 2):
If the combined SMF/PGW-C is requested to be discovered, the NRF shall return in the response the SMF instances registered with the SmfInfo containing pgwFqdn.
(NOTE 5):
The AMF may perform the SMF discovery based on the dnn, snssais and preferred-tai during a PDU session establishment procedure, and the NRF shall return the SMF profiles matching all if possible, or the SMF profiles only matching dnn and snssais. If the SMF profiles only matching dnn and snssais are returned, the AMF shall insert an I-SMF. An SMF may also perform a UPF discovery using this parameter.
(NOTE 6):
The SMF may select the P-CSCF close to the UPF by setting the preferred-locality to the value of the locality of the UPF.
(NOTE 8):
The service consumer may include a list of preferred-nf-instance-ids in the query. If so, the NRF shall first check if the NF profiles of the preferred NF instances match the other query parameters, and if so, then the NRF shall return the corresponding NF profiles; otherwise, the NRF shall return a list of candidate NF profiles matching the query parameters other than the preferred-nf-instance-ids. For example, the target AMF may set this query parameter to the SMF Instance ID and I-SMF Instance ID during an inter AMF mobility procedure to select an I-SMF.
(NOTE 11):
The dnn query parameter shall be considered as matching a DNN attribute in the NF Profile of a given NF Instance if:
both contain the same Network Identifier and Operator Identifier;
both contain the same Network Identifier and none contains an Operator Identifier;
the dnn query parameter contains the Network Identifier only, the DNN value in the NF
Profile contains both the Network Identifier and Operator Identifier, and both contain the same Network Identifier; or
the dnn query parameter contains both the Network Identifier and Operator Identifier, the DNN value in the NF Profile contains the Network Identifier only, both contain the same Network Identifier and the Operator Identifier matches one PLMN of the NF (i.e. plmnList of the NF Profile).

But there is also the aspect of the NE Status of the actual SMF instance to take into consideration when the NRF “selects” one or several SMF candidates.

### 6.1.6.3.7 Enumeration: NFStatus

TABLE 6.1.6.3.7-1
(TS 29.510 v.17.6.0): Enumeration NFStatus

| Enumeration value | Description |
|---|---|
| “REGISTERED” | The NF Instance is registered in NRF and can be |
| | discovered by other NFs. |
| “SUSPENDED” | The NF Instance is registered in NRF but it is not |
| | operative and cannot be discovered by other NFs. |
| | This status may result from a NF Heart-Beat failure |
| | (see clause 5.2.2.3.2) or a NF failure and may |
| | trigger restoration procedures (see clause 6.2 |
| | of 3GPP 23.527 [27]). |
| “UNDISCOV- | The NF instance is registered in NRF, is operative |
| ERABLE” | but cannot be discovered by other NFs. |
| | This status may be set by the NF e.g. in shutting |
| | down scenarios where the NF is still able to |
| | process requests for existing resources or sessions |
| | but cannot accept new resource creation or |
| | session establishment. |

### SUMMARY

As part of developing embodiments herein one or more problems have been identified. There are some use case scenarios herein addressed for updating or initiating NFs in the wireless communications network. That is, when a NE is upgraded with a new software (SW), or the NE is initiated, i.e., is powered up for the first time, re-started or is connected to the wireless communication network. These use cases may be one or more of the following:
Customers want to try out new SW deliveries for NFs using real UEs;
At the same time, customers do not want other UEs to end up on this NE until the new SW has passed all verification;
Once the test have passed, a smooth re-population of the network function might be wanted;
In Service Software Upgrade (ISSU) it is also a need to try the upgrade without other UEs using the upgraded NF such as SMF.

Solutions according to prior art:
The first part, assigning a specific UE to a specific NF, could be achieved today by adding a new DNN in NF, and/or Unified Data Management (UDM)/UDR;
The latter part, preventing all other UEs to try to establish PDU Sessions towards a specific NF, is much harder but could be achieved. However, given the current 3GPP specification there is no simple way to achieve this without impacting a lot of configurations. As an example, one could remove all slice and DNN related configurations and configure the upgraded NF to only support a single (S)-NSSAI (slice)+DNN, and/or one could remove all geographically related configuration, e.g., smflnfoList, and only support connectivity for a single TAI.

3GPP TS 29.510 v.17.6.0 exemplifies when the NF is an SMF:

TABLE 6.2.6.2.3-1
(TS 29.510 v.17.6.0): Definition of type NFProfile

| Attribute | | Cardi- | |
|---|---|---|---|
| name | Data type | nality | Description |
| smfInfo | SmfInfo | 0 . . . 1 | Specific data for the SMF |
| | | | (DNN's, . . .). |
| | | | (NOTE 8) |
| smfInfoList | map(SmfInfo) | 1 . . . N | Multiple entries of SmfInfo. |
| | | | This attribute provides additional |
| | | | information to the smfInfo. |
| | | | smfInfoList may be present |
| | | | even if the smfInfo is absent. |
| | | | The key of the map shall be a |
| | | | (unique) valid JSON string per |
| | | | clause 7 of IETF RFC 8259 |
| | | | [22], with a maximum |
| | | | of 32 characters. (NOTE 8) |

(NOTE 8):
The absence of both the smfInfo and smfInfoList attributes in an SMF profile indicates that the SMF can be selected for any S-NSSAI, DNN, TAI and access type.

A problem is then that one must put back all removed configurations once the verification is passed.

This reconfiguration has one or more of the following drawbacks:
There is a higher risk for misconfiguration;
There are increased costs for the operator, or any other operations department that handles the upgrade e.g., managing services;
Takes a longer time to coordinate and align, i.e., longer Time To Market (TTM) for the new software.

An object herein is to provide a mechanism to handle implementation or updating of NFs, such as SMF, PCF or CHF, in an efficient manner in the wireless communications network.

According to an aspect the object is achieved, according to embodiments herein, by providing a method performed by a first network node, such as NF node e.g., an AMF, for handling a testing process associated with a third network node in a wireless communications network. The first network node obtains an instance identity of an updated or initiated third network node, and stores one or more identities of one or more UEs to be used during the testing process mapped to the obtained instance identity. The first network node, upon detection of a session establishment of a UE, checks whether an identity of the UE matches the stored one or more identities of the one or more UEs; and with the proviso that the identity of the UE matches one of the stored one or more identities of the one or more UEs, the first network node initiates an NF discovery towards a second network node using the instance identity mapped to the matched one identity.

According to another aspect the object is achieved, according to embodiments herein, by providing a method performed by a second network node, such as NF node e.g., an NRF for handling a testing process associated with a third network node in a wireless communications network. The second network node obtains an instance identity of an updated or initiated third network node and receives a request from a first network node related to a NF discovery using the instance identity. The second network node generates a response based on the instance identity, a status indication of the third network node, a condition indication, a received indication from the first network node and/or previously stored status information, wherein the response indicates a profile of the updated or initiated third network node. The second network node then transmits the generated response to the first network node.

According to yet another aspect the object is achieved, according to embodiments herein, by providing a method performed by a third network node, such as NF node, e.g., an SMF, a PCF, or a CHF, for handling a testing process associated with the third network node in a wireless communications network. The third network node provides, to a second network node, an indication of a status of the third network node, along with profile information of the third network node, wherein the indication indicates a status related to testing, maintenance or updating of the third network node.

According to still another aspect the object is achieved, according to embodiments herein, by providing a first network node, second network node, and a third network node configured to perform the methods herein, respectively.

Thus, according to an aspect the object is achieved, according to embodiments herein, by providing a first network node, such as NF node e.g., an AMF, for handling a testing process associated with a third network node in a wireless communications network. The first network node is configured to obtain an instance identity of an updated or initiated third network node, and stores one or more identities of one or more UEs to be used during the testing process mapped to the obtained instance identity. The first network node is configured to, upon detection of a session establishment of a UE, check whether an identity of the UE matches the stored one or more identities of the one or more UEs; and with the proviso that the identity of the UE matches one of the stored one or more identities of the one or more UEs, the first network node is configured to initiate an NF discovery towards a second network node using the instance identity mapped to the matched one identity.

According to another aspect the object is achieved, according to embodiments herein, by providing a second network node, such as NF node e.g., an NRF for handling a testing process associated with a third network node in a wireless communications network. The second network node is configured to obtain an instance identity of an updated or initiated third network node, and to receive a request from a first network node related to a NF discovery using the instance identity. The second network node is configured to generate a response based on the instance identity, a status indication of the third network node, a condition indication, a received indication from the first network node, and/or previously stored status information, wherein the response indicates a profile of the updated or initiated third network node. The second network node is configured to transmit the generated response to the first network node.

According to yet another aspect the object is achieved, according to embodiments herein, by providing a third network node, such as NF node, e.g., an SMF, a PCF, or a CHF, for handling a testing process associated with the third network node in a wireless communications network. The third network node is configured to provide, to a second network node, an indication of a status of the third network node, along with profile information of the third network node, wherein the indication indicates a status related to testing, maintenance or updating of the third network node.

It is furthermore provided herein a computer program product comprising instructions, which, when executed on at least one processor, cause the at least one processor to carry out the methods herein, as performed by the first, the second or the third network node, respectively. It is additionally provided herein a computer-readable storage medium, having stored thereon a computer program product comprising instructions which, when executed on at least one processor, cause the at least one processor to carry out the methods herein, as performed by the first, the second or the third network node, respectively.

Embodiments herein provides a mechanism that makes it possible for the first network node such as an AMF, for a specific UE, to select a specific, predetermined third network node, i.e., an NF, such as an SMF, that is in maintenance mode to be able to perform drive tests AND at the same time secure that no commercial/live traffic is directed to that third network node.

By further including a condition indication the NF, such as the third network node, may indicate whether it can or cannot be discovered and selected by other NFs under one or more conditions, and this makes it possible to allow gradual repopulation of the target (newly upgraded) NF, controlled by that NF itself.

Hence, embodiments herein provide a mechanism allowing to direct ONLY specific UE to a specific NF
At a low OPEX cost for the operators.
At low risk of misconfiguration.
With minimum coordination effort

Thus, this may create a quicker TTM for new SW meaning that older versions spend less time on the market thus reducing maintenance costs. Hence, embodiments herein provide a mechanism to handle implementation or updating of network functions, such as SMF, PCF or CHF, in an efficient manner in the wireless communications network.

### BRIEF DESCRIPTION OF THE DRAWINGS

Embodiments will now be described in more detail in relation to the enclosed drawings, in which:

FIG. 1 shows an architecture according to prior art;

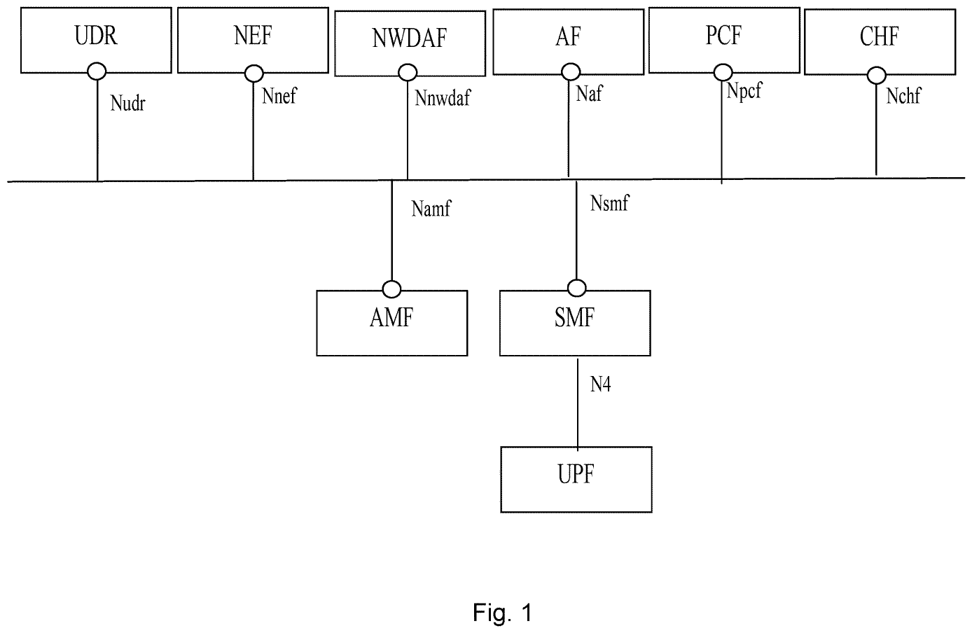

FIG. 2 shows an signalling scheme according to prior art;

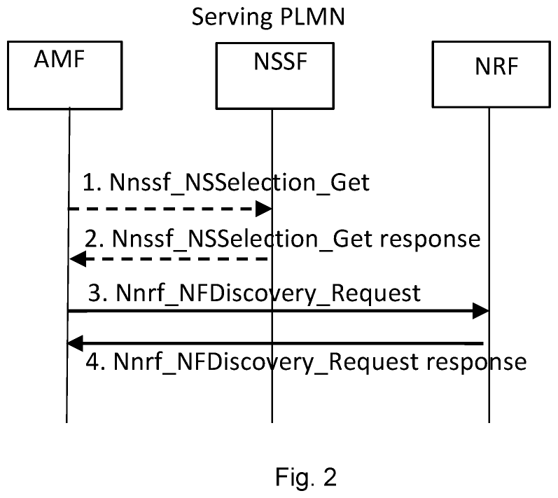

FIG. 3a shows a wireless communications network according to embodiments herein;

FIG. 3b shows a combined signalling scheme and flow chart according to embodiments herein;

FIG. 4 shows a signalling scheme according to embodiments herein;

FIG. 5 shows a signalling scheme according to embodiments herein;

FIG. 6a shows a signalling scheme according to embodiments herein;

FIG. 6b shows a signalling scheme according to embodiments herein;

FIG. 6c shows a signalling scheme according to embodiments herein;

FIG. 7 is depicting a method performed by a first network node according to embodiments herein;

FIG. 8 is depicting a method performed by a second network node according to embodiments herein;

FIG. 9 is depicting a method performed by a third network node according to embodiments herein;

FIG. 10 shows an upgrading example 1(2) for upgrading an SMF;

FIG. 11 shows an upgrading example 2(2) for upgrading an SMF;

FIG. 12 shows a block diagram depicting the first network node according to embodiments herein

FIG. 13 shows a block diagram depicting the second network node according to embodiments herein; and

FIG. 14 shows a block diagram depicting the third network node according to embodiments herein.

### DETAILED DESCRIPTION

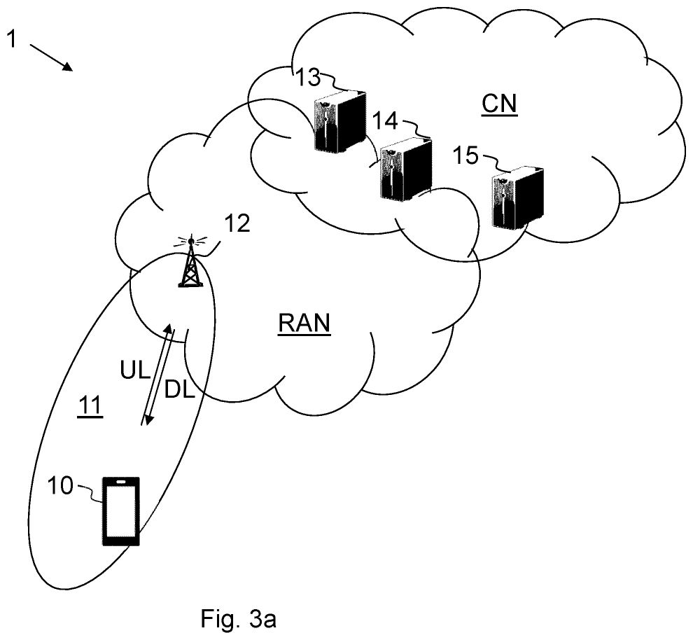

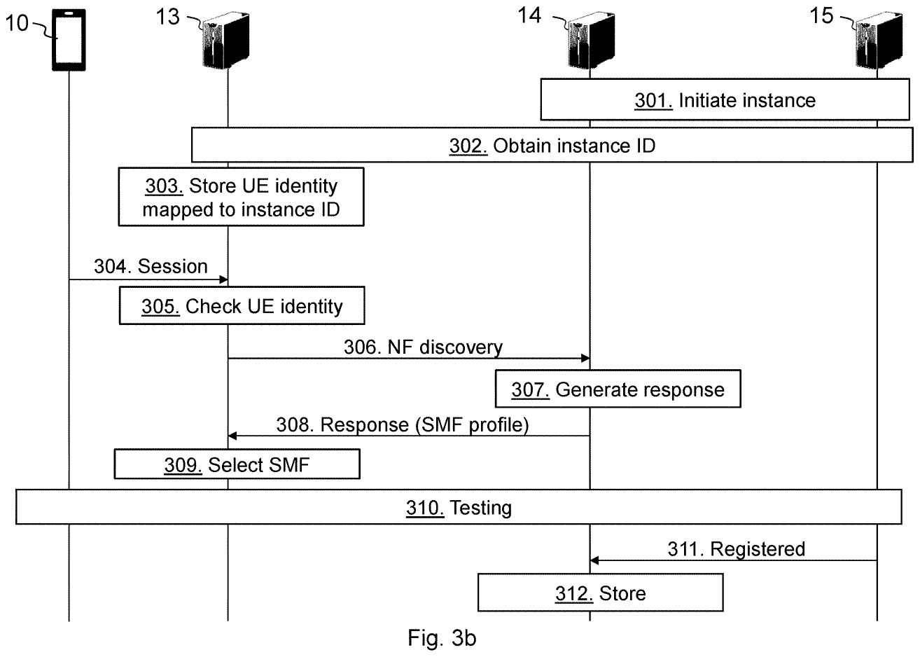

Embodiments herein relate to wireless communications networks in general. FIG. 3a is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a NR context, however, embodiments are also applicable in existing wireless communications systems such as e.g. LTE or WCDMA, and developments thereof.

In the wireless communications network 1, a UE 10, exemplified herein as a wireless device such as a mobile station, a non-access point (non-AP) station (STA), a STA and/or a wireless terminal, is comprised communicating via, e.g., one or more Access Networks (AN), e.g. RAN, to one or more CN. It should be understood by the skilled in the art that “UE” is a non-limiting term which means any terminal, wireless communications terminal, user equipment, NarrowBand Internet of Things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a radio network node 12 providing radio coverage over a geographical area, a first service area 11 or first cell, of a first Radio Access Technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the UE in form of DL transmissions to the UE and UL transmissions from the UE. It should be noted that a service area may be denoted as cell, beam, beam group or similar to define an area of radio coverage.

The wireless communications network further comprises a number of CN nodes/NF nodes such as a first network node 13 for example an AMF, a second network node 14 such as an NRF, a third network node 15, such as an SMF, a CHF, or a PCF. Network nodes are herein exemplified in accordance with NR terminology, it should however be noted that embodiments may herein be implemented in system of other RATs such as LTE or similar.

According to embodiments herein the first network node 13 selects, for a specific UE, a third network node 15 that is in maintenance or testing mode to be able to perform drive tests and at the same time secure that no commercial and/or live traffic is directed to that third network node 15.

Embodiments herein may comprise:

Configuration in the AMF, i.e., the first network node 13, that makes it possible to tag and/or link one (or several) specific UE 10, identified by an identity of the UE, such as the SUPI, to a predetermined NF, such as an SMF, identified by an instance identity (the NflnstanceId), when the UE 10 tries to establish a PDU Session. This is enabled by having stored UE identities for testing and mapping the instance identity to a maintenance/testing scenario.

TABLE 6.2.6.2.3-1
(TS 29.510 v.17.6.0): Definition of type NFProfile

| Attribute name | Data type | P | Cardinality | Description |
|---|---|---|---|---|
| nfInstanceId | NfInstanceId | M | 1 | Unique identity of |
| | | | | the NF Instance. |

Furthermore, in 3GPP 29.571 v.17.0.0:

| | | |
|---|---|---|
| NfInstanceId | string | String uniquely identifying a NF |
| | | instance. The format of the NF Instance ID |
| | | shall be a Universally Unique Identifier |
| | | (UUID) version 4, as described in |
| | | IETF RFC 4122 [15]. |
| | | (NOTE 3) |

RFC 4122:

This specification defines a Uniform Resource Name namespace for Universally Unique IDentifiers (UUID), also known as Globally Unique IDentifiers (GUID). A UUID is 128 bits long, and can guarantee uniqueness across space and time. UUIDs were originally used in the Apollo Network Computing System and later in the Open Software Foundation's (OSF) Distributed Computing Environment (DCE), and then in Microsoft Windows platforms.

An “instance” may thus be very similar to a “physical node”.

In the example, the first network node 13 checks above configuration and selects the configured NflnstanceId for that specific SUPI.

Three options are herein suggested when the first network node 13 is an AMF and the third network node 15 is an SMF:
The AMF sends an NF Discovery to the NRF, i.e., the second network node 14, and the NF discovery includes an S-NSSAI, a DNN, a new value or Attribute Value Pair (AVP), e.g., “maintenance mode” and target-nf-instance-id set to the same value that was defined in the target SMF.
NflnstanceId is a mandatory parameter in the NF Registration procedure and is manually configured on each SMF.
The new AVP, “maintenance mode” is typically a boolean.
The NRF checks the incoming qualification parameters and if the NF Status==UNDISCOVERABLE and the maintenance mode AVP==true, then the SMF that has the NflnstanceId is returned to the AMF and the procedure continues towards that SMF.
The SMF sends an NF Update with a new value for the NF Status called Maintenance or Testing. The AMF sends an NF Discovery to the NRF including S-NSSAI, DNN, and target-nf-instance-id set to the same value that was defined in the target SMF.
NflnstanceId is a mandatory parameter in the NF Registration procedure and manually configured on each SMF.
The NRF checks the incoming qualification parameters and if the NF Status==MAINTENANCE or TESTING, the AVP target-nf-instance-id include a single value, then the SMF that has the NflnstanceId is returned to the AMF and the procedure continues towards that SMF.
The SMF sends an NF Update with a new value for the NF Status called Maintenance or Testing. The AMF sends an NF Discovery to the NRF including S-NSSAI, and DNN. NRF checks incoming parameters and returns SMF to AMF if NF Status==REGISTERED, TESTING or MAINTENANCE, and other query parameters (S-NSSAI, and DNN) also match.
For the canary testing case, the AMF shall select the SMF instance which NF status==TESTING or MAINTENANCE and the procedure continues towards that SMF. Canary testing refers to testing a new software version or a new feature with real UEs in a live environment.

Then for re-population a further extension of the NFProfile may be needed:

| | | | | |
|---|---|---|---|---|
| nfSelec- | NfSelec- | O | 0 . . . 1 | Conditions under which an NF |
| tionCondi- | tionCondi- | | | Instance with an NFStatus value |
| tions | tions | | | set to “TESTING” shall |
| | | | | be selected by an NF Service |
| | | | | Consumer (e.g. if the UE |
| | | | | belongs to a range of SUPIs) |

Embodiments herein may comprise one or more of the following:
Introduce a new NFStatus value (“TESTING”)
Introduce one or more (a set of) conditions, e.g., the set of UEs, to indicate whether the NF under TESTING state should be primarily selected when the conditions are met, whereas an NF under testing should not be selected if the conditions are not met.

FIG. 3b shows a combined flowchart and signalling scheme according to embodiments herein.

Action 301. The third network node 15 is updated, i.e., upgraded with new SW, or initiated, i.e., is powered up for the first time, re-started or is connected to the wireless communication network. For example, the third network node 15 performs an upgrade procedure and verifies that a configuration to support a Test UE exists in the third network node 15. The third network node 15 may set the status to “Undiscoverable”, via command in the third network node 15.

Action 302. The first network node 13 obtains an instance identity for the upgraded or initiated third network node 15. As an example, the instance identity is set by the third network node 15 and once the third network node 15 is registered, and the first network node 13 has selected it once, the first network node 13 may subscribe to changes on that instance identity such as status changes.

Action 303. The first network node 13 stores an identity of the UE 10, to be tested, mapped to the instance identity. Previously, the first network node 13 may have obtained the identities of one or more UEs, and which UEs to be used for testing an NF in maintenance mode may be locally configured at the first network node 13.

Action 304. The UE 10 initiates session establishment.

Action 305. The first network node 13 checks the identity of the UE 10 whether it matches the stored UE identities.

Action 306. With the proviso that the identity of the UE 10 matches the stored identity, the first network node 13 initiates a NF discovery towards the second network node 14 using the instance identity mapped to the stored identity. The first network node 13 may further transmit a flag indicating a “maintenance mode”, such as a flag set to true. Thus, when identity of the UE 10 matches a stored identity the first network node 13 may include a value indicating a status of maintenance, testing or updating.

Action 307. The second network node 14 generates a response based on the instance identity, the flag, a condition is met, and/or previously stored status information. For example, if the flag is included and set to true, the second network node 14 may return an NF profile, corresponding to the instance identity, back to the first network node 13 even if the NF Status equals “Undiscoverable”. In another example, if the instance identity is set to a status as testing or maintenance at the second network node 14, the second network node 14 may provide the NF profile, corresponding to the instance identity, back to the first network node 13. Alternatively, the second network node 14 may check and match one or more parameters in a NF discovery request, and, when matched, may then provide indications of one or more NF profiles where the status equals “Registered”, “Testing” or “Maintenance” back to the first network node 13. The status of respective NF profile may be indicated in a message carrying the indications of the one or more NF profiles.

Action 308. The second network node 14 sends the response to the first network node 13.

Action 309. In case the response comprises indication of status of a plurality of profiles, the first network node 13 may select one NF profile with status indicating maintenance, testing or updating for the configuration at the first network node 13 indicating which one or more UEs are to be testing the NF in a testing or maintenance mode. The first network node 13 may select the one NF profile based on the instance identity mapped to UEs, i.e., according to the local configuration.

Action 310. The UE 10 may then run one or more tests using the updated or initiated third network node 15. It should be noted that the UE 10 itself may not know that it is a test scenario, only the operator that configures the logical link and/or connection between the UE 10 and the third network node 15, which is configured in the first network node 13, action 303.

Action 311. In case the one or more tests are successful, e.g., tests have passed pre-set threshold or similar, the third network node 15 may change its status to registered and may transmit to the second network node 14, an indication indicating the third network node 15 as a registered third network node. That is test results as successful may be managed in a Test Object List, managed and executed by e.g., an operator.

Action 312. The second network node 14 may then store, at the second network node 14, an indication that the third network node 15 is of a new status such as a registered third network node.

3GPP TS 29.510 v17.6.0 Common changes needed (underlined)

### 6.1.6.3.6 Enumeration: NotificationEventType

TABLE 6.1.6.3.6-1
Enumeration NotificationEventType

| Enumeration value | Description |
|---|---|
| “NF_REGISTERED” | The NF Instance has been registered in |
| | NRF |
| “NF_DEREGISTERED” | The NF Instance has been deregistered |
| | from NRF (NOTE) |
| “NF_PROFILE_CHANGED” | The profile of the NF Instance has been |
| | modified (NOTE) |

(NOTE):
A change of the NFStatus value shall be notified as “NF_PROFILE_CHANGED” event, except if the NFStatus is set to value “TESTING” and the subscribing entity does not support the “Canary-Testing” feature; in such case, the subscribing entity shall be notified as a “NF_DEREGISTERED” event.

### 6.1.9 Features Supported by the N-Management Service

The syntax of the supportedFeatures attribute is defined in clause 5.2.2 of 3GPP TS 29.571 [7].
The following features are defined for the Nnrf_NFManagement service.

TABLE 6.1.9-1
Features of supportedFeatures attribute
used by Nnrf_NFManagement service

| Feature | | | |
|---|---|---|---|
| Number | Feature | M/O | Description |
| 1 | Service-Map | M | Support of defining in the profile of the |
| | | | NF Instance the list of NF Service |
| | | | Instances based on a map type (i.e. |
| | | | support of the “nfServiceList” |
| | | | attribute in NFProfile). |
| 2 | Empty- | O | Support of receiving empty JSON |
| | Objects- | | objects as values in the servedxxxInfo/ |
| | Nrf-Info | | servedxxxInfoList map attributes of the |
| | | | NrfInfo data structure used by an NRF |
| | | | during registration into another NRF |
| | | | (see clause 6.1.6.2.31). |
| | | | An NRF that supports registering into |
| | | | another NRF shall support this feature. |
| X | Canary-Testing | O | Support of “TESTING” value for |
| | | | NFStatus, used for e.g. canary testing |

Feature number: The order number of the feature within the supportedFeatures attribute (starting with 1).
Feature: A short name that can be used to refer to the bit and to the feature.
M/O: Defines if the implementation of the feature is mandatory (“M”) or optional (“O”).
Description: A clear textual description of the feature.

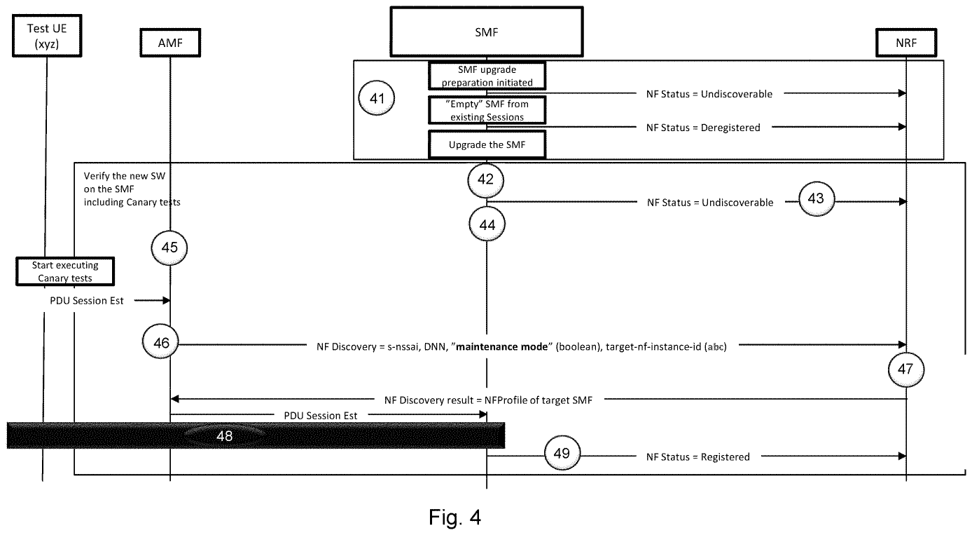

FIG. 4 shows a SMF Selection for Canary tests, alternative 1. With reference to FIG. 3, the first network node 13 is exemplified as an AMF, the second network node 14 is exemplified as an NRF and the third network node 15 is exemplified as an SMF.
41. Legacy: Normal Upgrade procedure as described in CPI
42. Legacy: Verify that the s-nssai+DNN configuration to support a Test UE exist in the SMF
43. Legacy: Set the NF Status to “Undiscoverable”, via command in the SMF
44. NEW: Retrieve the NflnstanceId for the upgraded SMF. For example, an operator may retrieve the NflnstanceId and then use it in the next step for the local configuration.
45. NEW: In the AMF, configure a link between the Test UE identity, such as SUPI, and the upgraded SMF (NflnstanceId).
   Use that value, NflnstanceId, retrieved from the SMF that will be used for these tests, step 44
46. NEW: When the UE 10 initiates the PDU Session Establishment procedure the AMF shall check against the local configuration.
   If the SUPI is found in the list, then AMF shall use a specific NF Discovery query towards NRF including the “target-nf-instance-id” information, same value as the configured NfInstancId value and also a new flag called “maintenance mode” (boolean) set to true.
47. NEW: If the new flag is included and set to true the NRF shall return the SMF NF profile (indicated by “target-nf-instance-id” back to the AMF even if the NF Status equals “Undiscoverable”)
48. Legacy: Run all tests
49. NEW: Once all tests are passed, Set the NF Status to “Registered”, via command in the SMF. This may then be provided to the NRF.

### 3GPP 29.510 v.17.6.0 Changes Needed for Alternative 1 (Add the Underlined)

TABLE 6.2.3.2.3.1-1
URI query parameters supported by
the GET method on this resource

| | | | | | |
|---|---|---|---|---|---|
| | Data | | Cardi- | | Applica- |
| Name | type | P | nality | Description | bility |

| | | | | |
|---|---|---|---|---|
| Mainte- | boolean | O | 0 . . . 1 | When present, this IE |
| nance | | | | indicates that the PDU |
| mode | | | | Session is intended for |
| | | | | Canary tests. Maintenance |
| | | | | mode may be included |
| | | | | if the target NF type |
| | | | | is “SMF”. |

TABLE 6.1.6.3.7-1
Enumeration NFStatus

| Enumeration value | Description |
|---|---|
| “REGISTERED” | The NF Instance is registered in NRF and can |
| | be discovered by other NFs. |
| “SUSPENDED” | The NF Instance is registered in NRF but it is |
| | not operative and cannot be discovered by |
| | other NFs. |
| | This status may result from a NF Heart-Beat |
| | failure (see clause 5.2.2.3.2) or a NF failure |
| | and may trigger restoration procedures |
| | (see clause 6.2 of 3GPP 23.527 [27]). |
| “UNDISCOVERABLE” | The NF instance is registered in NRF, is |
| | operative but cannot be discovered by other |
| | NFs unless “Maintenance mode” is |
| | included in the NF Discovery request. |
| | This status may be set by the NF e.g. in |
| | shutting down scenarios where the NF is |
| | still able to process requests for existing |
| | resources or sessions but cannot accept new |
| | resource creation or session establishment. |
| | It may also be set after an upgrade of e.g., |
| | SMF to do Canary tests |

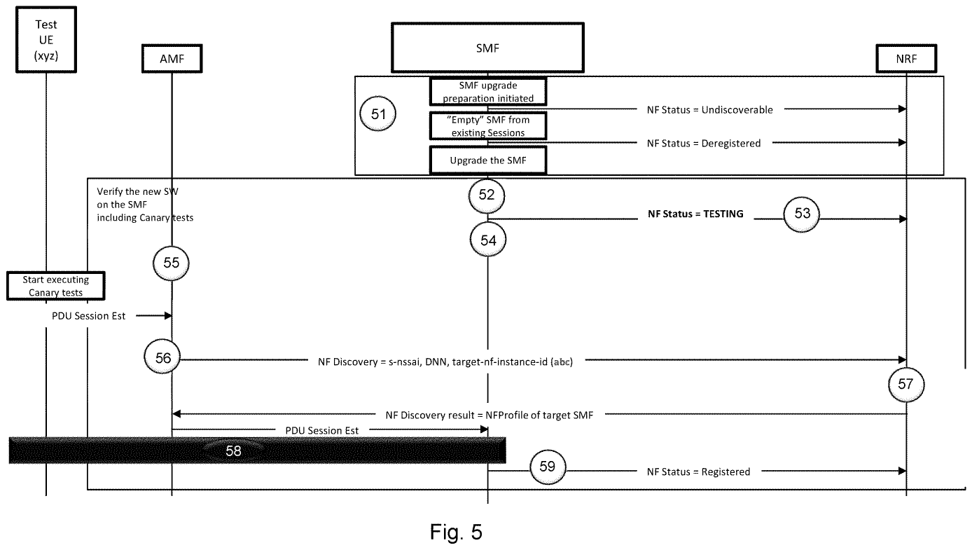

FIG. 5 shows a SMF Selection for Canary tests, alternative 2. With reference to FIG. 3, the first network node 13 is exemplified as an AMF, the second network node 14 is exemplified as an NRF and the third network node 15 is exemplified as an SMF.
51. Legacy: Normal Upgrade procedure as described in legacy procedure
52. Legacy: Verify that the s-nssai+DNN configuration to support the Test UE exist in SMF
53. NEW: Set the NF Status to “TESTING”, initiated via command in the SMF
54. NEW: Retrieve the NflnstanceId for the upgraded SMF
55. NEW: In the AMF, configure a link between the Test UE identity and the upgraded SMF (NflnstanceId) Use that value, NflnstanceId, retrieved from the SMF that will be used for these tests, step 54
56. NEW: When the UE 10 initiates the PDU Session Establishment procedure the AMF shall check against the local configuration.
   If, for example, the SUPI is found in the list, then AMF shall use a specific NF Discovery query towards NRF including the “target-nf-instance-id” information, same value as the configured NfInstancId value.
57. NEW: If the NF Status of the “target-nf-instance-id” is set to “Maintenance” at the NRF, then NRF provides that SMF NF profile back to the AMF
58. Legacy: Run all tests
59. NEW: Once all tests are passed, Set the NF Status to “Registered”, via command in the SMF. This may then be provided to the NRF.

### 3GPP 29.510 v.17.6.0 Changes Needed for Alternative 2 (Add the Underlined)

TABLE 6.1.6.3.7-1
Enumeration NFStatus

| Enumeration value | Description |
|---|---|
| “REGISTERED' | The NF Instance is registered in NRF and can |
| | be discovered by other NFs. |
| “SUSPENDED” | The NF Instance is registered in NRF but it |
| | is not operative and cannot be discovered |
| | by other NFs. |
| | This status may result from a NF Heart-Beat |
| | failure (see clause 5.2.2.3.2) or a NF failure |
| | and may trigger restoration procedures |
| | (see clause 6.2 of 3GPP 23.527 [27]). |
| “UNDISCOV- | The NF instance is registered in NRF, is |
| ERABLE” | operative but cannot be discovered by |
| | other NFs. |
| | This status may be set by the NF e.g. in |
| | shutting down scenarios where the NF is |
| | still able to process requests for existing resources |
| | or sessions but cannot accept new resource |
| | creation or session establishment. |
| “TESTING” | The NF instance is registered in NRF, is operative |
| | and can be discovered and selected by other |
| | NFs under certain conditions (see |
| | NFSelectionConditions, in clause 6.1.6.2.x). |
| | This status may be set by the NF e.g. in upgrade |
| | scenarios or during canary tests scenarios where |
| | the NF is able to process requests for new resource |
| | creation or session establishment under certain |
| | conditions (e.g. for a restricted set of users). |

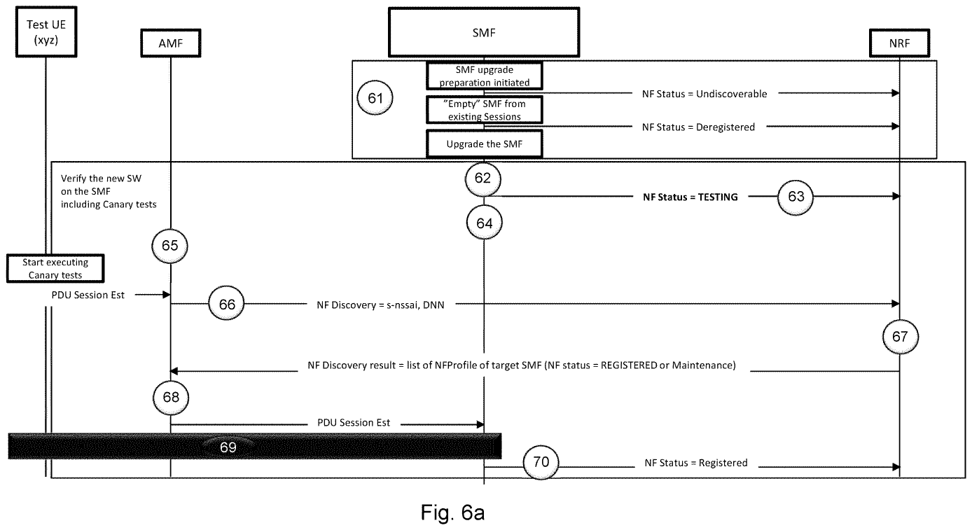

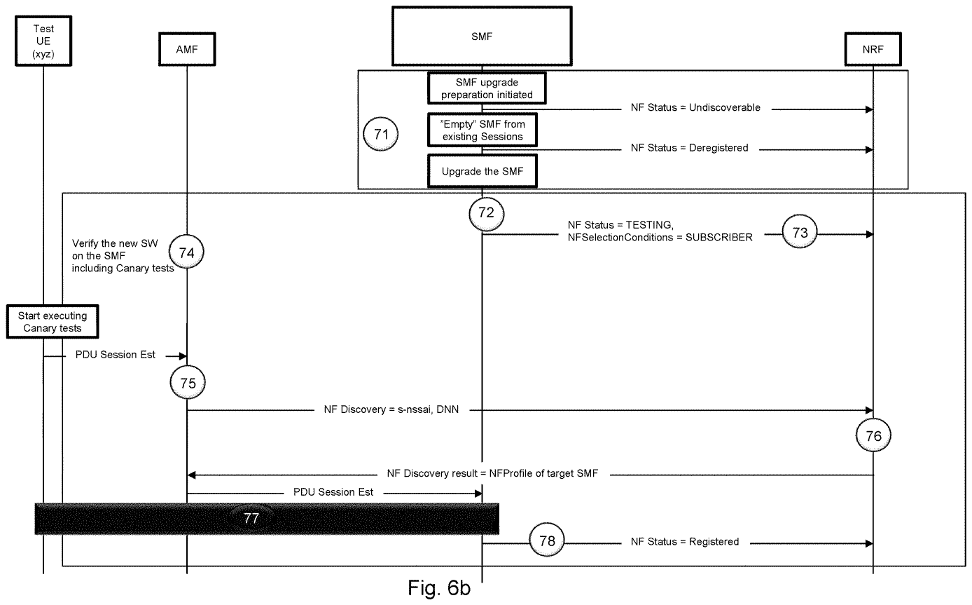

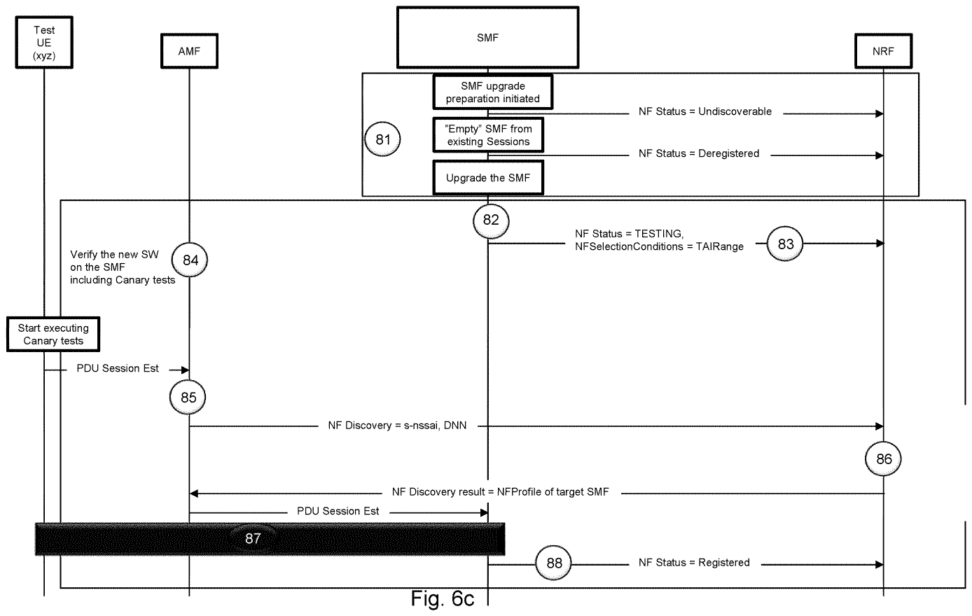

FIG. 6a shows a SMF Selection for Canary tests, alternative 3. With reference to FIG. 3, the first network node 13 is exemplified as an AMF, the second network node 14 is exemplified as an NRF and the third network node 15 is exemplified as an SMF.
61. Legacy: Normal Upgrade procedure as described in CPI
62. Legacy: Verify that the s-nssai+DNN configuration to support the Test UE exist in SMF
63. NEW: Set the NF Status to “Testing”, initiated via command in the SMF
64. NEW: Retrieve the NflnstanceId for the upgraded SMF
65. NEW: In the AMF, configure a link between the Test UE identity (SUPI) and the upgraded SMF (NflnstanceId) Use that value, NflnstanceId, retrieved from the SMF that will be used for these tests, step 464
66. Legacy: When the UE 10 initiates the PDU Session Establishment procedure the AMF shall act according to legacy handling and send a“normal” NF Discovery.
67. NEW: The NRF will check and match all querying parameters and provide a list with all SMF NF profile where the NF Status equals “Registered”, “TESTING” or “Maintenance” back to the AMF, including the NF Status
68. NEW: The AMF will upon reception of the reply from the NRF check the local configuration, if SUPI=xyz, it means the user is for canary test, the AMF should choose the SMF instance with status=maintenance.
69. Legacy: Run all tests
70. NEW: Once all tests are passed, Set the NF Status to “Registered”, via command in the SMF. This may then be provided to the NRF.

### 3GPP 29.510 v.17.6.0 Changes Needed for Alternative 3 (Add the Underlined)

TABLE 6.1.6.3.7-1
Enumeration NFStatus

| Enumeration value | Description |
|---|---|
| “REGISTERED” | The NF Instance is registered in NRF and can |
| | be discovered by other NFs. |
| “SUSPENDED” | The NF Instance is registered in NRF but it |
| | is not operative and cannot be discovered |
| | by other NFs. |
| | This status may result from a NF Heart-Beat |
| | failure (see clause 5.2.2.3.2) or a NF failure |
| | and may trigger restoration procedures |
| | (see clause 6.2 of 3GPP 23.527 [27]). |
| “UNDISCOV- | The NF instance is registered in NRF, is operative |
| ERABLE” | but cannot be discovered by other NFs. |
| | This status may be set by the NF e.g. in |
| | shutting down scenarios where the NF is still |
| | able to process requests for existing resources |
| | or sessions but cannot accept new resource |
| | creation or session establishment. |
| “TESTING” | The NF instance is registered in NRF, is operative |
| | and can be discovered and selected by other |
| | NFs under certain conditions (see |
| | NFSelectionConditions, in clause 6.1.6.2.x). |
| | This status may be set by the NF e.g. in upgrade |
| | scenarios or during canary tests scenarios where |
| | the NF is able to process requests for new |
| | resource creation or session establishment under |
| | certain conditions (e.g. for a restricted set of users). |

FIG. 6b shows a SMF Selection for Canary tests, alternative 4. With reference to FIG. 3, the first network node 13 is exemplified as an AMF, the second network node 14 is exemplified as an NRF and the third network node 15 is exemplified as an SMF.
71. Legacy: Normal Upgrade procedure as described in CPI
72. Legacy: Verify that the s-nssai+DNN configuration to support the Test UE exist in SMF
73. NEW: Set the NF Status to “TESTING” AND NF Selection Conditions to “SUBSCRIBER”, via command in the SMF. The condition indication indicates one or more conditions under which an NF Instance with an NFStatus value set to “TESTING” may be selected by an NF Service Consumer.
74. NEW: In the AMF, configure a link between the Test UE identity (SUPI) and the NFProfiles that holds the NF Status=TESTING and NF Selection Conditions=SUBSCRIBER
75. NEW: When the UE 10 initiates the PDU Session Establishment procedure the AMF shall follow 3GPP.
76. When the NRF returns the suitable NFProfiles (for all SMFs, including the ones with NF Status=TESTING) the AMF shall look at the local configuration and select the SMF that will undergo the Canary tests.
77. Legacy: Run all tests
78. NEW: Once all tests are passed, Set the NF Status to “Registered”, via command in the SMF

FIG. 6c shows a SMF Selection for Canary tests, alternative 5. With reference to FIG. 3, the first network node 13 is exemplified as an AMF, the second network node 14 is exemplified as an NRF and the third network node 15 is exemplified as an SMF.
81. Legacy: Normal Upgrade procedure as described in CPI
82. Legacy: Verify that the s-nssai+DNN configuration to support the Test UE exist in SMF
83. NEW: Set the NF Status to “TESTING” AND NF Selection Conditions to “TAIRange”, via command in the SMF. The condition indication indicates one or more conditions, a range of tracking area identifiers, under which an NF Instance with an NFStatus value set to “TESTING” may be selected by an NF Service Consumer
84. NEW: In the AMF, configure a link between the Test UE identity (SUPI) and the NFProfiles that holds the NF Status=TESTING and NF Selection Conditions=SUBSCRIBER
85. NEW: When the UE 10 initiates the PDU Session Establishment procedure the AMF shall follow 3GPP.
86. When the NRF returns the suitable NFProfiles (for all SMFs, including the ones with NF Status=TESTING) the AMF shall look at the local configuration and select the SMF that will undergo the Canary tests.
87. Legacy: Run all tests
88. NEW: Once all tests are passed, Set the NF Status to “Registered”, via command in the SMF

### 3GPP 29.510 v.17.6.0 Changes Needed for Alternative 4&5 (Add the Underlined)

### 6.1.6.2.x Type: NFSelectionConditions

TABLE 6.1.6.2.x-1
Definition of type NFSelectionConditions

| Attribute name | Data type | P | Cardinality | Description |
|---|---|---|---|---|
| supiRangeList | array(SupiRange) | O | 1 . . . N | A set of SUPI for which the NF instance under |
| | | | | TESTING status shall be selected |
| gpsiRangeList | array(IdentityRange) | O | 1 . . . N | A set of GPSI for which the NF instance under |
| | | | | TESTING status shall be selected |
| peiList | array(Pei) | O | 1 . . . N | A set of PEI of the UEs for which the NF instance |
| | | | | under TESTING status shall be selected |
| taiRangeList | array(TaiRange) | O | 1 . . . N | A set of TAI where the NF instance under TESTING |
| | | | | status shall be selected for a certain UE |

NOTE:
If several attributes (conditions) are present, the NF shall be selected by the consumer if at least one of the conditions is met.

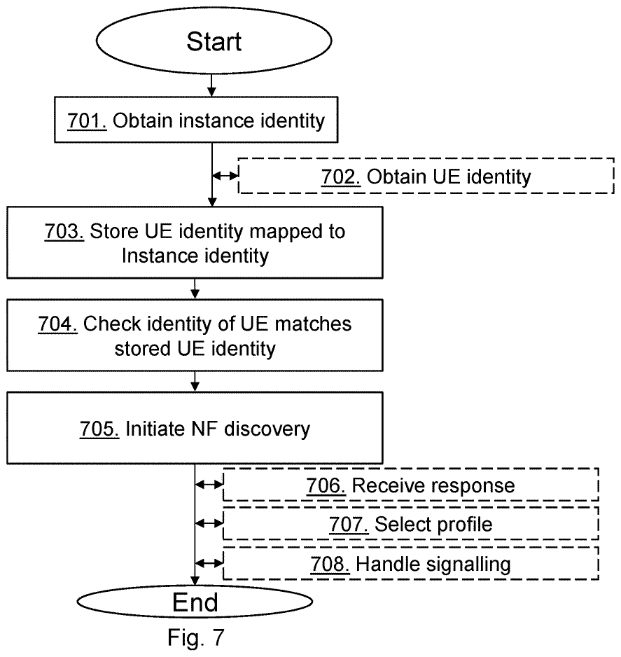

The method actions performed by the first network node 13, such as an AMF, for handling a testing process associated with the third network node 15, for example, testing of an updated or initiated third network node 15, in the wireless communications network 1 according to embodiments will now be described with reference to a flowchart depicted in FIG. 7. The actions do not have to be taken in the order stated below but may be taken in any suitable order. Dashed boxes indicate optional features.

Action 701. The first network node 13 obtains the instance identity of the updated or initiated third network node 15. This may be manually retrieved from the third network node 15 and set in the first network node 13 to create a link between UE identity and instance identity. As an example, the instance identity is set by the third network node 15 and once the third network node 15 is registered, and the first network node 13 has selected it once, the first network node 13 may subscribe to changes on that instance identity such as status changes. Thus, the first network node 13 may receive the instance identity from the second network node 14 or the third network node 15.

Action 702. The first network node 13 may obtain the UE identity of the UE associated with the updating or initiation, i.e., one or more UEs to be used during the testing. The first network node 13 may obtain the identities of one or more UEs and this may be locally configured at the first network node 13 indicating which one or more UEs are to be testing the NF in a maintenance mode. Thus, the first network node 13 may obtain the one or more identities of the one or more UEs to be used during the testing process mapped to the obtained instance identity in a local configuration.

Action 703. The first network node 13 stores the one or more (obtained) UE identities of the one or more UEs to be used during the testing process, mapped to the instance identity.

Action 704. Upon detecting a session establishment of the UE 10, the first network node 13 checks whether an identity of the UE 10 matches the stored one or more identities of the one or more UEs 10.

Action 705. With the proviso that the identity of the UE 10 matches one of the stored one or more identities of the one or more UEs, the first network node 13 initiates a NF discovery towards the second network node 14 using the obtained instance identity mapped to the matched one identity. The first network node 13 may further transmit, to the second network node 14, an indication, such as a request, indicating a requested status associated with a testing, maintenance or updating mode of the third network node 15, for example, a testing mode such as a testing status, a maintenance status or an updated status. The indication may comprise a flag value set to true. Thus, when identity of the UE matches a stored identity in the first network node 13, the first network node 13 may include, in a NF discovery message, a value indicating a status of maintenance, testing or updating. The first network node 13 may evaluate or determine whether the identity of the UE matches the stored UE identity, and that being the case the first network node 13 initiates the NRF discovery network function for the third network node 15 being in maintenance mode. In case there is no match, the first network node 13 initiates a legacy performance for discovering a third network node 15 such as an SMF.

Action 706. The first network node 13 may receive a response from the second network node 14, indicating a profile of the updated or initiated third network node 15. For example, the first network node 13 may receive an NF profile associated with the instance identity, even if status of the third network node 15 equals “Undiscoverable”. In another example, wherein the instance identity is associated with a status as maintenance, testing or updating, at the second network node 14, the first network node 13 may receive an NF profile associated with the instance identity. Alternatively, the first network node 13 may receive indications of one or more NF profiles where the status equals “Registered”, “Testing” or “Maintenance” at the second network node 14. The status of respective NF profile may be indicated in a message carrying the indications of the one or more NF profiles. The indication may be values or indexes of the NF profiles. Thus, the first network node 13 may receive one or more indications of one or more profiles of one or more third network nodes 15, wherein a status of respective profile is indicated in the response carrying the one or more indications.

Action 707. The first network node 13 may select one profile with status indicating testing, maintenance or updating. As an example, in case the response comprises indication of status, the first network node 13 may select one or more profiles such as SMF NF profiles with status indicating testing, maintenance or updating for the configuration at the first network node 13 indicating which one or more UEs are to be testing the NF in a maintenance mode.

Action 708. The first network node 13 may then handle signalling in a testing process based on the response. The first network node 13 may for example direct UE session of the UE using the profile indicated in the response or selected.

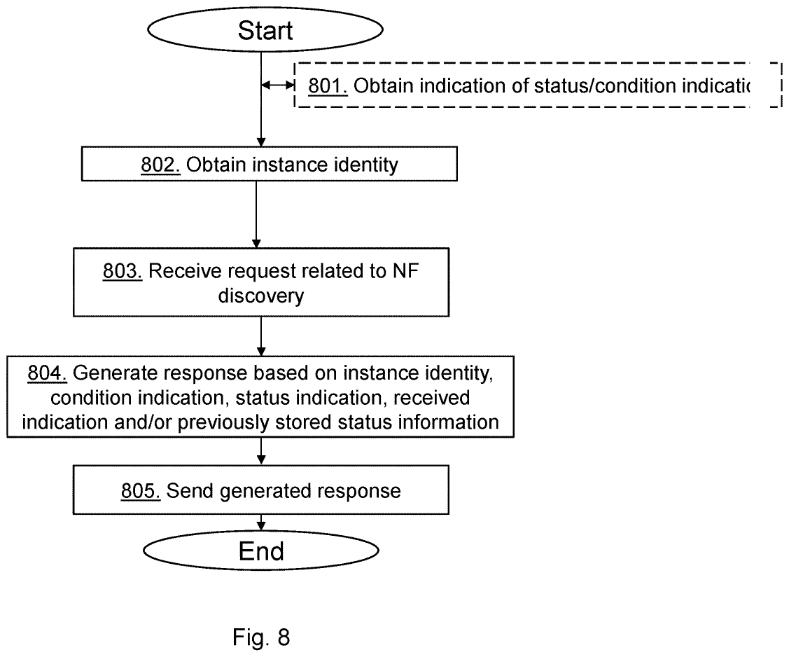

The method actions performed by the second network node 14, such as an NRF, for handling a testing process associated with the third network node 15, for example, testing of an updated or initiated third network node 15, in the wireless communications network 1 according to embodiments will now be described with reference to a flowchart depicted in FIG. 8. The actions do not have to be taken in the order stated below but may be taken in any suitable order. Dashed boxes indicate optional features.

Action 801. The second network node 14 may obtain an indication of a status of the third network node 15. The second network node 14 may obtain, for example, receive, a status indication from the third network node 15, indicating that the third network node 15 is undiscoverable, or in a status related to testing, maintenance or updating, such as a testing mode, or a maintenance mode. The second network node 14 may, additionally or alternatively, obtain the condition indication. The status indication may comprise a value, an index or a flag. The second network node 14 may further receive a condition indication indicating condition for selection of the NF. The condition indication may indicate one or more conditions under which the NF Instance with an NFStatus value set to “TESTING” may be selected by an NF Service Consumer.

Action 802. The second network node 14 obtains the instance identity of the updated or initiated third network node 15. For example, the second network node 14 may receive the instance identity from the third network node 15. The third network node 15 may set the instance identity during a NF Registration procedure. The instance identity may be used as input for the local configuration in the first network node 13.

Action 803. The second network node 14 receives the request from the first network node 13 related to the NF discovery using the instance identity. The second network node 14 may receive the indication, such as a flag or value, requesting a status for testing, maintenance or updating the third network node 15, such as a “maintenance mode” or “testing mode”, e.g., receive a flag value set to true.

Action 804. The second network node 14 generates the response based on the instance identity, the status indication of the third network node 15, the condition indication, the received indication from the first network node 13, and/or a previously stored status information, wherein the response indicates the profile of the updated or initiated third network node 15. For example, the second network node 14 may apply, to the response, one or more indications of one or more profiles of one or more third network nodes 15, wherein a status of respective profile is indicated in the response carrying the one or more indications.

Action 805. The second network node 14 transmits or sends the generated response to the first network node 13. For example, if the flag is included and set to true the second network node 14 may return an NF profile, corresponding to the instance identity, back to the first network node 13 even if the NF Status equals “Undiscoverable”. In another example, if the instance identity is set to a status as maintenance or testing at the second network node 14, the second network node 14 may provide the NF profile, corresponding to the instance identity, back to the first network node 13. Alternatively, the second network node may check and match one or more parameters in a NF discovery request, and, when matched, may then provide indications of one or more NF profiles where the status equals “Registered”, “Testing” or “Maintenance” back to the first network node 13. The status of respective NF profile may be indicated in a message carrying the indications of the one or more NF profiles. The indication may be values or indexes of the NF profiles.

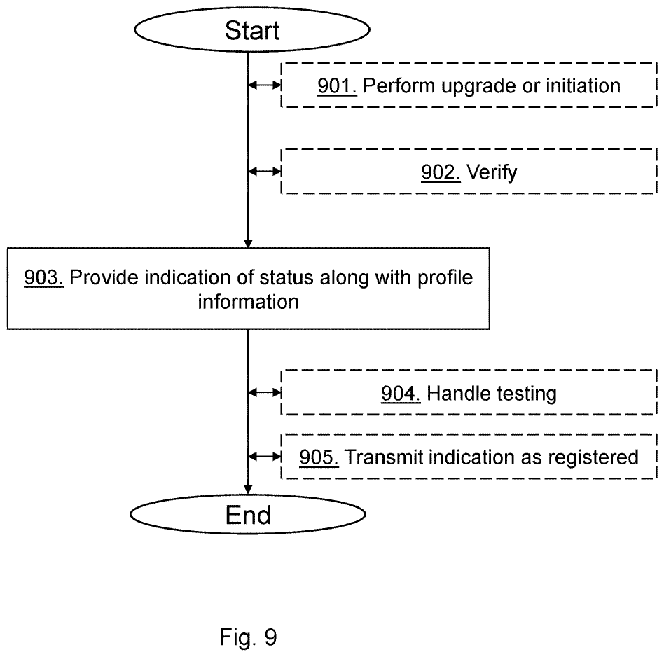

The method actions performed by the third network node 15, such as an SMF, PCF or a CHF, for handling a testing process associated with the third network node 15, for example, testing of an updated or initiated third network node 15, in the wireless communications network 1 according to embodiments will now be described with reference to a flowchart depicted in FIG. 9. The actions do not have to be taken in the order stated below but may be taken in any suitable order. Dashed boxes indicate optional features.

Action 901. The third network node 15 may perform upgrade or initiation.

Action 902. The third network node 15 may verify that a configuration to support testing exists in the third network node 15.

Action 903. The third network node 15 provides to the second network node 14 the indication of the status of the third network node 15, along with profile information of the third network node 15. The indication indicates a status related to testing, maintenance or updating of the third network node 15, and may be referred to as status indication. The third network node 15 may transmit the status indication to the second network node 14, indicating that the third network node is undiscoverable, or in a status related to testing such as a testing mode or a maintenance mode. The status indication may be values or indexes of the status. The third network node 15 may further provide or transmit the condition indication to the second network node 14. The condition indication may indicate a selection condition of UEs based on a set of UEs or a set of tracking areas. The condition indication may indicate: A set of Subscription Permanent Identifier (SUPI) for which the NF instance under TESTING status shall be selected; A set of Generic Public Subscription Identifier (GPSI) for which the NF instance under TESTING status shall be selected; A set of Permanent Equipment Identifier (PEI) of the UEs for which the NF instance under TESTING status shall be selected; or A set of TAI where the NF instance under TESTING status shall be selected for a certain UE. The condition indication may indicate a condition for selection of NF. The condition indication may be values or indexes of subscriber or TAIrange.

Action 904. The third network node 15 may then handle a testing process of the UE 10. For example, the third network node 15 may handle the testing such as handle PCC related to the testing process.

Action 905. In case testing process is successful, the third network node 15 may transmit to the second network node 14, an indication indicating a status of the third network node 15 as a registered third network node 15. For example, in case the one or more tests are successful, e.g., tests have passed pre-set threshold or similar, the third network node 15 may transmit to the second network node 14, the indication indicating the third network node 15 has a new status such as being a registered third network node. The indication may be values or indexes of the status. If the testing fails, the third network node 15 may not change status to registered.

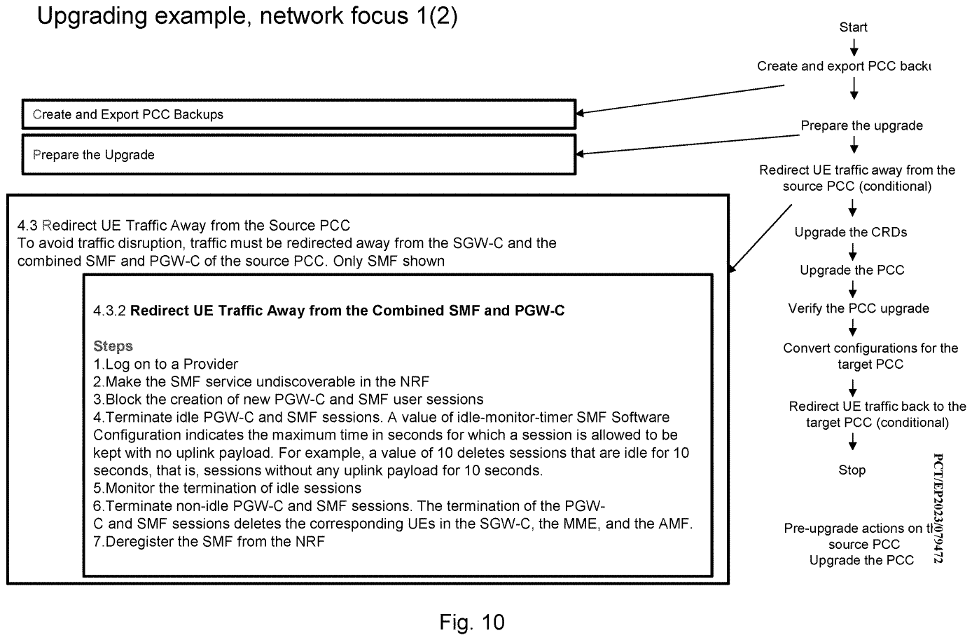

FIG. 10 shows an upgrading example 1(2) for upgrading a second network node such as an SMF.

Create and Export PCC Backups.

If the upgrade fails, operators can reinstall the PCC back to the source release. Kubernetes configuration and certificate files need to be saved and exported from the source PCC for reinstalling.
Save Kubernetes Files from the Source PCC

Non-default settings such as values, the content of configMaps, and secrets must be saved and reapplied on the target PCC. Ericsson recommends keeping the YAML files which were used during the source PCC deployment for later reuse.
Save the Configuration of the Source PCC

To save the configuration of the source PCC:

Collect the PCC configuration
Save the Certificate Files of the PC-SM

Prepare the Upgrade.

The following preparations may be needed before PCC upgrade:

Prepare custom values which was configured for PCC preparation during installation.

### 4.3 Redirect UE Traffic Away from the Source PCC

To avoid traffic disruption, traffic must be redirected away from the serving gateway (SGW)-Control Plane Function (C) and the combined SMF and PGW-C of the source PCC.

### 4.3.1 Redirect UE Traffic Away from the SGW-C

To redirect UE Traffic away from the SGW-C:
Steps
Log on to the Provider
Block the creation of new user sessions
Terminate idle sessions
Monitor the termination of idle sessions
Terminate non-idle sessions

### 4.3.2 Redirect UE Traffic Away from the Combined SMF and PGW-C

To redirect UE traffic away from the combined SMF and PGW-C:

### Steps

Log on to the Provider
Make the SMF service undiscoverable in the NRF
Block the creation of new PGW-C and SMF user sessions
Terminate idle PGW-C and SMF sessions. The value of idle-monitor-timerSMF Software Configuration indicates the maximum time in seconds for which a session is allowed to be kept with no uplink payload. For example, a value of 10 deletes sessions that are idle for 10 seconds that is, sessions without any uplink payload for 10 seconds.
Monitor the termination of idle sessions
Terminate non-idle PGW-C and SMF sessions. The termination of the PGW-C and SMF sessions deletes the corresponding UEs in the SGW-C, the MME, and the AMF.
Deregister the SMF from the NRF.

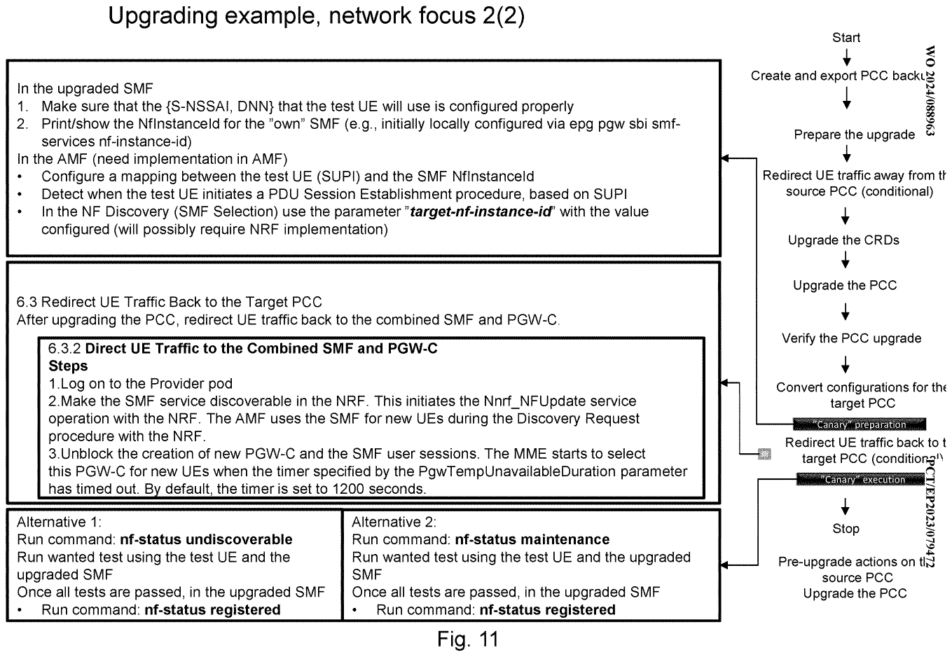

FIG. 11 shows an upgrading example 2(2) for upgrading the SMF.

In the upgraded SMF
1. Make sure that the {S-NSSAI, DNN} that the test UE will use is configured properly
2. Print/show the NflnstanceId for the “own” SMF (e.g., initially locally configured via epg pgw sbi smf-services nf-instance-id)

In the AMF (need implementation in AMF)
Configure a mapping between the test UE (SUPI) and the SMF NflnstanceId
Detect when the test UE initiates a PDU Session Establishment procedure, based on SUPI
In the NF Discovery (SMF Selection) use the parameter “target-nf-instance-id” with the value configured (will possibly require NRF implementation)

### 6.3 Redirect UE Traffic Back to the Target PCC

After upgrading the PCC, redirect UE traffic back to the combined SMF and PGW-C.

### 6.3.2 Direct UE Traffic to the Combined SMF and PGW-C

### Steps

1. Log on to the Provider pod
2. Make the SMF service discoverable in the NRF. This initiates the Nnrf_NFUpdate service operation with the NRF.
   The AMF uses the SMF for new UEs during the Discovery Request procedure with the NRF.
3. Unblock the creation of new PGW-C and the SMF user sessions. The MME starts to select this PGW-C for new UEs when the timer specified by the PgwTempUnavailableDuration parameter has timed out. By default, the timer is set to 1200 seconds.

### Canary Execution, Alternative 1:

Run command stating nf-status undiscoverable
Run wanted test using the test UE and the upgraded SMF
Once all tests are passed, in the upgraded SMF
Run command stating nf-status registered

### Canary Execution, Alternative 2:

Run command stating nf-status maintenance/testing
Run wanted test using the test UE and the upgraded SMF
Once all tests are passed, in the upgraded SMF
Run command stating nf-status registered

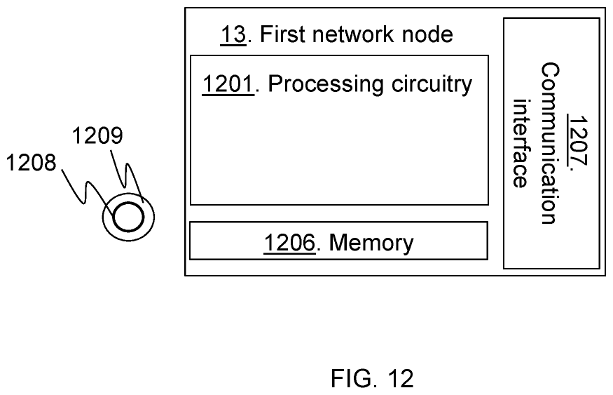

FIG. 12 is a block diagram depicting embodiments of the first network node 13, such as an AMF, for handling the testing process associated with the third network node 15 in the wireless communications network 1 according to embodiments herein.

The first network node 13 may comprise processing circuitry 1201, e.g., one or more processors, configured to perform the methods herein.

The first network node 13, and/or the processing circuitry 1201 is configured to obtain the instance identity of the updated or initiated third network node 15.

The first network node 13, and/or the processing circuitry 1201 is configured to store the one or more identities of one or more UEs (respectively) to be used during the testing process. The one or more identities are mapped to the obtained instance identity.

The first network node 13, and/or the processing circuitry 1201 is configured to, upon detection of a session establishment of the UE 10, check whether the identity of the UE 10 matches the stored one or more identities of the one or more UEs. With the proviso that the identity of the UE matches one of the stored one or more identities of the one or more UEs, the first network node 13, and/or the processing circuitry 1201 is configured to initiate the NF discovery towards the second network node 14 using the obtained instance identity mapped to the matched one identity. The first network node 13, and/or the processing circuitry 1201 may be configured to initiate the NF discovery by transmitting to the second network node 14 the indication indicating the requested status associated with the testing, maintenance, or updating mode of the third network node 15. Thus, the first network node 13 and/or the processing circuitry 1201 may be configured to transmit the indication being the flag indicating a maintenance mode or testing mode. The first network node 13 and/or the processing circuitry 1201 may be configured to evaluate or determine whether the identity of the UE 10 matches the stored UE identity, and that being the case the first network node 13 and/or the processing circuitry 1201 may be configured to initiate the NRF discovery network function for the third network node 15 being in maintenance mode or testing mode. In case there is no match, the first network node 13 and/or the processing circuitry 1201 may be configured to initiate a legacy performance for discovering a third network node such as an SMF.

The first network node 13, and/or the processing circuitry 1201 may be configured to receive the response from the second network node 14, indicating the profile of the updated or initiated third network node 15.

The first network node 13, and/or the processing circuitry 1201 may be configured to receive the response by receiving the one or more indications of the one or more profiles of the one or more third network nodes. The status of respective profile may be indicated in the response carrying the one or more indications.

The first network node 13, and/or the processing circuitry 1201 may be configured to select one profile with status indicating testing, maintenance or updating.

The first network node 13, and/or the processing circuitry 1201 may be configured to obtain the one or more identities of the one or more UEs to be used during the testing process mapped to the obtained instance identity in a local configuration.

The first network node 13 may comprise a memory 1206. The memory 1206 comprises one or more units to be used to store data on, such as data packets, subscription data, mapping, indications, status indication, instance identity, UE identities, mobility events, measurements, events and applications to perform the methods disclosed herein when being executed, and similar. Furthermore, the first network node 13 may comprise a communication interface 1207 comprising such as a transmitter, a receiver, a transceiver and/or one or more antennas.

The methods according to the embodiments described herein for the first network node 13 are respectively implemented by means of e.g., a computer program product 1208 or a computer program, comprising instructions, i.e., software code portions, which, when executed on at least one processor, cause the at least one processor to carry out the actions described herein, as performed by the first network node 13. The computer program product 1208 may be stored on a computer-readable storage medium 1209, e.g., a disc, a universal serial bus (USB) stick or similar. The computer-readable storage medium 1209, having stored thereon the computer program product, may comprise the instructions which, when executed on at least one processor, cause the at least one processor to carry out the actions described herein, as performed by the first network node 13. In some embodiments, the computer-readable storage medium may be a transitory or a non-transitory computer-readable storage medium. Thus, embodiments herein may disclose a first network node 13 for handling testing in a wireless communications network, wherein the first network node 13 comprises processing circuitry and a memory, said memory comprising instructions executable by said processing circuitry whereby said first network node is operative to perform any of the methods herein.

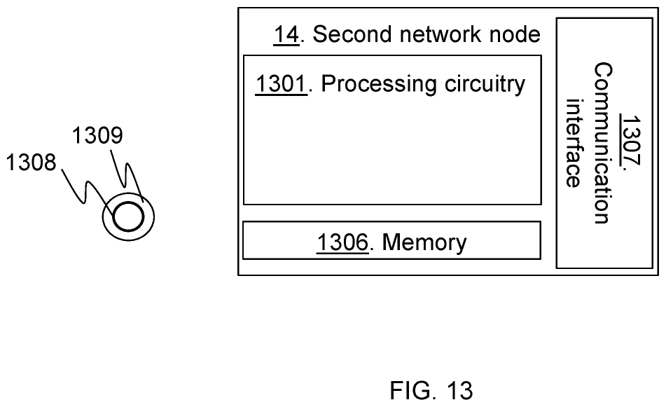

FIG. 13 is a block diagram depicting embodiments of the second network node 14, such as an NRF, for handling the testing process associated with the third network node 15 in the wireless communications network 1 according to embodiments herein.

The second network node 14 may comprise processing circuitry 1301, e.g., one or more processors, configured to perform the methods herein.

The second network node 14, and/or the processing circuitry 1301 is configured to obtain the instance identity of the updated or initiated third network node 15.

The second network node 14, and/or the processing circuitry 1301 is configured to receive the request from the first network node 13 related to the NF discovery using the instance identity.

The second network node 14, and/or the processing circuitry 1301 is configured to generate the response based on the instance identity, the status indication of the third network node 15, the condition indication, the received indication from the first network node 13 and/or previously stored status information. The response indicates the profile of the updated or initiated third network node 15.

The second network node 14, and/or the processing circuitry 1301 is configured to transmit the generated response to the first network node.

The second network node 14, and/or the processing circuitry 1301 may be configured to receive the request by receiving, from the first network node 13, the indication indicating a status for testing, maintenance or updating the third network node 15. The indication may comprise a flag called “testing mode”, or “maintenance mode” (boolean) set to true.

The second network node 14, and/or the processing circuitry 1301 may be configured to obtain the status indication from the third network node 15, indicating that the third network node 15 is undiscoverable, or in a status related to testing, maintenance or updating. Thus, the second network node 14 may set the NF Status to “Testing” or “Maintenance”, initiated via command in the third network node 15. The second network node 14 and/or the processing circuitry 1301 may be configured to obtain the condition indication. The second network node 14 and/or the processing circuitry 1301 may be configured to receive from the third network node 15 the condition indication indicating one or more conditions under which an NF Instance, i.e. the third network node 15, with an NFStatus value set to “TESTING” may be selected by an NF Service Consumer.

The second network node 14 and/or the processing circuitry 1301 may be configured to receive The second network node 14, and/or the processing circuitry 1301 may be configured to generate the response by applying, to the response, one or more indications of one or more profiles of one or more third network nodes. A status of respective profile may be indicated in the response carrying the one or more indications. The second network node 14, and/or the processing circuitry 1301 may be configured to generate and transit a list of profiles with respective indicated status.

The second network node 14 may comprise a memory 1306. The memory 1306 comprises one or more units to be used to store data on, such as data packets, subscription data, mapping, indications, status indication, instance identity, UE identities, mobility events, measurements, events and applications to perform the methods disclosed herein when being executed, and similar. Furthermore, the second network node 14 may comprise a communication interface 1307 comprising such as a transmitter, a receiver, a transceiver and/or one or more antennas.

The methods according to the embodiments described herein for the second network node 14 are respectively implemented by means of e.g., a computer program product 1308 or a computer program, comprising instructions, i.e., software code portions, which, when executed on at least one processor, cause the at least one processor to carry out the actions described herein, as performed by the second network node 14. The computer program product 1308 may be stored on a computer-readable storage medium 1309, e.g., a disc, a USB stick or similar. The computer-readable storage medium 1309, having stored thereon the computer program product, may comprise the instructions which, when executed on at least one processor, cause the at least one processor to carry out the actions described herein, as performed by the second network node 14. In some embodiments, the computer-readable storage medium may be a transitory or a non-transitory computer-readable storage medium. Thus, embodiments herein may disclose a second network node for handling testing in a wireless communications network, wherein the second network node comprises processing circuitry and a memory, said memory comprising instructions executable by said processing circuitry whereby said second network node is operative to perform any of the methods herein.

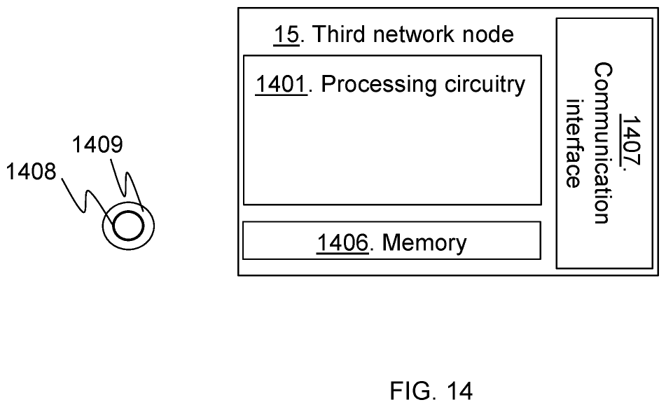

FIG. 14 is a block diagram depicting embodiments of the third network node 15, such as an SMF, PCF, or CHF, for handling the testing process associated with the third network node 15 in the wireless communications network 1 according to embodiments herein.

The third network node 15 may comprise processing circuitry 1401, e.g., one or more processors, configured to perform the methods herein.

The third network node 15, and/or the processing circuitry 1401 is configured to provide, to the second network node 14, the indication of the status of the third network node 15, along with the profile information of the third network node 15, wherein the indication indicates the status related to testing, maintenance or updating of the third network node 15. The third network node 15, and/or the processing circuitry 1401 may be configured to provide, such as transmit, to the second network node 14 the condition indication. The condition indication may indicate the selection condition of UEs based on a set of UEs or a set of tracking areas. For example, a set of SUPI for which the NF instance under TESTING status shall be selected; a set of GPSI for which the NF instance under TESTING status shall be selected; a set of PEI of the UEs for which the NF instance under TESTING status shall be selected; and/or a set of TAI where the NF instance under TESTING status shall be selected for a certain UE. The condition indication may indicate one or more conditions under which an NF Instance, i.e., the third network node 15, with an NFStatus value set to “TESTING” may be selected.

The third network node 15, and/or the processing circuitry 1401 may be configured to handle the testing process of the UE 10; and in case testing process is successful, the third network node 15, and/or the processing circuitry 1401 may be configured to transmit to the second network node 14, the indication indicating a status of the third network node 15 as a registered third network node.

The third network node 15 may comprise a memory 1406. The memory 1406 comprises one or more units to be used to store data on, such as data packets, subscription data, mapping, indications, status indication, instance ID, UE IDs, mobility events, measurements, events and applications to perform the methods disclosed herein when being executed, and similar. Furthermore, the third network node 15 may comprise a communication interface 1407 comprising such as a transmitter, a receiver, a transceiver and/or one or more antennas.

The methods according to the embodiments described herein for the third network node 15 are respectively implemented by means of e.g., a computer program product 1408 or a computer program, comprising instructions, i.e., software code portions, which, when executed on at least one processor, cause the at least one processor to carry out the actions described herein, as performed by the third network node 15. The computer program product 1408 may be stored on a computer-readable storage medium 1409, e.g., a disc, a USB stick or similar. The computer-readable storage medium 1409, having stored thereon the computer program product, may comprise the instructions which, when executed on at least one processor, cause the at least one processor to carry out the actions described herein, as performed by the third network node 15. In some embodiments, the computer-readable storage medium may be a transitory or a non-transitory computer-readable storage medium. Thus, embodiments herein may disclose a third network node for handling testing in a wireless communications network, wherein the third network node 15 comprises processing circuitry and a memory, said memory comprising instructions executable by said processing circuitry whereby said third network node is operative to perform any of the methods herein.

It should be noted that “transmitting to” and “receiving from” also cover embodiments where a message is transmitted via some intermediate node, i.e., “to” can be interpreted as “towards” and “from” can be interpreted as “transmitted by” (not necessarily directly “to” or “from”).

In some embodiments a more general term “network node” is used and it can correspond to any type of radio-network node or any network node, which communicates with a wireless device and/or with another network node. Examples of network nodes are NodeB, MeNB, SeNB, a network node belonging to Master Cell Group (MCG) or Secondary Cell Group (SCG), Base Station (BS), Multi-Standard Radio (MSR) radio node such as MSR BS, eNodeB, gNodeB, network controller, RNC, BSC, relay, donor node controlling relay, Base Transceiver Station (BTS), Access Point (AP), transmission points, transmission nodes, Remote Radio Unit (RRU), Remote Radio Head (RRH), nodes in Distributed Antenna System (DAS), etc.

In some embodiments the non-limiting term wireless device or UE is used and it refers to any type of wireless device communicating with a network node and/or with another wireless device in a cellular or mobile communication system. Examples of UE are target device, D2D UE, proximity capable UE (aka ProSe UE), machine type UE or UE capable of Machine to Machine (M2M) communication, Tablet, mobile terminals, smart phone, Laptop Embedded Equipped (LEE), Laptop Mounted Equipment (LME), USB dongles etc.

Embodiments are applicable to any RAT or multi-RAT systems, where the wireless device receives and/or transmit signals (e.g. data) e.g. NR, Wi-Fi, LTE, LTE-Advanced, WCDMA, GSM/Enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single Application-Specific Integrated Circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, Digital Signal Processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as Read-Only Memory (ROM), Random-Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings.

Instead, the embodiments herein are limited only by the following claims and their legal equivalents.

TABLE 6.1.6.1-1
Nnrf_NFManagement specific Data Types

| Data type | Clause defined | Description |
|---|---|---|
| NFProfile | 6.1.6.2.2 | Information of an NF Instance registered in the NRF. |
| NFService | 6.1.6.2.3 | Information of a given NF Service Instance; it is part of the |
| | | NFProfile of an NF Instance. |
| DefaultNotificationSubscription | 6.1.6.2.4 | Data structure for specifying the notifications the NF service |
| | | subscribes by default along with callback URI. |
| IpEndPoint | 6.1.6.2.5 | IP addressing information of a given NFService; it consists |
| | | on, e.g. IP address, TCP port, transport protocol . . . |
| UdrInfo | 6.1.6.2.6 | Information of an UDR NF Instance. |
| UdmInfo | 6.1.6.2.7 | Information of an UDM NF Instance. |
| AusfInfo | 6.1.6.2.8 | Information of an AUSF NF Instance. |
| SupiRange | 6.1.6.2.9 | A range of SUPIs (subscriber identities), either based on a |
| | | numeric range, or based on regular-expression matching. |
| IdentityRange | 6.1.6.2.10 | A range of subscriber identities, either based on a numeric |
| | | range, or based on regular-expression matching. |
| AmfInfo | 6.1.6.2.11 | Information of an AMF NF Instance. |
| SmfInfo | 6.1.6.2.12 | Information of an SMF NF Instance. |
| UpfInfo | 6.1.6.2.13 | Information of an UPF NF Instance. |
| SnssaiUpfInfoItem | 6.1.6.2.14 | Set of parameters supported by UPF for a given S-NSSAI. |
| DnnUpfInfoItem | 6.1.6.2.15 | Set of parameters supported by UPF for a given DNN. |
| SubscriptionData | 6.1.6.2.16 | Information of a subscription to notifications to NRF events, |
| | | included in subscription requests and responses. |
| NotificationData | 6.1.6.2.17 | Data sent in notifications from NRF to subscribed NF |
| | | Instances. |
| NFServiceVersion | 6.1.6.2.19 | Contains the version details of an NF service. |
| PcfInfo | 6.1.6.2.20 | Information of a PCF NF Instance. |
| BsfInfo | 6.1.6.2.21 | Information of a BSF NF Instance. |
| Ipv4AddressRange | 6.1.6.2.22 | Range of IPv4 addresses. |
| Ipv6PrefixRange | 6.1.6.2.23 | Range of IPv6 prefixes. |
| InterfaceUpfInfoItem | 6.1.6.2.24 | Information of a given IP interface of an UPF. |
| UriList | 6.1.6.2.25 | Set of URIs following 3GPP hypermedia format (containing |
| | | a “_links” attribute). |
| N2InterfaceAmfInfo | 6.1.6.2.26 | AMF N2 interface information |
| TaiRange | 6.1.6.2.27 | Range of TAIs (Tracking Area Identities). |
| TacRange | 6.1.6.2.28 | Range of TACs (Tracking Area Codes). |
| SnssaiSmfInfoItem | 6.1.6.2.29 | Set of parameters supported by SMF for a given S-NSSAI. |
| DnnSmfInfoItem | 6.1.6.2.30 | Set of parameters supported by SMF for a given DNN. |
| NrfInfo | 6.1.6.2.31 | Information of an NRF NF Instance, used in hierarchical |
| | | NRF deployments. |
| ChfInfo | 6.1.6.2.32 | Information of a CHF NF Instance. |
| PlmnRange | 6.1.6.2.34 | Range of PLMN IDs. |
| SubscrCond | 6.1.6.2.35 | Condition to determine the set of NFs to monitor under a |
| | | certain subscription in NRF. |
| NfInstanceIdCond | 6.1.6.2.36 | Subscription to a given NF Instance Id. |
| NfTypeCond | 6.1.6.2.37 | Subscription to a set of NFs based on their NF Type. |
| ServiceNameCond | 6.1.6.2.38 | Subscription to a set of NFs based on their support for a |
| | | given Service Name. |
| AmfCond | 6.1.6.2.39 | Subscription to a set of AMFs, based on AMF Set Id and/or |
| | | AMF Region Id. |
| GuamiListCond | 6.1.6.2.40 | Subscription to a set of AMFs, based on their GUAMIs. |
| NetworkSliceCond | 6.1.6.2.41 | Subscription to a set of NFs, based on the slices (S-NSSAI |
| | | and NSI) they support |
| NfGroupCond | 6.1.6.2.42 | Subscription to a set of NFs based on their Group Id. |
| NotifCondition | 6.1.6.2.43 | Condition (list of attributes in the NF Profile) to determine |
| | | whether a notification must be sent by NRF. |
| PlmnSnssai | 6.1.6.2.44 | List of network slices (S-NSSAIs) for a given PLMN ID. |
| NwdafInfo | 6.1.6.2.45 | Information of a NWDAF NF Instance. |
| LmfInfo | 6.1.6.2.46 | Information of an LMF NF Instance. |
| GmlcInfo | 6.1.6.2.47 | Information of a GMLC NF Instance. |
| NefInfo | 6.1.6.2.48 | Information of an NEF NF Instance. |
| PfdData | 6.1.6.2.49 | List of Application IDs and/or AF IDs managed by a given |
| | | NEF Instance. |
| AfEventExposureData | 6.1.6.2.50 | AF Event Exposure data managed by a given NEF |
| | | Instance. |
| WAgfInfo | 6.1.6.2.51 | Information of the W-AGF endpoints. |
| TngfInfo | 6.1.6.2.52 | Information of the TNGF endpoints. |
| PcscfInfo | 6.1.6.2.53 | Information of a P-CSCF NF Instance. |
| NfSetCond | 6.1.6.2.54 | Subscription to a set of NFs based on their Set Id. |
| NfServiceSetCond | 6.1.6.2.55 | Subscription to a set of NFs based on their Service Set Id. |
| NfInfo | 6.1.6.2.56 | Information of a generic NF Instance. |
| HssInfo | 6.1.6.2.57 | Information of an HSS NF Instance. |
| ImsiRange | 6.1.6.2.58 | A range of IMSIs (subscriber identities), either based on a |
| | | numeric range, or based on regular-expression matching. |
| InternalGroupIdRange | 6.1.6.2.59 | A range of Group IDs (internal group identities), either |
| | | based on a numeric range, or based on regular-expression |
| | | matching. |
| UpfCond | 6.1.6.2.60 | Subscription to a set of NF Instances (UPFs), able to serve |
| | | a certain service area (i.e. SMF serving area or TAI list). |
| TwifInfo | 6.1.6.2.61 | Addressing information (IP addresses, FQDN) of the TWIF. |
| VendorSpecificFeature | 6.1.6.2.62 | Information about a vendor-specific feature |
| UdsfInfo | 6.1.6.2.63 | Information related to UDSF |
| ScpInfo | 6.1.6.2.65 | Information of an SCP Instance |
| ScpDomainInfo | 6.1.6.2.66 | SCP domain information |
| ScpDomainCond | 6.1.6.2.67 | Subscription to an SCP domain |
| OptionsResponse | 6.1.6.2.68 | Communication options of the NRF |
| NwdafCond | 6.1.6.2.69 | Subscription to a set of NF Instances (NWDAFs), identified |
| | | by Analytics ID(s), S-NSSAI(s) or NWDAF Serving Area |
| | | information, i.e. list of TAls for which the NWDAF can |
| | | provide analytics. |
| NefCond | 6.1.6.2.70 | Subscription to a set of NF Instances (NEFs), identified by |
| | | Event ID(s) provided by AF, S-NSSAI(s), AF Instance ID, |
| | | Application Identifier, External Identifier, External Group |
| | | Identifier, or domain name. |
| SuciInfo | 6.1.6.2.71 | SUCI information containing Routing Indicator and Home |
| | | Network Public Key ID. |
| SeppInfo | 6.1.6.2.72 | Information of a SEPP Instance |
| AanfInfo | 6.1.6.2.73 | Information of an AAnF NF Instance. |
| 5GDdnmfInfo | 6.1.6.2.74 | Information of a 5G DDNMF NF Instance. |
| MfafInfo | 6.1.6.2.75 | Information of the MFAF NF Instance. |
| NwdafCapability | 6.1.6.2.76 | Indicates the capability supported by the NWDAF. |
| DccfInfo | 6.1.6.2.80 | Information of a DCCF NF Instance. |
| NsacfInfo | 6.1.6.2.81 | Information of an NSACF NF Instance. |
| NsacfCapability | 6.1.6.2.82 | NSACF service capability. |
| DccfCond | 6.1.6.2.83 | Subscription to a set of NF Instances (DCCFs), identified |
| | | by NF types, NF Set Id(s) or DCCF Serving Area |
| | | information, i.e. list of TAIs served by the DCCF. |
| MlAnalyticsInfo | 6.1.6.2.84 | ML Analytics Filter information supported by the |
| | | Nnwdaf_MLModelProvision service |
| MbSmfInfo | 6.1.6.2.85 | Information of a MB-SMF NF Instance |
| TmgiRange | 6.1.6.2.86 | Range of TMGIs |
| MbsSession | 6.1.6.2.87 | MBS Session served by an MB-SMF |
| SnssaiMbSmfInfoItem | 6.1.6.2.88 | Parameters supported by an MB-SMF for a given S-NSSAI |
| DnnMbSmfInfoItem | 6.1.6.2.89 | Parameters supported by an MB-SMF for a given DNN |
| TsctsfInfo | 6.1.6.2.91 | Information of a TSCTSF NF Instance. |
| SnssaiTsctsfInfoItem | 6.1.6.2.92 | Set of parameters supported by TSCTSF for a given S- |
| | | NSSAI. |
| DnnTsctsfInfoItem | 6.1.6.2.93 | Set of parameters supported by TSCTSF for a given DNN. |
| MbUpfInfo | 6.1.6.2.94 | Information of a MB-UPF NF Instance. |
| UnTrustAfInfo | 6.1.6.2.95 | Information of a untrusted AF Instance. |
| TrustAfInfo | 6.1.6.2.96 | Information of a trusted AF Instance |
| SnssaiInfoItem | 6.1.6.2.97 | Set of parameters supported by NF for a given S-NSSAI. |
| DnnInfoItem | 6.1.6.2.98 | Set of parameters supported by NF for a given DNN. |
| CollocatedNfInstance | 6.1.6.2.99 | Information related to collocated NF type(s) and |
| | | corresponding NF Instance(s) when the NF is collocated |
| | | with NFs supporting other NF types. |
| ServiceNameListCond | 6.1.6.2.100 | Subscription to a set of NF Instances that offer a service |
| | | name in the Service Name list. |
| NfGroupListCond | 6.1.6.2.101 | Subscription to a set of NF Instances, identified by a NF |
| | | Group Identity in the NF Group Identity list. |
| PlmnOauth2 | 6.1.6.2.102 | Per PLMN Oauth2.0 indication. |
| V2xCapability | 6.1.6.2.103 | Indicate the supported V2X Capability by the PCF. |
| NssaafInfo | 6.1.6.2.104 | Information of a NSSAAF NF Instance. |
| ProSeCapability | 6.1.6.2.105 | Indicate the supported ProSe Capability by the PCF. |
| SharedDataIdRange | 6.1.6.2.106 | |
| SubscriptionContext | 6.1.6.2.107 | Context data related to a created subscription, to be |
| | | included in notifications sent by NRF. |
| IwmscInfo | 6.1.6.2.108 | Information of a SMS-IWMSC NF Instance. |
| MnpfInfo | 6.1.6.2.109 | Information of an MNPF Instance. |
| DefSubServiceInfo | 6.1.6.2.110 | Service Specific Information for Default Notification |
| | | Subscription. |
| LocalityDescriptionItem | 6.1.6.2.111 | Description of locality information item |
| LocalityDescription | 6.1.6.2.112 | Description of locality information comprising one or more |
| | | locality information items |
| NFSelectionConditions | 6.1.6.2.x | Conditions under which an NF Instance with an |
| | | NFStatus value set to “TESTING” shall be selected by |
| | | an NF Service Consumer (e.g. if the UE belongs to a |
| | | range of SUPIs) |
| NefId | 6.1.6.3.2 | Identity of the NEF. |
| VendorId | 6.1.6.3.2 | Vendor ID of the NF Service instance (Private Enterprise |
| | | Number assigned by IANA) |
| WildcardDnai | 6.1.6.3.2 | Wildcard DNAI |
| NFType | 6.1.6.3.3 | NF types known to NRF. |
| NotificationType | 6.1.6.3.4 | Types of notifications used in Default Notification URIs in |
| | | the NF Profile of an NF Instance. |
| TransportProtocol | 6.1.6.3.5 | Types of transport protocol used in a given IP endpoint of |
| | | an NF Service Instance. |
| NotificationEventType | 6.1.6.3.6 | Types of events sent in notifications from NRF to |
| | | subscribed NF Instances. |
| NFStatus | 6.1.6.3.7 | Status of a given NF Instance stored in NRF. |
| DataSetId | 6.1.6.3.8 | Types of data sets stored in UDR. |
| UPInterfaceType | 6.1.6.3.9 | Types of User-Plane interfaces of the UPF. |
| ServiceName | 6.1.6.3.11 | Service names known to NRF. |
| NFServiceStatus | 6.1.6.3.12 | Status of a given NF Service Instance of an NF Instance |
| | | stored in NRF. |
| AnNodeType | 6.1.6.3.13 | Access Network Node Type (gNB, ng-eNB . . .). |
| ConditionEventType | 6.1.6.3.14 | Indicates whether a notification is due to the NF Instance to |
| | | start or stop being part of a condition for a subscription to a |
| | | set of NFs |
| IpReachability | 6.1.6.3.15 | Indicates the type(s) of IP addresses reachable via an |
| | | SCP. |
| CollocatedNfType | 6.1.6.3.17 | Possible NF types supported by a collocated NF. |
| LocalityType | 6.1.6.3.18 | Type of Locality description item. |

Table 6.1.6.1-2 specifies data types re-used by the Nnrf_NFManagement service-based interface protocol from other specifications, including a reference to their respective specifications and when needed, a short description of their use within the Nnrf_NFManagement service-based interface.

TABLE 6.1.6.1-2
Nnrf_NFManagement re-used Data Types

| Data type | Reference | Comments |
|---|---|---|
| N1MessageClass | 3GPP TS 29.518 [6] | The N1 message type |
| N2InformationClass | 3GPP TS 29.518 [6] | The N2 information type |
| IPv4Addr | 3GPP TS 29.571 [7] | |
| IPv6Addr | 3GPP TS 29.571 [7] | |
| IPv6Prefix | 3GPP TS 29.571 [7] | |
| Uri | 3GPP TS 29.571 [7] | |
| Dnn | 3GPP TS 29.571 [7] | |
| SupportedFeatures | 3GPP TS 29.571 [7] | |
| Snssai | 3GPP TS 29.571 [7] | |
| PlmnId | 3GPP TS 29.571 [7] | |
| Guami | 3GPP TS 29.571 [7] | |
| Tai | 3GPP TS 29.571 [7] | |
| NfInstanceId | 3GPP TS 29.571 [7] | |
| LinksValueSchema | 3GPP TS 29.571 [7] | 3GPP Hypermedia link |
| UriScheme | 3GPP TS 29.571 [7] | |
| AmfName | 3GPP TS 29.571 [7] | |
| DateTime | 3GPP TS 29.571 [7] | |
| Dnai | 3GPP TS 29.571 [7] | |
| ChangeItem | 3GPP TS 29.571 [7] | |
| DiameterIdentity | 3GPP TS 29.571 [7] | |
| AccessType | 3GPP TS 29.571 [7] | |
| NfGroupId | 3GPP TS 29.571 [7] | Network Function Group Id |
| AmfRegionId | 3GPP TS 29.571 [7] | |
| AmfSetId | 3GPP TS 29.571 [7] | |
| PduSessionType | 3GPP TS 29.571 [7] | |
| AtsssCapability | 3GPP TS 29.571 [7] | Capability to support procedures related to Access Traffic |
| | | Steering, Switching, Splitting. |
| Nid | 3GPP TS 29.571 [7] | |
| PlmnIdNid | 3GPP TS 29.571 [7] | |
| NfSetId | 3GPP TS 29.571 [7] | NF Set ID (see clause 28.12 of 3GPP TS 23.003 [12]) |
| NfServiceSetId | 3GPP TS 29.571 [7] | NF Service Set ID (see clause 28.13 of 3GPP TS 23.003 [12]) |
| GroupId | 3GPP TS 29.571 [7] | Internal Group Identifier |
| RatType | 3GPP TS 29.571 [7] | RAT Type |
| DurationSec | 3GPP TS 29.571 [7] | |
| RedirectResponse | 3GPP TS 29.571 [7] | Response body of the redirect response message. |
| ExtSnssai | 3GPP TS 29.571 [7] | |
| AreaSessionId | 3GPP TS 29.571 [7] | Area Session Identifier used for an MBS session with location |
| | | dependent content |
| MbsSessionId | 3GPP TS 29.571 [7] | MBS Session Identifier |
| MbsServiceArea | 3GPP TS 29.571 [7] | MBS Service Area |
| IpAddr | 3GPP TS 29.571 [7] | IP Address |
| MbsServiceAreaInfo | 3GPP TS 29.571 [7] | MBS Service Area Information for Location dependent MBS |
| | | session |
| Fqdn | 3GPP TS 29.571 [7] | Fully Qualified Domain Name |
| EventId | 3GPP TS 29.520 [32] | Defined in Nnwdaf_AnalyticsInfo API. |
| NwdafEvent | 3GPP TS 29.520 [32] | Defined in Nnwdaf_EventsSubscription API. |
| ExternalClientType | 3GPP TS 29.572 [33] | |
| LMFIdentification | 3GPP TS 29.572 [33] | LMF Identification |
| AfEvent | 3GPP TS 29.517 [35] | Defined in Naf_EventExposure API |
| SupportedGADShapes | 3GPP TS 29.572 [33] | Supported GAD Shapes |
| NetworkNodeDiameterAddress | 3GPP TS 29.503 [36] | Diameter Address of a Network Node |
| IpIndex | 3GPP TS 29.503 [36] | IP Index |

* * * Next Change * * * *

### 6.1.6.2.2 Type: NFProfile

TABLE 6.1.6.2.2-1
Definition of type NFProfile

| Attribute name | Data type | P | Cardinality | Description |
|---|---|---|---|---|
| nfInstanceId | NfInstanceId | M | 1 | Unique identity of the NF Instance. |
| nfType | NFType | M | 1 | Type of Network Function |
| nfStatus | NFStatus | M | 1 | Status of the NF Instance (NOTE 5) (NOTE 16) |
| collocatedNfInstances | array(CollocatedNfInstance) | O | 1 . . . N | Information related to collocated NF type(s) and |
| | | | | corresponding NF Instances when the NF is |
| | | | | collocated with NFs supporting other NF types. |
| | | | | (NOTE 21) |
| | | | | In this release of the specification, following |
| | | | | collocation scenarios are supported (see |
| | | | | clause 6.1.6.2.99): |
| | | | | a MB-SMF collocated with a SMF; |
| | | | | a MB-UPF collocated with a UPF. |
| nfInstanceName | string | O | 0 . . . 1 | Human readable name of the NF Instance |
| heartBeatTimer | integer | C | 0 . . . 1 | Time in seconds expected between 2 consecutive |
| | | | | heart-beat messages from an NF Instance to the NRF. |
| | | | | It may be included in the registration request. When |
| | | | | present in the request it shall contain the heartbeat |
| | | | | time proposed by the NF service consumer. |
| | | | | It shall be included in responses from NRF to |
| | | | | registration requests (PUT) or in NF profile updates |
| | | | | (PUT or PATCH). If the proposed heartbeat time is |
| | | | | acceptable by the NRF based on the local |
| | | | | configuration, it shall use the same value as in the |
| | | | | registration request; otherwise the NRF shall |
| | | | | override the value using a preconfigured value. |
| plmnList | array(PlmnId) | C | 1 . . . N | PLMN(s) of the Network Function (NOTE 7). |
| | | | | This IE shall be present if this information is |
| | | | | available for the NF. |
| | | | | If not provided, PLMN ID(s) of the PLMN of the NRF |
| | | | | are assumed for the NF. |
| snpnList | array(PlmnIdNid) | C | 1 . . . N | SNPN(s) of the Network Function. |
| | | | | This IE shall be present if the NF pertains to one or |
| | | | | more SNPNs. |
| sNssais | array(ExtSnssai) | O | 1 . . . N | S-NSSAIs of the Network Function. |
| | | | | If not provided, and if the perPlmnSnssaiList attribute |
| | | | | is not present, the NF can serve any S-NSSAI. |
| | | | | When present this IE represents the list of S-NSSAIs |
| | | | | supported in all the PLMNs listed in the plmnList IE. |
| | | | | If the sNSSAIs attribute is provided in at least one |
| | | | | NF Service, the S-NSSAIs supported by the NF |
| | | | | Profile shall be the set or a superset of the S- |
| | | | | NSSAIs of the NFService(s). |
| perPlmnSnssaiList | array(PlmnSnssai) | O | 1 . . . N | This IE may be included when the list of S-NSSAIs |
| | | | | supported by the NF for each PLMN it is supporting |
| | | | | is different. When present, this IE shall include the S- |
| | | | | NSSAIs supported by the Network Function for each |
| | | | | PLMN supported by the Network Function. When |
| | | | | present, this IE shall override sNssais IE. (NOTE 9) |
| | | | | If the perPlmnSnssaiList attribute is provided in at |
| | | | | least one NF Service, the S-NSSAIs supported per |
| | | | | PLMN in the NF Profile shall be the set or a superset |
| | | | | of the perPlmnSnssaiList of the NFService(s). |
| nsiList | array(string) | O | 1 . . . N | NSI identities of the Network Function. |
| | | | | If not provided, the NF can serve any NSI. |
| fqdn | Fqdn | C | 0 . . . 1 | FQDN of the Network Function (NOTE 1) (NOTE 2) |
| | | | | (NOTE 18). For AMF, the FQDN registered with the |
| | | | | NRF shall be that of the AMF Name (see |
| | | | | 3GPP TS 23.003 [12] clause 28.3.2.5). |
| interPlmnFqdn | Fqdn | C | 0 . . . 1 | If the NF needs to be discoverable by other NFs in a |
| | | | | different PLMN, then an FQDN that is used for inter- |
| | | | | PLMN routing as specified in 3GPP TS 23.003 [12] |
| | | | | shall be registered with the NRF (NOTE 8). |
| | | | | A change of this attribute shall result in triggering a |
| | | | | “NF_PROFILE_CHANGED” notification from NRF |
| | | | | towards subscribing NFs located in the same or a |
| | | | | different PLMN, but in the latter case the new value |
| | | | | shall be notified as a change of the “fqdn” attribute. |
| ipv4Addresses | array(Ipv4Addr) | C | 1 . . . N | IPv4 address(es) of the Network Function (NOTE 1) |
| | | | | (NOTE 2) (NOTE 18) |
| ipv6Addresses | array(Ipv6Addr) | C | 1 . . . N | IPv6 address(es) of the Network Function (NOTE 1) |
| | | | | (NOTE 2) (NOTE 18) |
| allowedPlmns | array(PlmnId) | O | 1 . . . N | PLMNs allowed to access the NF instance. |
| | | | | If not provided, any PLMN is allowed to access the NF. |
| | | | | This attribute shall not be included in profile change |
| | | | | notifications to subscribed NFs. (NOTE 17) |
| allowedSnpns | array(PlmnIdNid) | O | 1 . . . N | SNPNs allowed to access the NF instance. |
| | | | | If this attribute is present in the NFService and in the |
| | | | | NF profile, the attribute from the NFService shall |
| | | | | prevail. |
| | | | | The absence of this attribute in both the NFService |
| | | | | and in the NF profile indicates that no SNPN, other |
| | | | | than the SNPN(s) registered in the snpnList attribute |
| | | | | of the NF Profile, is allowed to access the service |
| | | | | instance. |
| | | | | This attribute shall not be included in profile change |
| | | | | notifications to subscribed NFs. (NOTE 17) |
| allowedNfTypes | array(NFType) | O | 1 . . . N | Type of the NFs allowed to access the NF instance. |
| | | | | If not provided, any NF type is allowed to access the NF. |
| | | | | This attribute shall not be included in profile change |
| | | | | notifications to subscribed NFs. (NOTE 17) |
| allowedNfDomains | array(string) | O | 1 . . . N | Pattern (regular expression according to the ECMA- |
| | | | | 262 dialect [8]) representing the NF domain names |
| | | | | within the PLMN of the NRF allowed to access the |
| | | | | NF instance. |
| | | | | If not provided, any NF domain is allowed to access |
| | | | | the NF. |
| | | | | This attribute shall not be included in profile change |
| | | | | notifications to subscribed NFs. (NOTE 17) |
| allowedNssais | array(ExtSnssai) | O | 1 . . . N | S-NSSAI of the allowed slices to access the NF |
| | | | | instance. |
| | | | | If not provided, any slice is allowed to access the NF. |
| | | | | This attribute shall not be included in profile change |
| | | | | notifications to subscribed NFs. (NOTE 17) |
| priority | integer | O | 0 . . . 1 | Priority (relative to other NFs of the same type) |
| | | | | within the range 0 to 65535, to be used for NF |
| | | | | selection; lower values indicate a higher priority. |
| | | | | Priority may or may not be present in the |
| | | | | nfServiceList parameters, xxxInfo parameters and in |
| | | | | this attribute. Priority in the nfServiceList has |
| | | | | precedence over the priority in this attribute |
| | | | | (NOTE 4). |
| | | | | Priority in xxxInfo parameter shall only be used to |
| | | | | determine the relative priority among NF instances |
| | | | | with the same priority at NFProfile/NFService. |
| | | | | The NRF may overwrite the received priority value |
| | | | | when exposing an NFProfile with the |
| | | | | Nnrf_NFDiscovery service. |
| capacity | integer | O | 0 . . . 1 | Static capacity information within the range 0 to |
| | | | | 65535, expressed as a weight relative to other NF |
| | | | | instances of the same type; if capacity is also |
| | | | | present in the nfServiceList parameters, those will |
| | | | | have precedence over this value. (NOTE 4). |
| load | integer | O | 0 . . . 1 | Dynamic load information, within the range 0 to 100, |
| | | | | indicates the current load percentage of the NF. |
| loadTimeStamp | DateTime | O | 0 . . . 1 | It indicates the point in time in which the latest load |
| | | | | information (sent by the NF in the “load” attribute of |
| | | | | the NF Profile) was generated at the NF Instance. |
| | | | | If the NF did not provide a timestamp, the NRF |
| | | | | should set it to the instant when the NRF received |
| | | | | the message where the NF provided the latest load |
| | | | | information. |
| locality | string | O | 0 . . . 1 | Operator defined information about the location of |
| | | | | the NF instance (e.g. geographic location, data |
| | | | | center) (NOTE 3) |
| extLocality | map(string) | O | 1 . . . N | Operator defined information about the location of |
| | | | | the NF instance. (NOTE 3) |
| | | | | The key of the map shall be a (unique) valid JSON |
| | | | | string per clause 7 of IETF RFC 8259 [22], with a |
| | | | | maximum of 32 characters, representing a type of |
| | | | | locality as defined in clause 6.1.6.3.x. |
| | | | | Example: |
| | | | | { |
| | | | | “DATA_CENTER”: “dc-123”, |
| | | | | “CITY”: “Los Angeles”, |
| | | | | “STATE”: “California” |
| | | | | } |
| udrInfo | UdrInfo | O | 0 . . . 1 | Specific data for the UDR (ranges of SUPI, group ID . . .) |
| udrInfoList | map(UdrInfo) | O | 1 . . . N | Multiple entries of UdrInfo. This attribute provides |
| | | | | additional information to the udrInfo. udrInfoList may |
| | | | | be present even if the udrInfo is absent. |
| | | | | The key of the map shall be a (unique) valid JSON |
| | | | | string per clause 7 of IETF RFC 8259 [22], with a |
| | | | | maximum of 32 characters. |
| udmInfo | UdmInfo | O | 0 . . . 1 | Specific data for the UDM (ranges of SUPI, group |
| | | | | ID . . .) |
| udmInfoList | map(UdmInfo) | O | 1 . . . N | Multiple entries of UdmInfo. This attribute provides |
| | | | | additional information to the udmInfo. udmInfoList |
| | | | | may be present even if the udmInfo is absent. |
| | | | | The key of the map shall be a (unique) valid JSON |
| | | | | string per clause 7 of IETF RFC 8259 [22], with a |
| | | | | maximum of 32 characters. |
| ausfInfo | AusfInfo | O | 0 . . . 1 | Specific data for the AUSF (ranges of SUPI, group |
| | | | | ID . . .) |
| ausfInfoList | map(AusfInfo) | O | 1 . . . N | Multiple entries of AusfInfo. This attribute provides |
| | | | | additional information to the ausfInfo. ausfInfoList |
| | | | | may be present even if the ausfInfo is absent. |
| | | | | The key of the map shall be a (unique) valid JSON |
| | | | | string per clause 7 of IETF RFC 8259 [22], with a |
| | | | | maximum of 32 characters. |
| amfInfo | AmfInfo | O | 0 . . . 1 | Specific data for the AMF (AMF Set ID, . . .) |
| amfInfoList | map(AmfInfo) | O | 1 . . . N | Multiple entries of AmfInfo. This attribute provides |
| | | | | additional information to the amfInfo. amfInfoList |
| | | | | may be present even if the amfInfo is absent. |
| | | | | The key of the map shall be a (unique) valid JSON |
| | | | | string per clause 7 of IETF RFC 8259 [22], with a |
| | | | | maximum of 32 characters. |
| smfInfo | SmfInfo | O | 0 . . . 1 | Specific data for the SMF (DNN's, . . .). |
| | | | | (NOTE 12) |
| smfInfoList | map(SmfInfo) | O | 1 . . . N | Multiple entries of SmfInfo. This attribute provides |
| | | | | additional information to the smfInfo. smfInfoList may |
| | | | | be present even if the smfInfo is absent. |
| | | | | The key of the map shall be a (unique) valid JSON |
| | | | | string per clause 7 of IETF RFC 8259 [22], with a |
| | | | | maximum of 32 characters. |
| | | | | (NOTE 12) |
| upfInfo | UpfInfo | O | 0 . . . 1 | Specific data for the UPF (S-NSSAI, DNN, SMF |
| | | | | serving area, interface . . .) |
| upfInfoList | map(UpfInfo) | O | 1 . . . N | Multiple entries of UpfInfo. This attribute provides |
| | | | | additional information to the upfInfo. upfInfoList may |
| | | | | be present even if the upfInfo is absent. |
| | | | | The key of the map shall be a (unique) valid JSON |
| | | | | string per clause 7 of IETF RFC 8259 [22], with a |
| | | | | maximum of 32 characters. |
| pcfInfo | PcfInfo | O | 0 . . . 1 | Specific data for the PCF. |
| pcfInfoList | map(PcfInfo) | O | 1 . . . N | Multiple entries of PcfInfo. This attribute provides |
| | | | | additional information to the pcfInfo. pcfInfoList may |
| | | | | be present even if the pcfInfo is absent. |
| | | | | The key of the map shall be a (unique) valid JSON |
| | | | | string per clause 7 of IETF RFC 8259 [22], with a |
| | | | | maximum of 32 characters. |
| bsfInfo | BsfInfo | O | 0 . . . 1 | Specific data for the BSF. |
| bsfInfoList | map(BsfInfo) | O | 1 . . . N | Multiple entries of BsfInfo. This attribute provides |
| | | | | additional information to the bsfInfo. bsfInfoList may |
| | | | | be present even if the bsfInfo is absent. |
| | | | | The key of the map shall be a (unique) valid JSON |
| | | | | string per clause 7 of IETF RFC 8259 [22], with a |
| | | | | maximum of 32 characters. |
| chfInfo | ChfInfo | O | 0 . . . 1 | Specific data for the CHF. |
| chfInfoList | map(ChfInfo) | O | 1 . . . N | Multiple entries of ChfInfo. This attribute provides |
| | | | | additional information to the chfInfo. chfInfoList may |
| | | | | be present even if the chfInfo is absent. |
| | | | | The key of the map shall be a (unique) valid JSON |
| | | | | string per clause 7 of IETF RFC 8259 [22], with a |
| | | | | maximum of 32 characters. |
| nefInfo | NefInfo | O | 0 . . . 1 | Specific data for the NEF. |
| nrfInfo | NrfInfo | O | 0 . . . 1 | Specific data for the NRF. |
| udsfInfo | UdsfInfo | O | 0 . . . 1 | Specific data for the UDSF. |
| udsfInfoList | map(UdsfInfo) | O | 1 . . . N | Multiple entries of udsfInfo. This attribute provides |
| | | | | additional information to the udsfInfo. udsfInfoList |
| | | | | may be present even if the udsfInfo is absent. |
| | | | | The key of the map shall be a (unique) valid JSON |
| | | | | string per clause 7 of IETF RFC 8259 [22], with a |
| | | | | maximum of 32 characters. |
| nwdafInfo | NwdafInfo | O | 0 . . . 1 | Specific data for the NWDAF. |
| nwdafInfoList | map(NwdafInfo) | O | 1 . . . N | Multiple entries of nwdafInfo. This attribute provides |
| | | | | additional information to the nwdafInfo. nwdafInfoList |
| | | | | may be present even if the nwdafInfo is absent. |
| | | | | The key of the map shall be a (unique) valid JSON |
| | | | | string per clause 7 of IETF RFC 8259 [22], with a |
| | | | | maximum of 32 characters. |
| pcscfInfoList | map(PcscfInfo) | O | 1 . . . N | Specific data for the P-CSCF. |
| | | | | The key of the map shall be a (unique) valid JSON |
| | | | | string per clause 7 of IETF RFC 8259 [22], with a |
| | | | | maximum of 32 characters. |
| | | | | (NOTE 11) |
| hssInfoList | map(HssInfo) | O | 1 . . . N | Specific data for the HSS. |
| | | | | The key of the map shall be a (unique) valid JSON |
| | | | | string per clause 7 of IETF RFC 8259 [22], with a |
| | | | | maximum of 32 characters. |
| customInfo | object | O | 0 . . . 1 | Specific data for custom Network Functions |
| recoveryTime | DateTime | O | 0 . . . 1 | Timestamp when the NF was (re)started (NOTE 5) |
| | | | | (NOTE 6) |
| nfServicePersistence | boolean | O | 0 . . . 1 | true: If present, and set to true, it indicates that the |
| | | | | different service instances of a same NF Service in |
| | | | | this NF instance, supporting a same API version, are |
| | | | | capable to persist their resource state in shared |
| | | | | storage and therefore these resources are available |
| | | | | after a new NF service instance supporting the same |
| | | | | API version is selected by a NF Service Consumer |
| | | | | (see 3GPP TS 23.527 [27]). |
| | | | | false (default): Otherwise, it indicates that the NF |
| | | | | Service Instances of a same NF Service are not |
| | | | | capable to share resource state inside the NF |
| | | | | Instance. |
| nfServices | array(NFService) | O | 1 . . . N | List of NF Service Instances. It shall include the |
| | | | | services produced by the NF that can be discovered |
| | | | | by other NFs, if any. (NOTE 15) |
| | | | | This attribute is deprecated; the attribute |
| | | | | “nfServiceList” should be used instead. |
| nfServiceList | map(NFService) | O | 1 . . . N | Map of NF Service Instances, where the |
| | | | | “serviceInstanceId” attribute of the NFService object |
| | | | | shall be used as the key of the map. (NOTE 15) |
| | | | | It shall include the services produced by the NF that |
| | | | | can be discovered by other NFs, if any. |
| nfProfileChangesSupportInd | boolean | O | 0 . . . 1 | NF Profile Changes Support Indicator. |
| | | | | See Annex B. |
| | | | | This IE may be present in the NFRegister or |
| | | | | NFUpdate (NF Profile Complete Replacement) |
| | | | | request and shall be absent in the response. |
| | | | | true: the NF Service Consumer supports receiving |
| | | | | NF Profile Changes in the response. |
| | | | | false (default): the NF Service Consumer does not |
| | | | | support receiving NF Profile Changes in the |
| | | | | response. |
| | | | | Write-Only: true |
| nfProfileChangesInd | boolean | O | 0 . . . 1 | NF Profile Changes Indicator. |
| | | | | See Annex B. |
| | | | | This IE shall be absent in the request to the NRF |
| | | | | and may be included by the NRF in NFRegister or |
| | | | | NFUpdate (NF Profile Complete Replacement) |
| | | | | response. |
| | | | | true: the NF Profile contains NF Profile changes. |
| | | | | false (default): complete NF Profile. |
| | | | | Read-Only: true |
| defaultNotifi- | array(DefaultNotifi- | O | 1 . . . N | Notification endpoints for different notification types. |
| cationSubscriptions | cationSubscription) | | | (NOTE 10) |
| lmfInfo | LmfInfo | O | 0 . . . 1 | Specific data for the LMF. |
| gmlcInfo | GmlcInfo | O | 0 . . . 1 | Specific data for the GMLC. |
| nfSetIdList | array(NfSetId) | C | 1 . . . N | NF Set ID defined in clause 28.12 of |
| | | | | 3GPP TS 23.003 [12]. |
| | | | | At most one NF Set ID shall be indicated per PLMN- |
| | | | | ID or SNPN of the NF. |
| | | | | This information shall be present if available. |
| | | | | (NOTE 22) (NOTE 23) |
| servingScope | array(string) | O | 1 . . . N | The served area(s) of the NF instance. |
| | | | | The absence of this attribute does not imply that the |
| | | | | NF instance can serve every area in the PLMN. |
| | | | | (NOTE 13) |
| lcHSupportInd | boolean | O | 0 . . . 1 | This IE indicates whether the NF supports Load |
| | | | | Control based on LCI Header (see clause 6.3 of |
| | | | | 3GPP TS 29.500 [4]). |
| | | | | true: the NF supports the feature. |
| | | | | false (default): the NF does not support |
| | | | | the feature. |
| olcHSupportInd | boolean | O | 0 . . . 1 | This IE indicates whether the NF supports Overload |
| | | | | Control based on OCI Header (see clause 6.4 of |
| | | | | 3GPP TS 29.500 [4]). |
| | | | | true: the NF supports the feature. |
| | | | | false (default): the NF does not support |
| | | | | the feature. |
| nfSetRecoveryTimeList | map(DateTime) | O | 1 . . . N | Map of recovery time, where the key of the map is |
| | | | | the NfSetId of NF Set(s) that the NF instance |
| | | | | belongs to. |
| | | | | When present, the value of each entry of the map |
| | | | | shall be the recovery time of the NF Set indicated by |
| | | | | the key. |
| serviceSetRecoveryTimeList | map(DateTime) | O | 1 . . . N | Map of recovery time, where the key of the map is |
| | | | | the NfServiceSetId of the NF Service Set(s) |
| | | | | configured in the NF instance. |
| | | | | When present, the value of each entry of the map |
| | | | | shall be the recovery time of the NF Service Set |
| | | | | indicated by the key. |
| scpDomains | array(string) | O | 1 . . . N | When present, this IE shall carry the list of SCP |
| | | | | domains the SCP belongs to, or the SCP domain the |
| | | | | NF (other than SCP) or the SEPP belongs to. |
| | | | | (NOTE 14) |
| scpInfo | ScpInfo | O | 0 . . . 1 | Specific data for the SCP. |
| seppInfo | SeppInfo | O | 0 . . . 1 | Specific data for the SEPP. |
| vendorId | VendorId | O | 0 . . . 1 | Vendor ID of the NF instance, according to the |
| | | | | IANA-assigned “SMI Network Management Private |
| | | | | Enterprise Codes” [38]. |
| supportedVendorSpecif- | map(array(VendorSpecif- | O | 1 . . . N(1 . . . M) | Map of Vendor-Specific features, where the key of |
| icFeatures | icFeature)) | | | the map is the IANA-assigned “SMI Network |
| | | | | Management Private Enterprise Codes” [38]. The |
| | | | | string used as key of the map shall contain 6 decimal |
| | | | | digits; if the SMI code has less than 6 digits, it shall |
| | | | | be padded with leading digits “0” to complete a 6- |
| | | | | digit string value. |
| | | | | The value of each entry of the map shall be a list |
| | | | | (array) of VendorSpecificFeature objects. |
| | | | | (NOTE 19) |
| aanfInfoList | map(AanfInfo) | O | 1 . . . N | Multiple entries of AanfInfo. |
| | | | | The key of the map shall be a (unique) valid JSON |
| | | | | string per clause 7 of IETF RFC 8259 [22], with a |
| | | | | maximum of 32 characters. |
| 5gDdnmfInfo | 5GDdnmfInfo | O | 0 . . . 1 | Specific data for the 5G DDNMF (5G DDNMF ID, . . .) |
| mfafInfo | MfafInfo | O | 0 . . . 1 | Specific data for the MFAF |
| easdfInfoList | map(EasdfInfo) | O | 1 . . . N | EASDF specific data. |
| | | | | The key of the map shall be a (unique) valid JSON |
| | | | | string per clause 7 of IETF RFC 8259 [22], with a |
| | | | | maximum of 32 characters. (NOTE 20) |
| dccfInfo | DccfInfo | O | 0 . . . 1 | Specific data for the DCCF. |
| nsacfInfoList | map(NsacfInfo) | O | 1 . . . N | Specific data for the NSACF. |
| | | | | The key of the map shall be a (unique) valid JSON |
| | | | | string per clause 7 of IETF RFC 8259 [22], with a |
| | | | | maximum of 32 characters. |
| mbSmfInfoList | map(MbSmfInfo) | O | 1 . . . N | MB-SMF specific data. |
| | | | | The key of the map shall be a (unique) valid JSON |
| | | | | string per clause 7 of IETF RFC 8259 [22], with a |
| | | | | maximum of 32 characters. |
| tsctsfInfoList | map(TsctsfInfo) | O | 1 . . . N | Specific data for the TSCTSF. |
| | | | | The key of the map shall be a (unique) valid JSON |
| | | | | string per clause 7 of IETF RFC 8259 [22], with a |
| | | | | maximum of 32 characters. |
| mbUpfInfoList | map(MbUpfInfo) | O | 1 . . . N | MB-UPF specific data. |
| | | | | The key of the map shall be a (unique) valid JSON |
| | | | | string per clause 7 of IETF RFC 8259 [22], with a |
| | | | | maximum of 32 characters. |
| trustAfInfo | TrustAfInfo | O | 0 . . . 1 | Specific data for the trusted AF. |
| nssaafInfo | NssaafInfo | O | 0 . . . 1 | Specific data for the NSSAAF. |
| hniList | arrary(Fqdn) | C | 1 . . . N | Identifications of Credentials Holder or Default |
| | | | | Credentials Server. |
| | | | | This IE shall be present if the NFs are available for |
| | | | | the case of access to an SNPN using credentials |
| | | | | owned by a Credentials Holder or for the case of |
| | | | | SNPN Onboarding using a DCS. |
| iwmscInfo | IwmscInfo | O | 0 . . . 1 | Specific data for the SMS-IWMSC. |
| mnpfInfo | MnpfInfo | O | 0 . . . 1 | Specific data for the MNPF. |
| nfSelectionConditions | NfSelectionConditions | O | 0 . . . 1 | Conditions under which an NF Instance with an |
| | | | | NFStatus value set to “TESTING” shall be |
| | | | | selected by an NF Service Consumer (e.g. if the |
| | | | | UE belongs to a range of SUPIs) |

(NOTE 1):
At least one of the addressing parameters (fqdn, ipv4address or ipv6adress) shall be included in the NF Profile. If the NF supports the NF services with “https” URI scheme (i.e use of TLS is mandatory), then the FQDN shall be provided in the NF Profile or the NF Service profile (see clause 6.1.6.2.3) and it shall be used to construct the target URI (unless overriden by a NFService-specific FQDN). See NOTE 1 of Table 6.1.6.2.3-1 for the use of these parameters. If multiple ipv4 addresses and/or ipv6 addresses are included in the NF Profile, the NF Service Consumer of the discovery service shall select one of these addresses randomly, unless operator defined local policy of IP address selection, in order to avoid overload for a specific ipv4 address and/or ipv6 address.
(NOTE 2):
If the type of Network Function is UPF or MB-UPF, the addressing information is for the UPF N4 interface or MB-UPF N4mb interface respectively. If the type of Network Function is a P-CSCF and if no Gm FQDN or IP addresses are registered in the pcscfInfoList attribute, the addressing information is also used for the P-CSCF Gm interface.
(NOTE 3):
A requester NF may use this information to select a NF instance (e.g. a NF instance preferably located in the same data center).
(NOTE 4):
The capacity and priority parameters, if present, are used for NF selection and load balancing. The priority and capacity attributes shall be used for NF selection in the same way that priority and weight are used for server selection as defined in IETF RFC 2782 [23].
(NOTE 5):
The NRF shall notify NFs subscribed to receiving notifications of changes of the NF profile, if the NF recoveryTime or the nfStatus is changed. See clause 6.2 of 3GPP TS 23.527 [27].
(NOTE 6):
A requester NF may consider that all the resources created in the NF before the NF recovery time have been lost. This may be used to detect a restart of a NF and to trigger appropriate actions, e.g. release local resources. See clause 6.2 of 3GPP TS 23.527 [27].
(NOTE 7):
A NF may register multiple PLMN IDs in its profile within a PLMN comprising multiple PLMN IDs. If so, all the attributes of the NF Profile shall apply to each PLMN ID registered in the plmnList. As an exception, attributes including a PLMN ID, e.g. IMSI-based SUPI ranges, TAIs and GUAMIs, are specific to one PLMN ID and the NF may register in its profile multiple occurrences of such attributes for different PLMN IDs (e.g. the UDM may register in its profile SUPI ranges for different PLMN IDs).
(NOTE 8):
Other NFs are in a different PLMN if they belong to none of the PLMN ID(s) configured for the PLMN of the NRF.
(NOTE 9):
This is for the use case where an NF (e.g. AMF) supports multiple PLMNs and the slices supported in each PLMN are different. See clause 9.2.6.2 of 3GPP TS 38.413 [29].
(NOTE 10):
For notification types that may be associated with a specifc service of the NF Instance receiving the notification (see clause 6.1.6.3.4), if notification endpoints are present both in the profile of the NF instance (NFProfile) and in some of its NF Services (NFService) for a same notification type, the notification endpoint(s) of the NF Services shall be used for this notification type. The defaultNotificationSubscriptions attribute may contain multiple default subscriptions for a same notification type; in that case, those default subscriptions are used as alternative notification endpoints so, for each notification event that needs to be sent, the NF Service Consumer shall select one of such subscriptions and use it to send the notification.
(NOTE 11):
The absence of the pcscfInfoList attribute in a P-CSCF profile indicates that the P-CSCF can be selected for any DNN and Access Type, and that the P-CSCF Gm addressing information is the same as the addressing information registered in the fqdn, ipv4Addresses and ipv4Addresses attributes of the NF profile.
(NOTE 12):
The absence of both the smfInfo and smfInfoList attributes in an SMF profile indicates that the SMF can be selected for any S-NSSAI listed in the sNssais and perPlmnSnssaiList IEs, or for any S-NSSAI if neither the sNssais IE nor the perPlmnSnssaiList IE are present, and for any DNN, TAI and access type.
(NOTE 13):
The servingScope attribute may indicate geographical areas, It may be used e.g. to discover and select NFs in centralized Data Centers that are expected to serve users located in specific region(s) or province(s). It may also be used to reduce the large configuration of TAIs in the NF instances.
(NOTE 14):
An NF (other than a SCP) can register at most one SCP domain in NF profile, i.e. the NF can belong to only one SCP domain. If an NF (other than a SCP) includes this information in its profile, this indicates that the services produced by this NF should be accessed preferably via an SCP from the SCP domain the NF belongs to.
(NOTE 15):
If the NF Service Consumer that issues an NF profile retrieval request indicates support for the “Service-Map” feature, the NRF shall return in the NF profile retrieval response the list of NF Service Instances in the “nfServiceList” map attribute. Otherwise, the NRF shall return the list of NF Service Instances in the “nfServices” array attribute.
(NOTE 16):
The nfStatus also indicate the Status of the NF instance as NF Service Consumer for notification delivery. When a notification is to be delivered to the NF instance and the NF Service Producer (or SCP) has been aware that the NF instance is not operative from the nfStatus in its NF profile, the NF Service producer (or SCP) shall reselect another NF Service Consumer as target if possible, e.g. using binding indication or discovery factors previously provided for the notification. When selecting or reselecting an NF Service Consumer for notification delivery, not operative NF instances shall not be selected as target.
(NOTE 17):
A change of this attribute shall trigger a “NF_PROFILE_CHANGED” notification from NRF, if the change of the NF Profile results in that the NF Instance starts or stops being authorized to be accessed by an NF having subscribed to be notified about NF profile changes.
(NOTE 18):
For API URIs constructed with an FQDN, the NF Service Consumer may use the FQDN of the target URI to do a DNS query and obtain the IP address(es) to setup the TCP connection, and ignore the IP addresses that may be present in the NFProfile; alternatively, the NF Service Consumer may use those IP addresses to setup the TCP connection, if no service-specific FQDN or IP address is provided in the NFService data and if the NF Service Consumer supports to indicate specific IP address(es) to establish an HTTP/2 connection with an FQDN in the target URI.
(NOTE 19):
When present, this attribute allows an NF requesting NF Discovery (e.g. an NF Service Consumer) to determine which vendor-specific extensions are supported in a given NF (e.g. an NF Service Producer), so as to select an appropriate NF with specific capability, or to include or not the vendor-specific attributes (see 3GPP TS 29.500 [4] clause 6.6.3) required for a given feature in subsequent messages towards a certain NF. One given vendor-specific feature shall not appear in both NF Profile and NF Service Profile. If one vendor-specific feature is service related, it shall only be included in the NF Service Profile.
(NOTE 20):
The absence of the easdfInfoList attribute in an EASDF profile indicates that the EASDF can be selected for any S-NSSAI, DNN, DNAI or PSA UPF N6 IP address.
(NOTE 21):
The NF service consumer when invoking NF services offered by collocated NF service producers shall follow the respective service API in the same manner as if they were not collocated with any other NF type. The NF service consumer shall not assume any optimization of signaling between the NF service consumer and the collocated NF service producers.
(NOTE 22):
The nfSetIdList attribute shall be present only if all NF service instance(s) of the NF instance are redundant at NF Set level. I.e. any NF service instance shall be redundant (i.e. functionally equivalent, interchangeable and sharing contexts) with equivalent service instance(s) of every other NF instance(s) within the indicated NF Set or, if the NF service instance belongs to an NF service set, it shall be redundant with NF service instance(s) in an equivalent NF service set of every other NF instance(s) within the indicated NF set.
(NOTE 23):
The NF Instance shall be removed from an NF set or re-assigned to another NF set ONLY when there is NO ongoing resource/context associated with the NF instance.
* * * Next Change * * * *

TABLE 6.1.6.2.x-1
Definition of type NFSelectionConditions

| Attribute name | Data type | P | Cardinality | Description |
|---|---|---|---|---|
| supiRangeList | array(SupiRange) | O | 1 . . . N | A set of SUPI for which the NF instance under |
| | | | | TESTING status shall be selected |
| gpsiRangeList | array(IdentityRange) | O | 1 . . . N | A set of GPSI for which the NF instance under |
| | | | | TESTING status shall be selected |
| peiList | array(Pei) | O | 1 . . . N | A set of PEI of the UEs for which the NF instance |
| | | | | under TESTING status shall be selected |
| taiRangeList | array(TaiRange) | O | 1 . . . N | A set of TAI where the NF instance under |
| | | | | TESTING status shall be selected for a certain UE |

NOTE:
If several attributes (conditions) are present, the NF shall be selected by the consumer if at least one of the conditions is met.
* * * Next Change * * * *

### 6.1.6.3.6 Enumeration: Notification EventType

TABLE 6.1.6.3.6-1
Enumeration NotificationEventType

| Enumeration value | Description |
|---|---|
| “NF_REGISTERED” | The NF Instance has been registered in NRF |
| “NF_DEREGISTERED” | The NF Instance has been deregistered from NRF (NOTE) |
| “NF_PROFILE_CHANGED” | The profile of the NF Instance has been modified (NOTE) |

(NOTE):
A change of the NFStatus value shall be notified as “NF_PROFILE_CHANGED” event, except if the NFStatus is set to value “TESTING” and the subscribing entity does not support the “Canary-Testing” feature; in such case, the subscribing entity shall be notified as a “NF DEREGISTERED” event.
* * * Next Change * * * *

### 6.1.6.3.7 Enumeration: NFStatus

TABLE 6.1.6.3.7-1
Enumeration NFStatus

| Enumeration value | Description |
|---|---|
| “REGISTERED” | The NF Instance is registered in NRF and can be |
| | discovered by other NFs. |
| “SUSPENDED” | The NF Instance is registered in NRF but it is not operative |
| | and cannot be discovered by other NFs. |
| | This status may result from a NF Heart-Beat failure (see |
| | clause 5.2.2.3.2) or a NF failure and may trigger restoration |
| | procedures (see clause 6.2 of 3GPP 23.527 [27]). |
| “UNDISCOVERABLE” | The NF instance is registered in NRF, is operative but |
| | cannot be discovered by other NFs. |
| | This status may be set by the NF e.g. in shutting down |
| | scenarios where the NF is still able to process requests for |
| | existing resources or sessions but cannot accept new |
| | resource creation or session establishment. |
| “TESTING” | The NF instance is registered in NRF, is operative and |
| | can be discovered and selected by other NFs under |
| | certain conditions (see NFSelectionConditions, in |
| | clause 6.1.6.2.x). |
| | This status may be set by the NF e.g. in upgrade |
| | scenarios or during canary tests scenarios where the |
| | NF is able to process requests for new resource |
| | creation or session establishment under certain |
| | conditions (e.g. for a restricted set of users). |

* * * Next Change * * * *

### 6.1.9 Features Supported by the NFManagement Service

The syntax of the supportedFeatures attribute is defined in clause 5.2.2 of 3GPP TS 29.571 [7].

The following features are defined for the Nnrf_NFManagement service.

TABLE 6.1.9-1
Features of supportedFeatures attribute used by Nnrf_NFManagement service

| Feature | | | |
|---|---|---|---|
| Number | Feature | M/O | Description |
| 1 | Service-Map | M | Support of defining in the profile of the NF Instance the list of NF |
| | | | Service Instances based on a map type (i.e. support of the |
| | | | “nfServiceList” attribute in NFProfile). |
| 2 | Empty-Objects- | O | Support of receiving empty JSON objects as values in the |
| | Nrf-Info | | servedxxxInfo/servedxxxInfoList map attributes of the NrfInfo data |
| | | | structure used by an NRF during registration into another NRF (see |
| | | | clause 6.1.6.2.31). |
| | | | An NRF that supports registering into another NRF shall support this |
| | | | feature. |
| x | Canary-Testing | O | Support of “TESTING” value for NFStatus, used for e.g. canary |
| | | | testing |

Feature number: The order number of the feature within the supportedFeatures attribute (starting with 1).
Feature: A short name that can be used to refer to the bit and to the feature.
M/O: Defines if the implementation of the feature is mandatory (“M”) or optional (“O”).
Description: A clear textual description of the feature.
* * * Next Change * * * *

### 6.2.6.1 General

This clause specifies the application data model supported by the API.

TABLE 6.2.6.1-1
Nnrf_NFDiscovery specific Data Types

| Data type | Clause defined | Description |
|---|---|---|
| SearchResult | 6.2.6.2.2 | Contains the list of NF Profiles returned in a Discovery |
| | | response. |
| NFProfile | 6.2.6.2.3 | Information of an NF Instance discovered by the NRF. |
| NFService | 6.2.6.2.4 | Information of a given NF Service Instance; it is part of |
| | | the NFProfile of an NF Instance discovered by the NRF. |
| StoredSearchResult | 6.2.6.2.5 | Contains a complete search result (i.e. a number of |
| | | discovered NF Instances), stored by NRF as a |
| | | consequence of a prior search result. |
| PreferredSearch | 6.2.6.2.6 | Contains information on whether the returned NFProfiles |
| | | match the preferred query parameters. |
| NfInstanceInfo | 6.2.6.2.7 | Contains information on an NF profile matching a |
| | | discovery request. |
| ScpDomainRoutingInfo | 6.2.6.2.8 | SCP Domain Routing Information |
| ScpDomainConnectivity | 6.2.6.2.9 | SCP Domain Routing Information |
| ScpDomainRoutingInfoSubscription | 6.2.6.2.10 | SCP Domain Routing Information Subscription |
| ScpDomainRoutingInfoNotification | 6.2.6.2.11 | Notification for SCP Domain Routing Information Update |
| NfServiceInstance | 6.2.6.2.12 | NF service instance |
| NoProfileMatchInfo | 6.2.6.2.13 | No Profile Matching information |
| QueryParamCombination | 6.2.6.2.14 | Contains a list of query parameters |
| QueryParameter | 6.2.6.2.15 | Contains name and value of a query parameter |

Table 6.2.6.1-2 specifies data types re-used by the Nnrf_NFDiscovery service-based interface protocol from other specifications, including a reference to their respective specifications and when needed, a short description of their use within the Nnrf_NFDiscovery service-based interface.

TABLE 6.2.6.1-2
Nnrf_NFDiscovery re-used Data Types

| Data type | Reference | Comments |
|---|---|---|
| Snssai | 3GPP TS 29.571 [7] | |
| PlmnId | 3GPP TS 29.571 [7] | |
| Dnn | 3GPP TS 29.571 [7] | |
| Tai | 3GPP TS 29.571 [7] | |
| SupportedFeatures | 3GPP TS 29.571 [7] | |
| NfInstanceId | 3GPP TS 29.571 [7] | |
| Uri | 3GPP TS 29.571 [7] | |
| Gpsi | 3GPP TS 29.571 [7] | |
| GroupId | 3GPP TS 29.571 [7] | |
| Guami | 3GPP TS 29.571 [7] | |
| IPv4Addr | 3GPP TS 29.571 [7] | |
| IPv6Addr | 3GPP TS 29.571 [7] | |
| UriScheme | 3GPP TS 29.571 [7] | |
| Dnai | 3GPP TS 29.571 [7] | |
| NfGroupId | 3GPP TS 29.571 [7] | Identifier of a NF Group |
| PduSessionType | 3GPP TS 29.571 [7] | |
| AtsssCapability | 3GPP TS 29.571 [7] | |
| PlmnIdNid | 3GPP TS 29.571 [7] | |
| NfSetId | 3GPP TS 29.571 [7] | |
| NfServiceSetId | 3GPP TS 29.571 [7] | |
| ExtSnssai | 3GPP TS 29.571 [7] | |
| DurationSec | 3GPP TS 29.571 [7] | |
| RedirectResponse | 3GPP TS 29.571 [7] | Response body of the redirect response message. |
| MbsSessionId | 3GPP TS 29.571 [7] | MBS Session Identifier |
| IpAddr | 3GPP TS 29.571 [7] | IP Address |
| AreaSessionId | 3GPP TS 29.571 [7] | Area Session Identifier used for an MBS session with |
| | | location dependent content |
| Fqdn | 3GPP TS 29.571 [7] | Fully Qualified Domain Name |
| EventId | 3GPP TS 29.520 [32] | Defined in Nnwdaf_AnalyticsInfo API. |
| NwdafEvent | 3GPP TS 29.520 [32] | Defined in Nnwdaf_EventsSubscription API. |
| ExtGroupId | 3GPP TS 29.503 [36] | |
| SharedDataId | 3GPP TS 29.503 [36] | |
| ExternalClientType | 3GPP TS 29.572 [33] | |
| SupportedGADShapes | 3GPP TS 29.572 [33] | Supported GAD Shapes |
| DefaultNotificationSubscription | 3GPP TS 29.510 | See clause 6.1.6.2.4 |
| IPEndPoint | 3GPP TS 29.510 | See clause 6.1.6.2.5 |
| NFType | 3GPP TS 29.510 | See clause 6.1.6.3.3 |
| UdrInfo | 3GPP TS 29.510 | See clause 6.1.6.2.6 |
| UdmInfo | 3GPP TS 29.510 | See clause 6.1.6.2.7 |
| AusfInfo | 3GPP TS 29.510 | See clause 6.1.6.2.8 |
| SupiRange | 3GPP TS 29.510 | See clause 6.1.6.2.9 |
| AmfInfo | 3GPP TS 29.510 | See clause 6.1.6.2.11 |
| SmfInfo | 3GPP TS 29.510 | See clause 6.1.6.2.12 |
| UpfInfo | 3GPP TS 29.510 | See clause 6.1.6.2.13 |
| PcfInfo | 3GPP TS 29.510 | See clause 6.1.6.2.20 |
| BsfInfo | 3GPP TS 29.510 | See clause 6.1.6.2.21 |
| ChfInfo | 3GPP TS 29.510 | See clause 6.1.6.2.32 |
| NFServiceVersion | 3GPP TS 29.510 | See clause 6.1.6.2.19 |
| PlmnSnssai | 3GPP TS 29.510 | See clause 6.1.6.2.44 |
| NwdafInfo | 3GPP TS 29.510 | See clause 6.1.6.2.45 |
| NFStatus | 3GPP TS 29.510 | See clause 6.1.6.3.7 |
| DataSetId | 3GPP TS 29.510 | See clause 6.1.6.3.8 |
| ServiceName | 3GPP TS 29.510 | See clause 6.1.6.3.11 |
| NFServiceStatus | 3GPP TS 29.510 | See clause 6.1.6.3.12 |
| LmfInfo | 3GPP TS 29.510 | See clause 6.1.6.2.46 |
| GmlcInfo | 3GPP TS 29.510 | See clause 6.1.6.2.47 |
| NefInfo | 3GPP TS 29.510 | See clause 6.1.6.2.48 |
| PfdData | 3GPP TS 29.510 | See clause 6.1.6.2.49 |
| AfEventExposureData | 3GPP TS 29.510 | See clause 6.1.6.2.50 |
| PcscfInfo | 3GPP TS 29.510 | See clause 6.1.6.2.53 |
| HssInfo | 3GPP TS 29.510 | See clause 6.1.6.2.57 |
| ImsiRange | 3GPP TS 29.510 | See clause 6.1.6.2.58 |
| VendorSpecificFeature | 3GPP TS 29.510 | See clause 6.1.6.2.62 |
| ScpInfo | 3GPP TS 29.510 | See clause 6.1.6.2.65 |
| NefId | 3GPP TS 29.510 | See clause 6.1.6.3 |
| VendorId | 3GPP TS 29.510 | See clause 6.1.6.3 |
| AnNodeType | 3GPP TS 29.510 | See clause 6.1.6.3.13 |
| SuciInfo | 3GPP TS 29.510 | See clause 6.1.6.2.71 |
| SeppInfo | 3GPP TS 29.510 | See clause 6.1.6.2.72 |
| NsacfInfo | 3GPP TS 29.510 | See clause 6.1.6.2.81 |
| NsacfCapability | 3GPP TS 29.510 | See clause 6.1.6.2.82 |
| MIAnalyticsInfo | 3GPP TS 29.510 | See clause 6.1.6.2.84 |
| MbSmfInfo | 3GPP TS 29.510 | See clause 6.1.6.2.85 |
| TsctsfInfo | 3GPP TS 29.510 | See clause 6.1.6.2.91 |
| MbUpfInfo | 3GPP TS 29.510 | See clause 6.1.6.2.94 |
| TrustAfInfo | 3GPP TS 29.510 | See clause 6.1.6.2.96 |
| CollocatedNfInstance | 3GPP TS 29.510 | See clause 6.1.6.2.99 |
| NssaafInfo | 3GPP TS 29.510 | See clause 6.1.6.2.104 |
| IwmscInfo | 3GPP TS 29.510 | See clause 6.1.6.2.108 |
| MnpfInfo | 3GPP TS 29.510 | See clause 6.1.6.2.109 |
| LocalityDescriptionItem | 3GPP TS 29.510 | See clause 6.1.6.2.111 |
| LocalityDescription | 3GPP TS 29.510 | See clause 6.1.6.2.112 |
| LocalityType | 3GPP TS 29.510 | See clause 6.1.6.3.18 |
| NfSelectionConditions | 3GPP TS 29.510 | See clause 6.1.6.2.x |

* * * Next Change * * * *

### 6.2.6.2.3 Type: NFProfile

TABLE 6.2.6.2.3-1
Definition of type NFProfile

| Attribute name | Data type | P | Cardinality | Description |
|---|---|---|---|---|
| nfInstanceId | NfInstanceId | M | 1 | Unique identity of the NF Instance. |
| nfType | NFType | M | 1 | Type of Network Function |
| nfStatus | NFStatus | M | 1 | Status of the NF Instance |
| collocatedInstances | array(CollocatedNfInstance) | O | 1 . . . N | Information related collocated NF type(s) and |
| | | | | corresponding NF Instance(s) when the NF is |
| | | | | collocated with NFs supporting other NF types |
| nfInstanceName | string | O | 0 . . . 1 | Human readable name of the NF Instance |
| plmnList | array(PlmnId) | C | 1 . . . N | PLMN(s) of the Network Function (NOTE 5). This IE |
| | | | | shall be present if this information is available for the |
| | | | | NF. If this information was not provided by the NF |
| | | | | during registration, the NRF should return the list of |
| | | | | PLMN ID(s) of the PLMN of the NRF. If this IE is |
| | | | | absent in the response, PLMN ID(s) of the PLMN of |
| | | | | the NRF are assumed for the NF. |
| sNssais | array(ExtSnssai) | O | 1 . . . N | S-NSSAIs of the Network Function. |
| | | | | If not provided, and if the perPlmnSnssaiList attribute |
| | | | | is not present, the NF can serve any S-NSSAI. |
| | | | | If the sNSSAIs attribute is provided in at least one |
| | | | | NF Service, the sNssais attribute in the NF Profile |
| | | | | shall be present and be the set or a superset of the |
| | | | | sNSSAIs of the NFService(s). |
| perPlmnSnssaiList | array(PlmnSnssai) | O | 1 . . . N | The per-PLMN list of S-NSSAI(s) supported by the |
| | | | | Network Function. |
| | | | | If the perPlmnSnssaiList attribute is provided in at |
| | | | | least one NF Service, the perPlmnSnssaiList |
| | | | | attribute in the NF Profile shall be present and be the |
| | | | | set or a superset of the perPlmnSnssaiList of the |
| | | | | NFService(s). |
| nsiList | array(string) | O | 1 . . . N | List of NSIs of the Network Function. |
| | | | | If not provided, the NF can serve any NSI. |
| fqdn | Fqdn | C | 0 . . . 1 | FQDN of the Network Function (NOTE 1, NOTE 3, |
| | | | | NOTE 11) |
| interPlmnFqdn | Fqdn | C | 0 . . . 1 | If the requester-plmn-list query parameter is absent |
| | | | | in the NF Discovery request, or if is present and the |
| | | | | requester's PLMN is the same as the PLMN of the |
| | | | | discovered NF, then this attribute shall be included |
| | | | | by the NRF and it shall contain the interPlmnFqdn |
| | | | | value registered by the NF during NF registration |
| | | | | (see clause 6.1.6.2.2), if the interPlmnFqdn attribute |
| | | | | was registered in the NF profile. |
| | | | | This attribute shall be absent if the requester-plmn in |
| | | | | the query parameter is different from the PLMN of |
| | | | | the discovered NF. |
| | | | | (NOTE 3, NOTE 14) |
| ipv4Addresses | array(Ipv4Addr) | C | 1 . . . N | IPv4 address(es) of the Network Function (NOTE 1, |
| | | | | NOTE 11) |
| ipv6Addresses | array(Ipv6Addr) | C | 1 . . . N | IPV6 address(es) of the Network Function (NOTE 1, |
| | | | | NOTE 11) |
| capacity | integer | O | 0 . . . 1 | Static capacity information within the range 0 to |
| | | | | 65535, expressed as a weight relative to other NF |
| | | | | instances of the same type; if capacity is also |
| | | | | present in the nfServiceList parameters, those will |
| | | | | have precedence over this value. (See NOTE 2) |
| load | integer | O | 0 . . . 1 | Latest known load information of the NF within the |
| | | | | range 0 to 100 in percentage (See NOTE 4) |
| loadTimeStamp | DateTime | O | 0 . . . 1 | It indicates the point in time in which the latest load |
| | | | | information of the NF Instance was sent from the NF |
| | | | | to the NRF. |
| locality | string | O | 0 . . . 1 | Operator defined information about the location of |
| | | | | the NF instance (e.g. geographic location, data |
| | | | | center) |
| extLocality | map(string) | O | 1 . . . N | Operator defined information about the location of |
| | | | | the NF instance. (NOTE 3) |
| | | | | The key of the map shall be a (unique) valid JSON |
| | | | | string per clause 7 of IETF RFC 8259 [22], with a |
| | | | | maximum of 32 characters, representing a type of |
| | | | | locality as defined in clause 6.1.6.3.x. |
| | | | | Example: |
| | | | | { |
| | | | | “DATA_CENTER”: “dc-123” |
| | | | | “CITY”: “Los Angeles”, |
| | | | | “STATE”: “California” |
| | | | | } |
| priority | integer | O | 0 . . . 1 | Priority (relative to other NFs of the same type) |
| | | | | within the range 0 to 65535, to be used for NF |
| | | | | selection; lower values indicate a higher priority. |
| | | | | Priority may or may not be present in the |
| | | | | nfServiceList parameters, xxxInfo parameters and in |
| | | | | this attribute. Priority in the nfServiceList has |
| | | | | precedence over the priority in this attribute. |
| | | | | (NOTE 2) |
| | | | | Priority in xxxInfo parameter shall only be used to |
| | | | | determine the relative priority among NF instances |
| | | | | with the same priority at NFProfile/NFService. |
| udrInfo | UdrInfo | O | 0 . . . 1 | Specific data for the UDR (ranges of SUPI, . . .) |
| udrInfoList | map(UdrInfo) | O | 1 . . . N | Multiple entries of UdrInfo. This attribute provides |
| | | | | additional information to the udrInfo. udrInfoList may |
| | | | | be present even if the udrInfo is absent. |
| | | | | The key of the map shall be a (unique) valid JSON |
| | | | | string per clause 7 of IETF RFC 8259 [22], with a |
| | | | | maximum of 32 characters. |
| udmInfo | UdmInfo | O | 0 . . . 1 | Specific data for the UDM |
| udmInfoList | map(UdmInfo) | O | 1 . . . N | Multiple entries of UdmInfo. This attribute provides |
| | | | | additional information to the udmInfo. udmInfoList |
| | | | | may be present even if the udmInfo is absent. |
| | | | | The key of the map shall be a (unique) valid JSON |
| | | | | string per clause 7 of IETF RFC 8259 [22], with a |
| | | | | maximum of 32 characters. |
| ausfInfo | AusfInfo | O | 0 . . . 1 | Specific data for the AUSF |
| ausfInfoList | map(AusfInfo) | O | 1 . . . N | Multiple entries of AusfInfo. This attribute provides |
| | | | | additional information to the ausfInfo. ausfInfoList |
| | | | | may be present even if the ausfInfo is absent. |
| | | | | The key of the map shall be a (unique) valid JSON |
| | | | | string per clause 7 of IETF RFC 8259 [22], with a |
| | | | | maximum of 32 characters. |
| amfInfo | AmfInfo | O | 0 . . . 1 | Specific data for the AMF (AMF Set ID, . . .) |
| amfInfoList | map(AmfInfo) | O | 1 . . . N | Multiple entries of AmfInfo. This attribute provides |
| | | | | additional information to the amfInfo. amfInfoList |
| | | | | may be present even if the amfInfo is absent. |
| | | | | The key of the map shall be a (unique) valid JSON |
| | | | | string per clause 7 of IETF RFC 8259 [22], with a |
| | | | | maximum of 32 characters. |
| smfInfo | SmfInfo | O | 0 . . . 1 | Specific data for the SMF (DNN's, . . .). |
| | | | | (NOTE 8) |
| smfInfoList | map(SmfInfo) | O | 1 . . . N | Multiple entries of SmfInfo. This attribute provides |
| | | | | additional information to the smfInfo. smfInfoList may |
| | | | | be present even if the smfInfo is absent. |
| | | | | The key of the map shall be a (unique) valid JSON |
| | | | | string per clause 7 of IETF RFC 8259 [22], with a |
| | | | | maximum of 32 characters. |
| | | | | (NOTE 8) |
| upfInfo | UpfInfo | O | 0 . . . 1 | Specific data for the UPF (S-NSSAI, DNN, SMF |
| | | | | serving area, . . .) |
| upfInfoList | map(UpfInfo) | O | 1 . . . N | Multiple entries of UpfInfo. This attribute provides |
| | | | | additional information to the upfInfo. upfInfoList may |
| | | | | be present even if the upfInfo is absent. |
| | | | | The key of the map shall be a (unique) valid JSON |
| | | | | string per clause 7 of IETF RFC 8259 [22], with a |
| | | | | maximum of 32 characters. |
| pcfInfo | PcfInfo | O | 0 . . . 1 | Specific data for the PCF |
| pcfInfoList | map(PcfInfo) | O | 1 . . . N | Multiple entries of PcfInfo. This attribute provides |
| | | | | additional information to the pcfInfo. pcfInfoList may |
| | | | | be present even if the pcfInfo is absent. |
| | | | | The key of the map shall be a (unique) valid JSON |
| | | | | string per clause 7 of IETF RFC 8259 [22], with a |
| | | | | maximum of 32 characters. |
| bsfInfo | BsfInfo | O | 0 . . . 1 | Specific data for the BSF |
| bsfInfoList | map(BsfInfo) | O | 1 . . . N | Multiple entries of BsfInfo. This attribute provides |
| | | | | additional information to the bsfInfo. bsfInfoList may |
| | | | | be present even if the bsfInfo is absent. |
| | | | | The key of the map shall be a (unique) valid JSON |
| | | | | string per clause 7 of IETF RFC 8259 [22], with a |
| | | | | maximum of 32 characters. |
| chfInfo | ChfInfo | O | 0 . . . 1 | Specific data for the CHF |
| chfInfoList | map(ChfInfo) | O | 1 . . . N | Multiple entries of ChfInfo. This attribute provides |
| | | | | additional information to the chfInfo. chfInfoList may |
| | | | | be present even if the chfInfo is absent. |
| | | | | The key of the map shall be a (unique) valid JSON |
| | | | | string per clause 7 of IETF RFC 8259 [22], with a |
| | | | | maximum of 32 characters. |
| udsfInfo | UdsfInfo | O | 0 . . . 1 | Specific data for the UDSF |
| udsfInfoList | map(UdsfInfo) | O | 1 . . . N | Multiple entries of udsfInfo. This attribute provides |
| | | | | additional information to the udsfInfo. udsfInfoList |
| | | | | may be present even if the udsfInfo is absent. |
| | | | | The key of the map shall be a (unique) valid JSON |
| | | | | string per clause 7 of IETF RFC 8259 [22], with a |
| | | | | maximum of 32 characters. |
| nefInfo | NefInfo | O | 0 . . . 1 | Specific data for the NEF |
| nwdafInfo | NwdafInfo | O | 0 . . . 1 | Specific data for the NWDAF |
| nwdafInfoList | map(NwdafInfo) | O | 1 . . . N | Multiple entries of nwdafInfo. This attribute provides |
| | | | | additional information to the nwdafInfo. nwdafInfoList |
| | | | | may be present even if the nwdafInfo is absent. |
| | | | | The key of the map shall be a (unique) valid JSON |
| | | | | string per clause 7 of IETF RFC 8259 [22], with a |
| | | | | maximum of 32 characters. |
| pcscfInfoList | map(PcscfInfo) | O | 1 . . . N | Specific data for the P-CSCF. |
| | | | | The key of the map shall be a (unique) valid JSON |
| | | | | string per clause 7 of IETF RFC 8259 [22], with a |
| | | | | maximum of 32 characters. |
| | | | | (NOTE 7) |
| hssInfoList | map(HssInfo) | O | 1 . . . N | Specific data for the HSS. |
| | | | | The key of the map shall be a (unique) valid JSON |
| | | | | string per clause 7 of IETF RFC 8259 [22], with a |
| | | | | maximum of 32 characters. |
| customInfo | object | O | 0 . . . 1 | Specific data for custom Network Functions |
| recoveryTime | DateTime | O | 0 . . . 1 | Timestamp when the NF was (re)started |
| nfServicePersistence | boolean | O | 0 . . . 1 | true: If present, and set to true, it indicates that the |
| | | | | different service instances of a same NF Service in |
| | | | | the NF instance, supporting a same API version, are |
| | | | | capable to persist their resource state in shared |
| | | | | storage and therefore these resources are available |
| | | | | after a new NF service instance supporting the same |
| | | | | API version is selected by a NF Service Consumer |
| | | | | (see 3GPP TS 23.527 [27]). |
| | | | | false (default): Otherwise, it indicates that the NF |
| | | | | Service Instances of a same NF Service are not |
| | | | | capable to share resource state inside the NF |
| | | | | Instance. |
| nfServices | array(NFService) | O | 1 . . . N | List of NF Service Instances. |
| | | | | (NOTE 10) |
| | | | | This attribute is deprecated; the attribute |
| | | | | “nfServiceList” should be used instead. |
| nfServiceList | map(NFService) | O | 1 . . . N | Map of NF Service Instances, where the |
| | | | | “serviceInstanceId” attribute of the NFService object |
| | | | | shall be used as the key of the map. |
| | | | | (NOTE 10) |
| defaultNotifi- | array(DefaultNotifi- | O | 1 . . . N | Notification endpoints for different notification types. |
| cationSubscriptions | cationSubscription) | | | (NOTE 6) |
| | | | | (See also NOTE 10 in clause 6.1.6.2.2) |
| lmfInfo | LmfInfo | O | 0 . . . 1 | Specific data for the LMF |
| gmlcInfo | GmlcInfo | O | 0 . . . 1 | Specific data for the GMLC |
| snpnList | array(PlmnIdNid) | C | 1 . . . N | SNPN(s) of the Network Function. |
| | | | | This IE shall be present if the NF pertains to one or |
| | | | | more SNPNs. |
| nfSetIdList | array(NfSetId) | C | 1 . . . N | NF Set ID defined in clause 28.12 of |
| | | | | 3GPP TS 23.003 [12]. |
| | | | | At most one NF Set ID shall be indicated per PLMN- |
| | | | | ID or SNPN of the NF. |
| | | | | This information shall be present if available. |
| servingScope | array(string) | O | 1 . . . N | The served area(s) of the NF instance. |
| | | | | The absence of this attribute does not imply the NF |
| | | | | instance can serve every area. |
| lcHSupportInd | boolean | O | 0 . . . 1 | This IE indicates whether the NF supports Load |
| | | | | Control based on LCI Header (see clause 6.3 of |
| | | | | 3GPP TS 29.500 [4]). |
| | | | | true: the NF supports the feature. |
| | | | | false (default): the NF does not support |
| | | | | the feature. |
| olcHSupportInd | boolean | O | 0 . . . 1 | This IE indicates whether the NF supports Overload |
| | | | | Control based on OCI Header (see clause 6.4 of |
| | | | | 3GPP TS 29.500 [4]). |
| | | | | true: the NF supports the feature. |
| | | | | false (default): the NF does not support |
| | | | | the feature. |
| nfSetRecoveryTimeList | map(DateTime) | O | 1 . . . N | Map of recovery time, where the key of the map is |
| | | | | the NfSetId of NF Set(s) that the NF instance |
| | | | | belongs to. |
| | | | | When present, the value of each entry of the map |
| | | | | shall be the recovery time of the NF Set indicated by |
| | | | | the key. |
| serviceSetRecoveryTimeList | map(DateTime) | O | 1 . . . N | Map of recovery time, where the key of the map is |
| | | | | the NfServiceSetId of the NF Service Set(s) |
| | | | | configured in the NF instance. |
| | | | | When present, the value of each entry of the map |
| | | | | shall be the recovery time of the NF Service Set |
| | | | | indicated by the key. |
| scpDomains | array(string) | O | 1 . . . N | When present, this IE shall carry the list of SCP |
| | | | | domains the SCP belongs to, or the SCP domain the |
| | | | | NF (other than SCP) or the SEPP belongs to. |
| | | | | (NOTE 9) |
| scpInfo | ScpInfo | O | 0 . . . 1 | Specific data for the SCP. |
| seppInfo | SeppInfo | O | 0 . . . 1 | Specific data for the SEPP. |
| vendorId | VendorId | O | 0 . . . 1 | Vendor ID of the NF instance, according to the |
| | | | | IANA-assigned “SMI Network Management Private |
| | | | | Enterprise Codes” [38]. |
| supportedVendorSpecif- | map(array(VendorSpecif- | O | 1 . . . N(1 . . . M) | Map of Vendor-Specific features, where the key of |
| icFeatures | icFeature) | | | the map is the IANA-assigned “SMI Network |
| | | | | Management Private Enterprise Codes” [38]. The |
| | | | | string used as key of the map shall contain 6 decimal |
| | | | | digits; if the SMI code has less than 6 digits, it shall |
| | | | | be padded with leading digits “0” to complete a 6- |
| | | | | digit string value. |
| | | | | The value of each entry of the map shall be a list |
| | | | | (array) of VendorSpecificFeature objects. |
| | | | | (NOTE 12) |
| aanfInfoList | map(AanfInfo) | O | 1 . . . N | Specific data for the AAnF. |
| | | | | The key of the map shall be a (unique) valid JSON |
| | | | | string per clause 7 of IETF RFC 8259 [22], with a |
| | | | | maximum of 32 characters. |
| mfafInfo | MfafInfo | O | 0 . . . 1 | Specific data for the MFAF. |
| easdfInfoList | map(EasdfInfo) | O | 1 . . . N | Specific data for the EASDF. |
| | | | | The key of the map shall be a (unique) valid JSON |
| | | | | string per clause 7 of IETF RFC 8259 [22], with a |
| | | | | maximum of 32 characters. |
| | | | | (NOTE 13) |
| dccfInfo | DccfInfo | O | 0 . . . 1 | Specific data for the DCCF. |
| nsacfInfoList | map(NsacfInfo) | O | 1 . . . N | Specific data for the NSACF. |
| | | | | The key of the map shall be a (unique) valid JSON |
| | | | | string per clause 7 of IETF RFC 8259 [22], with a |
| | | | | maximum of 32 characters. |
| mbSmfInfoList | map(MbSmfInfo) | O | 1 . . . N | MB-SMF specific data. |
| | | | | The key of the map shall be a (unique) valid JSON |
| | | | | string per clause 7 of IETF RFC 8259 [22], with a |
| | | | | maximum of 32 characters. |
| tsctsfInfoList | map(TsctsfInfo) | O | 1 . . . N | Specific data for the TSCTSF. |
| | | | | The key of the map shall be a (unique) valid JSON |
| | | | | string per clause 7 of IETF RFC 8259 [22], with a |
| | | | | maximum of 32 characters. |
| mbUpfInfoList | map(MbUpfInfo) | O | 1 . . . N | MB-UPF specific data. |
| | | | | The key of the map shall be a (unique) valid JSON |
| | | | | string per clause 7 of IETF RFC 8259 [22], with a |
| | | | | maximum of 32 characters. |
| trustAfInfo | TrustAfInfo | O | 0 . . . 1 | Specific data for the trusted AF. |
| nssaafInfo | NssaafInfo | O | 0 . . . 1 | Specific data for the NSSAAF. |
| hniList | arrary(Fqdn) | C | 1 . . . N | Identifications of Credentials Holder or Default |
| | | | | Credentials Server. |
| | | | | This IE shall be present if the NFs are available for |
| | | | | the case of access to an SNPN using credentials |
| | | | | owned by a Credentials Holder or for the case of |
| | | | | SNPN Onboarding using a DCS. |
| iwmscInfo | IwmscInfo | O | 0 . . . 1 | Specific data for the SMS-IWMSC. |
| mnpfInfo | MnpfInfo | O | 0 . . . 1 | Specific data for the MNPF. |
| nfSelectionConditions | NfSelectionConditions | O | 0 . . . 1 | Conditions under which an NF Instance with an |
| | | | | NFStatus value set to “TESTING” shall be |
| | | | | selected by an NF Service Consumer (e.g. if the |
| | | | | UE belongs to a range of SUPIs) |

(NOTE 1):
At least one of the addressing parameters (fqdn, ipv4address or ipv6adress) shall be included in the NF Profile. See NOTE 1 of Table 6.2.6.2.4-1 for the use of these parameters. If multiple ipv4 addresses and/or ipv6 addresses are included in the NF Profile, the NF Service Consumer shall select one of these addresses randomly, unless operator defined local policy of IP address selection, in order to avoid overload for a specific ipv4 address and/or ipv6 address.
(NOTE 2):
The capacity and priority parameters, if present, are used for NF selection and load balancing. The priority and capacity attributes shall be used for NF selection in the same way that priority and weight are used for server selection as defined in IETF RFC 2782 [23].
(NOTE 3):
If the requester-plmn in the query parameter is different from the PLMN of the discovered NF, then the fqdn attribute value shall contain the interPlmnFqdn value registered by the NF during NF registration (see clause 6.1.6.2.2). The requester-plmn is different from the PLMN of the discovered NF if it belongs to none of the PLMN ID(s) configured for the PLMN of the NRF.
(NOTE 4):
The usage of the load parameter by the NF service consumer is implementation specific, e.g. be used for NF selection and load balancing, together with other parameters.
(NOTE 5):
An NF may register multiple PLMN IDs in its profile within a PLMN comprising multiple PLMN IDs. If so, all the attributes of the NF Profile shall apply to each PLMN ID registered in the plmnList. As an exception, attributes including a PLMN ID, e.g. IMSI-based SUPI ranges, TAIs and GUAMIs, are specific to one PLMN ID and the NF may register in its profile multiple occurrences of such attributes for different PLMN IDs (e.g. the UDM may register in its profile SUPI ranges for different PLMN IDs).
(NOTE 6):
For notification types that may be associated with a specifc service of the NF Instance receiving the notification (see clause 6.1.6.3.4), if notification endpoints are present both in the profile of the NF instance (NFProfile) and in some of its NF Services (NFService) for a same notification type, the notification endpoint(s) of the NF Services shall be used for this notification type.
(NOTE 7):
The absence of the pcscfInfoList attribute in a P-CSCF profile indicates that the P-CSCF can be selected for any DNN and Access Type, and that the P-CSCF Gm addressing information is the same as the addressing information registered in the fqdn, ipv4Addresses and ipv4Addresses attributes of the NF profile.
(NOTE 8):
The absence of both the smfInfo and smfInfoList attributes in an SMF profile indicates that the SMF can be selected for any S-NSSAI listed in the sNssais and perPlmnSnssaiList IEs, or for any S-NSSAI if neither the sNssais IE nor the perPlmnSnssaiList IE are present, and for any DNN, TAI and access type.
(NOTE 9):
If an NF (other than a SCP or SEPP) includes this information in its profile, this indicates that the services produced by this NF should be accessed preferably via an SCP from the SCP domain the NF belongs to.
(NOTE 10):
If the NF Service Consumer that issued the discovery request indicated support for the “Service-Map” feature, the NRF shall return in the discovery response the list of NF Service Instances in the “nfServiceList” map attribute. Otherwise, the NRF shall return the list of NF Service Instances in the “nfServices” array attribute.
(NOTE 11):
For API URIs constructed with an FQDN, the NF Service Consumer may use the FQDN of the target URI to do a DNS query and obtain the IP address(es) to setup the TCP connection, and ignore the IP addresses that may be present in the NFProfile; alternatively, the NF Service Consumer may use those IP addresses to setup the TCP connection, if no service-specific FQDN or IP address is provided in the NFService data and if the NF Service Consumer supports to indicate specific IP address(es) to establish an HTTP/2 connection with an FQDN in the target URI.
(NOTE 12):
When present, this attribute allows an NF requesting NF Discovery (e.g. an NF Service Consumer) to determine which vendor-specific extensions are supported in a given NF (e.g. an NF Service Producer), so as to select an appropriate NF with specific capability, or to include or not the vendor-specific attributes (see 3GPP TS 29.500 [4] clause 6.6.3) required for a given feature in subsequent messages towards a certain NF. One given vendor-specific feature shall not appear in both NF Profile and NF Service Profile. If one vendor-specific feature is service related, it shall only be included in the NF Service Profile.
(NOTE 13):
The absence of the easdfnfoList attributes in an EASDF profile indicates that the EASDF can be selected for any S-NSSAI, DNN, DNAI or PSA UPF N6 IP address.
(NOTE 14):
This attribute may be used by the requester NF or SCP e.g. to build the authority of the Location header in 3xx response or to set the 3gpp-Sbi-apiRoot header in a response message (see clause 6.10.4 of 3GPP TS 29.500 [4]), when the NF redirects a request issued by a consumer from a different PLMN towards the discovered NF, or when the SCP has reselected the discovered NF for such a request.
* * * Next Change * * * *

```
(... text not shown for clarity ...)
  NFProfile:
    description: Information of an NF Instance registered in the NRF
    type: object
    required:
      - nfInstanceId
      - nfType
      - nfStatus
    anyOf:
      - required: [ fqdn ]
      - required: [ ipv4Addresses ]
      - required: [ ipv6Addresses ]
    properties:
      nfInstanceId:
        $ref: ‘TS29571_CommonData.yaml#/components/schemas/NfInstanceId’
      nfInstanceName:
        type: string
      nfType:
        $ref: ‘#/components/schemas/NFType’
      nfStatus:
        $ref: ‘#/components/schemas/NFStatus’
      collocatedNfInstances:
        type: array
        items:
          $ref: ‘#/components/schemas/CollocatedNfInstance’
        minimum: 1
      heartBeatTimer:
        type: integer
        minimum: 1
      plmnList:
        type: array
        items:
          $ref: ‘TS29571_CommonData.yaml#/components/schemas/PlmnId’
        minItems: 1
      snpnList:
        type: array
        items:
          $ref: ‘TS29571_CommonData.yaml#/components/schemas/PlmnIdNid’
        minItems: 1
      sNssais:
        type: array
        items:
          $ref: ‘TS29571_CommonData.yaml#/components/schemas/ExtSnssai’
        minItems: 1
      perPlmnSnssaiList:
        type: array
        items:
          $ref: ‘#/components/schemas/PlmnSnssai’
        minItems: 1
      nsiList:
        type: array
        items:
          type: string
        minItems: 1
      fqdn:
        $ref: ‘TS29571_CommonData.yaml#/components/schemas/Fqdn’
      interPlmnFqdn:
        $ref: ‘TS29571_CommonData.yaml#/components/schemas/Fqdn’
      ipv4Addresses:
        type: array
        items:
          $ref: ‘TS29571_CommonData.yaml#/components/schemas/Ipv4Addr’
        minItems: 1
      ipv6Addresses:
        type: array
        items:
          $ref: ‘TS29571_CommonData.yaml#/components/schemas/Ipv6Addr’
        minItems: 1
      allowedPlmns:
        type: array
        items:
          $ref: ‘TS29571_CommonData.yaml#/components/schemas/PlmnId’
        minItems: 1
      allowedSnpns:
        type: array
        items:
          $ref: ‘TS29571_CommonData.yaml#/components/schemas/PlmnIdNid’
        minItems: 1
      allowedNfTypes:
        type: array
        items:
          $ref: ‘#/components/schemas/NFType’
        minItems: 1
      allowedNfDomains:
        type: array
        items:
          type: string
        minItems: 1
      allowedNssais:
        type: array
        items:
          $ref: ‘TS29571_CommonData.yaml#/components/schemas/ExtSnssai’
        minItems: 1
      priority:
        type: integer
        minimum: 0
        maximum: 65535
      capacity:
        type: integer
        minimum: 0
        maximum: 65535
      load:
        type: integer
        minimum: 0
        maximum: 100
      loadTimeStamp:
        $ref: ‘TS29571_CommonData.yaml#/components/schemas/DateTime’
      locality:
        type: string
      extLocality:
        description: >
          A map (list of key-value pairs) where a (unique) valid JSON string serves
          as key representing a type of locality
        type: object
        additionalProperties:
          type: string
        minProperties: 1
      udrInfo:
        $ref: ‘#/components/schemas/UdrInfo’
      udrInfoList:
        description: >
          A map (list of key-value pairs) where a (unique) valid JSON string
          serves as key of UdrInfo
        type: object
        additionalProperties:
          $ref: ‘#/components/schemas/UdrInfo’
        minProperties: 1
      udmInfo:
        $ref: ‘#/components/schemas/UdmInfo’
      udmInfoList:
        description: >
          A map (list of key-value pairs) where a (unique) valid JSON string
          serves as key of UdmInfo
        type: object
        additionalProperties:
          $ref: ‘#/components/schemas/UdmInfo’
        minProperties: 1
      ausfInfo:
        $ref: ‘#/components/schemas/AusfInfo’
      ausfInfoList:
        description: >
          A map (list of key-value pairs) where a (unique) valid JSON string
          serves as key of AusfInfo
        type: object
        additionalProperties:
          $ref: ‘#/components/schemas/AusfInfo’
        minProperties: 1
      amfInfo:
        $ref: ‘#/components/schemas/AmfInfo’
      amfInfoList:
        description: >
          A map (list of key-value pairs) where a (unique) valid JSON string
          serves as key of AmfInfo
        type: object
        additionalProperties:
          $ref: ‘#/components/schemas/AmfInfo’
        minProperties: 1
      smfInfo:
        $ref: ‘#/components/schemas/SmfInfo’
      smfInfoList:
        description: >
          A map (list of key-value pairs) where a (unique) valid JSON string
          serves as key of SmfInfo
        type: object
        additionalProperties:
          $ref: ‘#/components/schemas/SmfInfo’
        minProperties: 1
      upfInfo:
        $ref: ‘#/components/schemas/UpfInfo’
      upfInfoList:
        description: >
          A map (list of key-value pairs) where a (unique) valid JSON string
          serves as key of UpfInfo
        type: object
        additionalProperties:
          $ref: ‘#/components/schemas/UpfInfo’
        minProperties: 1
      pcfInfo:
        $ref: ‘#/components/schemas/PcfInfo’
      pcfInfoList:
        description: >
          A map (list of key-value pairs) where a (unique) valid JSON string
          serves as key of PcfInfo
        type: object
        additionalProperties:
          $ref: ‘#/components/schemas/PcfInfo’
        minProperties: 1
      bsfInfo:
        $ref: ‘#/components/schemas/BsfInfo’
      bsfInfoList:
        description: >
          A map (list of key-value pairs) where a (unique) valid JSON string
          serves as key of BsfInfo
        type: object
        additionalProperties:
          $ref: ‘#/components/schemas/BsfInfo’
        minProperties: 1
      chfInfo:
        $ref: ‘#/components/schemas/ChfInfo’
      chfInfoList:
        description: >
          A map (list of key-value pairs) where a (unique) valid JSON string
          serves as key of ChfInfo
        type: object
        additionalProperties:
          $ref: ‘#/components/schemas/ChfInfo’
        minProperties: 1
      nefInfo:
        $ref: ‘#/components/schemas/NefInfo’
      nrfInfo:
        $ref: ‘#/components/schemas/NrfInfo’
      udsfInfo:
        $ref: ‘#/components/schemas/UdsfInfo’
      udsfInfoList:
        description: >
          A map (list of key-value pairs) where a (unique) valid JSON string
          serves as key of UdsfInfo
        type: object
        additionalProperties:
          $ref: ‘#/components/schemas/UdsfInfo’
        minProperties: 1
      nwdafInfo:
        $ref: ‘#/components/schemas/NwdafInfo’
      nwdafInfoList:
        type: object
        description: >
          A map (list of key-value pairs) where a (unique) valid JSON string
          serves as key of NwdafInfo
        additionalProperties:
          $ref: ‘#/components/schemas/NwdafInfo’
        minProperties: 1
      pcscfInfoList:
        description: >
          A map (list of key-value pairs) where a (unique) valid JSON string
          serves as key of PcscfInfo
        type: object
        additionalProperties:
          $ref: ‘#/components/schemas/PcscfInfo’
        minProperties: 1
      hssInfoList:
        description: >
          A map (list of key-value pairs) where a (unique) valid JSON string
          serves as key of HssInfo
        type: object
        additionalProperties:
          $ref: ‘#/components/schemas/HssInfo’
        minProperties: 1
      customInfo:
        type: object
      recoveryTime:
        $ref: ‘TS29571_CommonData.yaml#/components/schemas/DateTime’
      nfServicePersistence:
        type: boolean
        default: false
      nfServices:
        deprecated: true
        type: array
        items:
          $ref: ‘#/components/schemas/NFService’
        minItems: 1
      nfServiceList:
        description: >
          A map (list of key-value pairs) where serviceInstanceId serves as key of
NFService
        type: object
        additionalProperties:
          $ref: ‘#/components/schemas/NFService’
        minProperties: 1
      nfProfileChangesSupportInd:
        type: boolean
        default: false
        writeOnly: true
      nfProfileChangesInd:
        type: boolean
        default: false
        readOnly: true
      defaultNotificationSubscriptions:
        type: array
        items:
          $ref: ‘#/components/schemas/DefaultNotificationSubscription’
      lmfInfo:
        $ref: ‘#/components/schemas/LmfInfo’
      gmlcInfo:
        $ref: ‘#/components/schemas/GmlcInfo’
      nfSetIdList:
        type: array
        items:
          $ref: ‘TS29571_CommonData.yaml#/components/schemas/NfSetId’
        minItems: 1
      servingScope:
        type: array
        items:
          type: string
        minItems: 1
      lcHSupportInd:
        type: boolean
        default: false
      olcHSupportInd:
        type: boolean
        default: false
      nfSetRecoveryTimeList:
        description: A map (list of key-value pairs) where NfSetId serves as key of
DateTime
        type: object
        additionalProperties:
          $ref: ‘TS29571_CommonData.yaml#/components/schemas/DateTime’
        minProperties: 1
      serviceSetRecoveryTimeList:
        description: >
          A map (list of key-value pairs) where NfServiceSetId serves as key of DateTime
        type: object
        additionalProperties:
          $ref: ‘TS29571_CommonData.yaml#/components/schemas/DateTime’
        minProperties: 1
      scpDomains:
        type: array
        items:
          type: string
        minItems: 1
      scpInfo:
        $ref: ‘#/components/schemas/ScpInfo’
      seppInfo:
        $ref: ‘#/components/schemas/SeppInfo’
      vendorId:
        $ref: ‘#/components/schemas/VendorId’
      supportedVendorSpecificFeatures:
        description: >
          The key of the map is the IANA-assigned SMI Network Management Private
Enterprise Codes
        type: object
        additionalProperties:
          type: array
          items:
            $ref: ‘#/components/schemas/VendorSpecificFeature’
          minItems: 1
        minProperties: 1
      aanfInfoList:
        type: object
        description: >
          A map (list of key-value pairs) where a (unique) valid JSON string
          serves as key of AanfInfo
        additionalProperties:
          $ref: ‘#/components/schemas/AanfInfo’
        minProperties: 1
      5gDdnmfInfo:
        $ref: ‘#/components/schemas/5GDdnmfInfo’
      mfafInfo:
        $ref: ‘#/components/schemas/MfafInfo’
      easdfInfoList:
        type: object
        description: >
          A map (list of key-value pairs) where a (unique) valid JSON string
          serves as key of EasdfInfo
        additionalProperties:
          $ref: ‘#/components/schemas/EasdfInfo’
        minProperties: 1
      dccfInfo:
        $ref: ‘#/components/schemas/DccfInfo’
      nsacfInfoList:
        description: >
          A map (list of key-value pairs) where a (unique) valid JSON string
          serves as key of NsacfInfo
        type: object
        additionalProperties:
          $ref: ‘#/components/schemas/NsacfInfo’
        minProperties: 1
      mbSmfInfoList:
        description: >
          A map (list of key-value pairs) where a (unique) valid JSON string
          serves as key of MbSmfInfo
        type: object
        additionalProperties:
          $ref: ‘#/components/schemas/MbSmfInfo’
        minProperties: 1
      tsctsfInfoList:
        type: object
        description: >
          A map (list of key-value pairs) where a (unique) valid JSON string
          serves as key of TsctsfInfo
        additionalProperties:
          $ref: ‘#/components/schemas/TsctsfInfo’
        minProperties: 1
      mbUpfInfoList:
        type: object
        description: >
          A map (list of key-value pairs) where a (unique) valid JSON string
          serves as key of MbUpfInfo
        additionalProperties:
          $ref: ‘#/components/schemas/MbUpfInfo’
        minProperties: 1
      trustAfInfo:
        $ref: ‘#/components/schemas/TrustAfInfo’
      nssaafInfo:
        $ref: ‘#/components/schemas/NssaafInfo’
      hniList:
        type: array
        items:
          $ref: ‘TS29571_CommonData.yaml#/components/schemas/Fqdn’
        minItems: 1
      iwmscInfo:
        $ref: ‘#/components/schemas/IwmscInfo’
      mnpfInfo:
        $ref: ‘#/components/schemas/MnpfInfo’
      nfSelectionConditions:
        $ref: ‘#/components/schemas/NfSelectionConditions’
(... text not shown for clarity ...)
  NFStatus:
    description: Status of a given NF Instance stored in NRF
    anyOf:
      - type: string
        enum:
          - REGISTERED
          - SUSPENDED
          - UNDISCOVERABLE
          - TESTING
      - type: string
(... text not shown for clarity ...)
  LocalityType:
    description: >
      Type of locality description. An operator may define custom locality type values
other
      than those listed in this enumeration.
    anyOf:
      - type: string
        enum:
          - DATA_CENTER
          - CITY
          - COUNTY
          - DISTRICT
          - STATE
          - CANTON
          - REGION
          - PROVINCE
          - PREFECTURE
          - COUNTRY
      - type: string
  NFSelectionConditions:
    description: >
      Conditions under which an NF Instance with an NFStatus value set to
      “TESTING”
      shall be selected by an NF Service Consumer
    type: object
    properties:
      supiRangeList:
        type: array
        items:
          $ref: ‘#/components/schemas/SupiRange’
        minItems: 1
      gpsiRangeList:
        type: array
        items:
          $ref: ‘#/components/schemas/IdentityRange’
        minItems: 1
      peiList:
        type: array
        items:
          $ref: ‘TS29571 CommonData.yaml#/components/schemas/Pei’
        minItems: 1
      taiRangeList:
        type: array
        items:
          $ref: ‘#/components/schemas/TaiRange’
        minItems: 1
              * * * Next Change * * * *
```

### A.3 Nnrf_NFDiscovery API

```
(... text not shown for clarity ...)
  NFProfile:
    description: Information of an NF Instance discovered by the NRF
    type: object
    required:
      - nfInstanceId
      - nfType
      - nfStatus
    properties:
      nfInstanceId:
        $ref: ‘TS29571_CommonData.yaml#/components/schemas/NfInstanceId’
      nfInstanceName:
        type: string
      nfType:
        $ref: ‘TS29510_Nnrf_NFManagement.yaml#/components/schemas/NFType’
      nfStatus:
        $ref: ‘TS29510_Nnrf_NFManagement.yaml#/components/schemas/NFStatus’
      collocatedNfInstances:
        type: array
        items:
          $ref: ‘TS29510_Nnrf_NFManagement.yaml#/components/schemas/CollocatedNfInstance’
        minimum: 1
      plmnList:
        type: array
        items:
          $ref: ‘TS29571_CommonData.yaml#/components/schemas/PlmnId’
        minItems: 1
      sNssais:
        type: array
        items:
          $ref: ‘TS29571_CommonData.yaml#/components/schemas/ExtSnssai’
        minItems: 1
      perPlmnSnssaiList:
        type: array
        items:
          $ref:’TS29510_Nnrf_NFManagement.yaml#/components/schemas/PlmnSnssai’
        minItems: 1
      nsiList:
        type: array
        items:
          type: string
        minItems: 1
      fqdn:
        $ref: ‘TS29571_CommonData.yaml#/components/schemas/Fqdn’
      interPlmnFqdn:
        $ref: ‘TS29571_CommonData.yaml#/components/schemas/Fqdn’
      ipv4Addresses:
        type: array
        items:
          $ref: ‘TS29571_CommonData.yaml#/components/schemas/Ipv4Addr’
        minItems: 1
      ipv6Addresses:
        type: array
        items:
          $ref: ‘TS29571_CommonData.yaml#/components/schemas/Ipv6Addr’
        minItems: 1
      capacity:
        type: integer
        minimum: 0
        maximum: 65535
      load:
        type: integer
        minimum: 0
        maximum: 100
      loadTimeStamp:
        $ref: ‘TS29571_CommonData.yaml#/components/schemas/DateTime’
      locality:
        type: string
      extLocality:
        description: >
          A map (list of key-value pairs) where a (unique) valid JSON string serves
          as key representing a type of locality
        type: object
        additionalProperties:
          type: string
        minProperties: 1
      priority:
        type: integer
        minimum: 0
        maximum: 65535
      udrInfo:
        $ref: ‘TS29510_Nnrf_NFManagement.yaml#/components/schemas/UdrInfo’
      udrInfoList:
        description: >
          A map (list of key-value pairs) where a (unique) valid JSON string
          serves as key of UdrInfo
        type: object
        additionalProperties:
          $ref: ‘TS29510_Nnrf_NFManagement.yaml#/components/schemas/UdrInfo’
        minProperties: 1
      udmInfo:
        $ref: ‘TS29510_Nnrf_NFManagement.yaml#/components/schemas/UdmInfo’
      udmInfoList:
        description: >
          A map (list of key-value pairs) where a (unique) valid JSON string
          serves as key of UdmInfo
        type: object
        additionalProperties:
          $ref: ‘TS29510_Nnrf_NFManagement.yaml#/components/schemas/UdmInfo’
        minProperties: 1
      ausfInfo:
        $ref: ‘TS29510_Nnrf_NFManagement.yaml#/components/schemas/AusfInfo’
      ausfInfoList:
        description: >
          A map (list of key-value pairs) where a (unique) valid JSON string
          serves as key of AusfInfo
        type: object
        additionalProperties:
          $ref: ‘TS29510_Nnrf_NFManagement.yaml#/components/schemas/AusfInfo’
        minProperties: 1
      amfInfo:
        $ref: ‘TS29510_Nnrf_NFManagement.yaml#/components/schemas/AmfInfo’
      amfInfoList:
        description: >
          A map (list of key-value pairs) where a (unique) valid JSON string
          serves as key of AmfInfo
        type: object
        additionalProperties:
          $ref: ‘TS29510_Nnrf_NFManagement.yaml#/components/schemas/AmfInfo’
        minProperties: 1
      smfInfo:
        $ref: ‘TS29510_Nnrf_NFManagement.yaml#/components/schemas/SmfInfo’
      smfInfoList:
        description: >
          A map (list of key-value pairs) where a (unique) valid JSON string
          serves as key of SmfInfo
        type: object
        additionalProperties:
          $ref: ‘TS29510_Nnrf_NFManagement.yaml#/components/schemas/SmfInfo’
        minProperties: 1
      upfInfo:
        $ref: ‘TS29510_Nnrf_NFManagement.yaml#/components/schemas/UpfInfo’
      upfInfoList:
        description: >
          A map (list of key-value pairs) where a (unique) valid JSON string
          serves as key of UpfInfo
        type: object
        additionalProperties:
          $ref: ‘TS29510_Nnrf_NFManagement.yaml#/components/schemas/UpfInfo’
        minProperties: 1
      pcfInfo:
        $ref: ‘TS29510_Nnrf_NFManagement.yaml#/components/schemas/PcfInfo’
      pcfInfoList:
        description: >
          A map (list of key-value pairs) where a (unique) valid JSON string
          serves as key of PcfInfo
        type: object
        additionalProperties:
          $ref: ‘TS29510_Nnrf_NFManagement.yaml#/components/schemas/PcfInfo’
        minProperties: 1
      bsfInfo:
        $ref: ‘TS29510_Nnrf_NFManagement.yaml#/components/schemas/BsfInfo’
      bsfInfoList:
        description: >
          A map (list of key-value pairs) where a (unique) valid JSON string
          serves as key of BsfInfo
        type: object
        additionalProperties:
          $ref: ‘TS29510_Nnrf_NFManagement.yaml#/components/schemas/BsfInfo’
        minProperties: 1
      chfInfo:
        $ref: ‘TS29510_Nnrf_NFManagement.yaml#/components/schemas/ChfInfo’
      chfInfoList:
        description: >
          A map (list of key-value pairs) where a (unique) valid JSON string
          serves as key of ChfInfo
        type: object
        additionalProperties:
          $ref: ‘TS29510_Nnrf_NFManagement.yaml#/components/schemas/ChfInfo’
        minProperties: 1
      udsfInfo:
        $ref: ‘TS29510_Nnrf_NFManagement.yaml#/components/schemas/UdsfInfo’
      udsfInfoList:
        description: >
          A map (list of key-value pairs) where a (unique) valid JSON string
          serves as key of UdsfInfo
        type: object
        additionalProperties:
          $ref: ‘TS29510_Nnrf_NFManagement.yaml#/components/schemas/UdsfInfo’
        minProperties: 1
      nwdafInfo:
        $ref: ‘TS29510_Nnrf_NFManagement.yaml#/components/schemas/NwdafInfo’
      nwdafInfoList:
        type: object
        description: >
          A map (list of key-value pairs) where a (unique) valid JSON string
          serves as key of NwdafInfo
        additionalProperties:
          $ref: ‘TS29510_Nnrf_NFManagement.yaml#/components/schemas/NwdafInfo’
        minProperties: 1
      nefInfo:
        $ref: ‘TS29510_Nnrf_NFManagement.yaml#/components/schemas/NefInfo’
      pcscfInfoList:
        description: >
          A map (list of key-value pairs) where a (unique) valid JSON string
          serves as key of PcscfInfo
        type: object
        additionalProperties:
          $ref: ‘TS29510_Nnrf_NFManagement.yaml#/components/schemas/PcscfInfo’
        minProperties: 1
      hssInfoList:
        description: >
          A map (list of key-value pairs) where a (unique) valid JSON string
          serves as key of HssInfo
        type: object
        additionalProperties:
          $ref: ‘TS29510_Nnrf_NFManagement.yaml#/components/schemas/HssInfo’
        minProperties: 1
      customInfo:
        type: object
      recoveryTime:
        $ref: ‘TS29571_CommonData.yaml#/components/schemas/DateTime’
      nfServicePersistence:
        type: boolean
        default: false
      nfServices:
        deprecated: true
        type: array
        items:
          $ref: ‘#/components/schemas/NFService’
        minItems: 1
      nfServiceList:
        description: >
          A map (list of key-value pairs) where serviceInstanceId serves as key of
NFService
        type: object
        additionalProperties:
          $ref: ‘#/components/schemas/NFService’
        minProperties: 1
      defaultNotificationSubscriptions:
        type: array
        items:
          $ref:
‘TS29510_Nnrf_NFManagement.yaml#/components/schemas/DefaultNotificationSubscription’
      lmfInfo:
        $ref: ‘TS29510_Nnrf_NFManagement.yaml#/components/schemas/LmfInfo’
      gmlcInfo:
        $ref: ‘TS29510_Nnrf_NFManagement.yaml#/components/schemas/GmlcInfo’
      snpnList:
        type: array
        items:
          $ref: ‘TS29571_CommonData.yaml#/components/schemas/PlmnIdNid’
        minItems: 1
      nfSetIdList:
        type: array
        items:
          $ref: ‘TS29571_CommonData.yaml#/components/schemas/NfSetId’
        minItems: 1
      servingScope:
        type: array
        items:
          type: string
        minItems: 1
      lcHSupportInd:
        type: boolean
        default: false
      olcHSupportInd:
        type: boolean
        default: false
      nfSetRecoveryTimeList:
        description: A map (list of key-value pairs) where NfSetId serves as key of
DateTime
        type: object
        additionalProperties:
          $ref: ‘TS29571_CommonData.yaml#/components/schemas/DateTime’
        minProperties: 1
      serviceSetRecoveryTimeList:
        description: >
          A map (list of key-value pairs) where NfServiceSetId serves as key of DateTime
        type: object
        additionalProperties:
          $ref: ‘TS29571_CommonData.yaml#/components/schemas/DateTime’
        minProperties: 1
      scpDomains:
        type: array
        items:
          type: string
        minItems: 1
      scpInfo:
        $ref: ‘TS29510_Nnrf_NFManagement.yaml#/components/schemas/ScpInfo’
      seppInfo:
        $ref: ‘TS29510_Nnrf_NFManagement.yaml#/components/schemas/SeppInfo’
      vendorId:
        $ref: ‘TS29510_Nnrf_NFManagement.yaml#/components/schemas/VendorId’
      supportedVendorSpecificFeatures:
        description: >
          The key of the map is the IANA-assigned SMI Network Management Private
Enterprise Codes
        type: object
        additionalProperties:
          type: array
          items:
            $ref:
‘TS29510_Nnrf_NFManagement.yaml#/components/schemas/VendorSpecificFeature’
          minItems: 1
        minProperties: 1
      aanfInfoList:
        type: object
        description: >
          A map (list of key-value pairs) where a (unique) valid JSON string
          serves as key of AanfInfo
        additionalProperties:
          $ref: ‘TS29510_Nnrf_NFManagement.yaml#/components/schemas/AanfInfo’
        minProperties: 1
      mfafInfo:
        $ref: ‘TS29510_Nnrf_NFManagement.yaml#/components/schemas/MfafInfo’
      easdfInfoList:
        type: object
        description: >
          A map(list of key-value pairs) where a (unique) valid JSON string
          serves as key of EasdfInfo
        additionalProperties:
          $ref: ‘TS29510_Nnrf_NFManagement.yaml#/components/schemas/EasdfInfo’
        minProperties: 1
      dccfInfo:
        $ref: ‘TS29510_Nnrf_NFManagement.yaml#/components/schemas/DccfInfo’
      nsacfInfoList:
        description: >
          A map (list of key-value pairs) where a (unique) valid JSON string
          serves as key of NsacfInfo
        type: object
        additionalProperties:
          $ref: ‘TS29510_Nnrf_NFManagement.yaml#/components/schemas/NsacfInfo’
        minProperties: 1
      mbSmfInfoList:
        description: >
          A map (list of key-value pairs) where a (unique) valid JSON string
          serves as key of MbSmfInfo
        type: object
        additionalProperties:
          $ref: ‘TS29510_Nnrf_NFManagement.yaml#/components/schemas/MbSmfInfo’
        minProperties: 1
      tsctsfInfoList:
        type: object
        description: >
          A map (list of key-value pairs) where a (unique) valid JSON string
          serves as key of TsctsfInfo
        additionalProperties:
          $ref: ‘TS29510_Nnrf_NFManagement.yaml#/components/schemas/TsctsfInfo’
        minProperties: 1
      mbUpfInfoList:
        description: >
          A map (list of key-value pairs) where a (unique) valid JSON string
          serves as key of MbUpfInfo
        type: object
        additionalProperties:
          $ref: ‘TS29510_Nnrf_NFManagement.yaml#/components/schemas/MbUpfInfo’
        minProperties: 1
      trustAfInfo:
        $ref: ‘TS29510_Nnrf_NFManagement.yaml#/components/schemas/TrustAfInfo’
      nssaafInfo:
        $ref: ‘TS29510_Nnrf_NFManagement.yaml#/components/schemas/NssaafInfo’
      hniList:
        type: array
        items:
          $ref: ‘TS29571_CommonData,yaml#/components/schemas/Fqdn’
        minItems: 1
      iwmscInfo:
        $ref: ‘TS29510_Nnrf_NFManagement.yaml#/components/schemas/IwmscInfo’
      mnpfInfo:
        $ref: ‘TS29510_Nnrf_NFManagement.yaml#/components/schemas/MnpfInfo’
      nfSelectionConditions:
        $ref:
        ‘TS29510 Nnrf NFManagement.yaml#/components/schemas/NfSelectionConditions’
(... text not shown for clarity ...)
              * * * End of Changes * * * *
```

1. A method performed by a first network node for handling a testing process associated with a third network node in a wireless communications network, the method comprising:
obtaining an instance identity of an updated or initiated third network node;
storing one or more identities of one or more UEs to be used during the testing process, mapped to the obtained instance identity;
upon detection of a session establishment of a UE, checking (704) whether an identity of the UE matches the stored one or more identities of the one or more UEs; and
with the proviso that the identity of the UE matches one of the stored one or more identities of the one or more UEs, initiating a network function, NF, discovery towards a second network node using the obtained instance identity mapped to the matched one identity.

2. The method according to claim 1, wherein initiating the NF discovery comprises transmitting to the second network node an indication indicating a requested status associated with a testing, maintenance or updating mode of the third network node.

3. The method according to claim 1, further comprising:
receiving a response from the second network node, indicating a profile of the updated or initiated third network node.

4. The method according to claim 3, wherein receiving the response comprises receiving one or more indications of one or more profiles of one or more third network nodes, wherein a status of respective profile is indicated in the response carrying the one or more indications;
wherein the method preferably further comprises:
selecting one profile with status indicating testing, maintenance or updating.

5. (canceled)

6. The method according to claim 4, further comprising obtaining the one or more identities of the one or more UEs to be used during the testing process mapped to the obtained instance identity in a local configuration and/or wherein the first network node comprises an Access and Mobility Management Function, AMF.

7. (canceled)

8. A method performed by a second network node for handling a testing process associated with a third network node in a wireless communications network, the method comprising
obtaining an instance identity of an updated or initiated third network node;
receiving a request from a first network node related to a network function, NF, discovery using the instance identity;
generating a response based on the instance identity, a status indication of the third network node, a condition indication, a received indication from the first network node and/or previously stored status information, wherein the response indicates a profile of the updated or initiated third network node; and
transmitting the generated response to the first network node.

9. The method according to claim 8, wherein receiving the request comprises receiving, from the first network node, an indication indicating a status for testing, maintenance or updating the third network node.

10. The method according to claim 8, further comprising:
obtaining
the status indication from the third network node, indicating that the third network node is undiscoverable, or in a status related to testing, maintenance or updating, and/or
the condition indication.

11. The method according to claim 8, wherein generating the response comprises applying, to the response, one or more indications of one or more profiles of one or more third network nodes, wherein a status of respective profile is indicated in the response carrying the one or more indications; and wherein the second network node comprises a network repository function, NRF.

12. (canceled)

13. A method performed by a third network node for handling a testing process associated with the third network node in a wireless communications network, the method comprising:
providing, to a second network node, an indication of a status of the third network node, along with profile information of the third network node, wherein the indication indicates a status related to testing, maintenance or updating of the third network node.

14. The method according to claim 13, further comprising
handling a testing process of a UE; and
in case testing process is successful, transmitting to the second network node, an indication indicating a status of the third network node as a registered third network node.

15. The method according claim 13, wherein the third network node further provides a condition indication to the second network node.

16. The method according to claim 15, wherein the condition indication indicates a selection condition of UEs based on a set of UEs or a set of tracking areas, and/or wherein the third network node comprises a Session Management Function, SMF, a Policy Control Function, PCF, or a Charging Function, CHF.

17. (canceled)

18. A first network node for handling a testing process associated with a third network node in a wireless communications network, wherein the first network node is configured to:
obtain an instance identity of an updated or initiated third network node;
store one or more identities of one or more UEs to be used during the testing process mapped to the obtained instance identity;
upon detection of a session establishment of a UE, check whether an identity of the UE matches the stored one or more identities of the one or more UEs; and
with the proviso that the identity of the UE matches one of the stored one or more identities of the one or more UEs, initiate a network function, NF, discovery towards a second network node using the instance identity mapped to the matched one identity.

19. The first network node according to claim 18, being configured to perform a method for handling a testing process associated with a third network node in a wireless communications network, the method comprising:
obtaining an instance identity of an updated or initiated third network node;
storing one or more identities of one or more UEs to be used during the testing process, mapped to the obtained instance identity;
upon detection of a session establishment of a UE, checking whether an identity of the UE matches the stored one or more identities of the one or more UEs; and
with the proviso that the identity of the UE matches one of the stored one or more identities of the one or more UEs, initiating a network function, NF, discovery towards a second network node using the obtained instance identity mapped to the matched one identity,
wherein initiating the NF discovery comprises transmitting to the second network node an indication indicating a requested status associated with a testing, maintenance or updating mode of the third network node.

20. A second network node for handling a testing process associated with a third network node in a wireless communications network, wherein the second network node is configured to:
obtain an instance identity of an updated or initiated third network node;
receive a request from a first network node related to a network function, NF, discovery using the instance identity;
generate a response based on the instance identity, a status indication of the third network node, a condition indication, a received indication from the first network node and/or previously stored status information, wherein the response indicates a profile of the updated or initiated third network node; and
transmit the generated response to the first network node.

21. The second network node according to claim 20, wherein the second network node is configured to perform a method for handling a testing process associated with a third network node in a wireless communications network, the method comprising:
obtaining an instance identity of an updated or initiated third network node;
receiving a request from a first network node related to a network function, NF, discovery using the instance identity;
generating a response based on the instance identity, a status indication of the third network node, a condition indication, a received indication from the first network node and/or previously stored status information, wherein the response indicates a profile of the updated or initiated third network node; and
transmitting the generated response to the first network node,
wherein receiving the request comprises receiving, from the first network node, an indication indicating a status for testing, maintenance or updating the third network node.

22. A third network node for handling a testing process associated with the third network node in a wireless communications network, wherein the third network node is configured to:
provide, to a second network node, an indication of a status of the third network node, along with profile information of the third network node, wherein the indication indicates a status related to testing, maintenance or updating of the third network node.

23. The third network node according to claim 22, wherein the third network node is configured to perform a method for handling a testing process associated with the third network node in a wireless communications network, the method comprising:
providing, to a second network node, an indication of a status of the third network node, along with profile information of the third network node, wherein the indication indicates a status related to testing, maintenance or updating of the third network node, further comprising:
handling a testing process of a UE; and
in case testing process is successful, transmitting to the second network node, an indication indicating a status of the third network node as a registered third network node.

24-26. (canceled)

27. A computer program product comprising instructions, which, when executed on at least one processor, cause the at least one processor to carry out the method according to claim 1, as performed by the first, the second or the third network node, respectively.

28. (canceled)
